(19) United States
(12) Patent Application Publication
(10) Pub. No.: US 2017/0091612 A1
(43) Pub. Date: Mar. 30, 2017

(54) PROACTIVE ASSISTANT WITH MEMORY ASSISTANCE

(71) Applicant: Apple Inc., Cupertino, CA (US)

(72) Inventors: Thomas R. GRUBER, Emerald Hills, CA (US); Jason A. SKINDER, Los Altos, CA (US); Marcos Regis VESCOVI, Cupertino, CA (US); Didier R. GUZZONI, Cupertino, CA (US)

(21) Appl. No.: 15/141,716

(22) Filed: Apr. 28, 2016

Related U.S. Application Data
(60) Provisional application No. 62/235,567, filed on Sep. 30, 2015.

(51) Int. Cl. G06N 3/00; G10L 15/22; G06F 3/0488; G06F 3/0484; G06F 17/24; G06N 5/04; G06F 17/28

(52) U.S. Cl. CPC G06N 3/006; G06N 5/04; G10L 15/22; G06F 17/28; G06F 3/04842; G06F 17/241; G06F 3/0488

(57) ABSTRACT

A non-transitory computer-readable storage medium stores one or more programs including instructions, which when executed by an electronic device of a user, cause the electronic device to generate at least one experiential data structure accessible to a virtual assistant; modify at least one experiential data structure with one or more annotations associated with the experiential data structure, utilizing the virtual assistant; store at least one experiential data structure; receive a natural-language user request for service from the virtual assistant, and output information responsive to the user request using at least one experiential data structure. The experiential data structure is a data structure that includes an organized set of data associated with at least one of the user and the electronic device at a particular point in time.

### CROSS-REFERENCE TO RELATED APPLICATIONS

This application claims priority to U.S. Provisional Patent Application Ser. No. 62/235,567, “PROACTIVE ASSISTANT WITH MEMORY ASSISTANCE,” filed on Sep. 30, 2015. The content of this application is hereby incorporated by reference for all purposes.

### FIELD

The present disclosure relates generally to a virtual assistant, and more specifically use of a virtual assistant to remember user data and generate recommendations.

### BACKGROUND

Intelligent automated assistants (or digital assistants) provide a beneficial interface between human users and electronic devices. Such assistants allow users to interact with devices or systems using natural language in spoken and/or text forms. For example, a user can access the services of an electronic device by providing a spoken user request to a digital assistant associated with the electronic device. The digital assistant can interpret the user's intent from the spoken user request and operationalize the user's intent into tasks. The tasks can then be performed by executing one or more services of the electronic device and a relevant output can be returned to the user in natural language form.

A digital assistant can be helpful in remembering calendar events or other reminders that have been set specifically by a user. A digital assistant also can be helpful in generating a recommendation based on a user request and on third-party reviews that are publicly available. However, digital assistants have not been useful in remembering unstructured data, or in generating recommendations for a user based on the user's experience with or without an express user request for such a recommendation.

### BRIEF SUMMARY

Some techniques for remembering user data and generating recommendations, however, are generally cumbersome and inefficient. For example, existing techniques use a complex and time-consuming user interface, which may include multiple key presses or keystrokes. Such a user interface may be impractical or impossible in certain circumstances, such as when the user is operating a motor vehicle or has his or her hands full. Existing techniques require more time than necessary, wasting user time and device energy. This latter consideration is particularly important in battery-operated devices.

Accordingly, there is a need for electronic devices with faster, more efficient methods and interfaces for remembering user data and generating recommendations. Such methods and interfaces optionally complement or replace other methods for remembering user data and generating recommendations based on a nonspecific, unstructured natural language request. Such methods and interfaces reduce the cognitive burden on a user and produce a more efficient human-machine interface. For battery-operated computing devices, such methods and interfaces conserve power and increase the time between battery charges.

Example non-transitory computer-readable storage media are disclosed herein. An example non-transitory computer-readable storage medium stores one or more programs, the one or more programs comprising instructions, which when executed by an electronic device of a user, cause the electronic device to: generate, in response to a trigger, at least one experiential data structure accessible to a virtual assistant, wherein the experiential data structure comprises an organized set of data associated with at least one of the user and the electronic device at a particular point in time; store at least one experiential data structure; modify at least one experiential data structure with one or more annotations associated with the experiential data structure, utilizing the virtual assistant; receive a natural-language user request for service from the virtual assistant; and output information responsive to the user request using at least one experiential data structure.

Example electronic devices are disclosed herein. An example electronic device comprises a memory and a processor coupled to the memory. In some examples, the processor is configured to generate, in response to a trigger, at least one experiential data structure accessible to a virtual assistant, wherein the experiential data structure comprises an organized set of data associated with at least one of the user and the electronic device at a particular point in time. In some examples, the processor is further configured to store at least one experiential data structure, modify at least one experiential data structure with one or more annotations associated with the experiential data structure, utilizing the virtual assistant, receive a natural-language user request for service from the virtual assistant, and output information responsive to the user request using at least one experiential data structure.

An example electronic device comprises a memory and a processing unit coupled to the memory. The processing unit is configured to generate, in response to a trigger, at least one experiential data structure accessible to a virtual assistant, wherein the experiential data structure comprises an organized set of data associated with at least one of the user and the electronic device at a particular point in time; store at least one experiential data structure; modify at least one experiential data structure with one or more annotations associated with the experiential data structure, utilizing the virtual assistant; receive a natural-language user request for service from the virtual assistant; and output information responsive to the user request using at least one experiential data structure.

Example methods are disclosed herein. An example method of using a virtual assistant comprises, at an electronic device configured to transmit and receive data: generating, in response to a trigger, at least one experiential data structure accessible to a virtual assistant, wherein the experiential data structure comprises an organized set of data associated with at least one of the user and the electronic device at a particular point in time; storing at least one experiential data structure; modifying at least one experiential data structure with one or more annotations associated with the experiential data structure, utilizing the virtual assistant; receiving a natural-language user request for service from the virtual assistant, and outputting information responsive to the user request using at least one experiential data structure.

Example systems are disclosed herein. An example system utilizing an electronic device comprises means for generating, in response to a trigger, at least one experiential data structure accessible to a virtual assistant, wherein the experiential data structure comprises an organized set of data associated with at least one of the user and the electronic device at a particular point in time; means for storing at least one experiential data structure; means for modifying at least one experiential data structure with one or more annotations associated with the experiential data structure, utilizing the virtual assistant; means for receiving a natural-language user request for service from the virtual assistant, and means for outputting information responsive to the user request using at least one experiential data structure.

An example non-transitory computer-readable storage medium stores one or more programs, the one or more programs comprising instructions, which when executed by an electronic device of a user, cause the electronic device to: generate, in response to a trigger, at least one experiential data structure accessible to a virtual assistant, wherein the experiential data structure comprises an organized set of data associated with at least one of the user and the electronic device at a particular point in time; store at least one experiential data structure; modify at least one experiential data structure with one or more annotations associated with the experiential data structure, utilizing the virtual assistant; based on at least one of a user context and a device context, generate a request for a recommendation from the virtual assistant without a request from the user; analyze at least one stored experiential data structure based on the generated request; and output information responsive to the generated request based on the analysis of the at least one stored experiential data structure.

An example electronic device comprises a memory, a microphone, and a processor coupled to the memory and the microphone. In some examples, the processor configured to: generate, in response to a trigger, at least one experiential data structure accessible to a virtual assistant, wherein the experiential data structure comprises an organized set of data associated with at least one of the user and the electronic device at a particular point in time; store at least one experiential data structure; modify at least one experiential data structure with one or more annotations associated with the experiential data structure, utilizing the virtual assistant; based on at least one of a user context and a device context, generate a request for a recommendation from the virtual assistant without a request from the user; analyze at least one stored experiential data structure based on the generated request; and output information responsive to the generated request based on the analysis of the at least one stored experiential data structure.

An example electronic device comprises a memory and a processing unit coupled to the memory. The processing unit is configured to generate, in response to a trigger, at least one experiential data structure accessible to a virtual assistant, wherein the experiential data structure comprises an organized set of data associated with at least one of the user and the electronic device at a particular point in time; store at least one experiential data structure; modify at least one experiential data structure with one or more annotations associated with the experiential data structure, utilizing the virtual assistant; based on at least one of a user context and a device context, generate a request for a recommendation from the virtual assistant without a request from the user; analyze at least one stored experiential data structure based on the generated request; and output information responsive to the generated request based on the analysis of the at least one stored experiential data structure.

An example method of using a virtual assistant comprises, at an electronic device configured to transmit and receive data: generating, in response to a trigger, at least one experiential data structure accessible to a virtual assistant, wherein the experiential data structure comprises an organized set of data associated with at least one of the user and the electronic device at a particular point in time; storing at least one experiential data structure; modifying at least one experiential data structure with one or more annotations associated with the experiential data structure, utilizing the virtual assistant; based on at least one of a user context and a device context, generating a request for a recommendation from the virtual assistant without a request from the user; analyzing at least one stored experiential data structure based on the generated request; and outputting information responsive to the generated request based on the analysis of the at least one stored experiential data structure.

An example system using an electronic device comprises means for generating, in response to a trigger, at least one experiential data structure accessible to a virtual assistant, wherein the experiential data structure comprises an organized set of data associated with at least one of the user and the electronic device at a particular point in time; means for storing at least one experiential data structure; means for modifying at least one experiential data structure with one or more annotations associated with the experiential data structure, utilizing the virtual assistant; means for based on at least one of a user context and a device context, generating a request for a recommendation from the virtual assistant without a request from the user; means for analyzing at least one stored experiential data structure based on the generated request; and means for outputting information responsive to the generated request based on the analysis of the at least one stored experiential data structure.

Thus, devices are provided with faster, more efficient methods and interfaces for remembering user data and generating recommendations, thereby increasing the effectiveness, efficiency, and user satisfaction with such devices. Such methods and interfaces may complement or replace other methods for remembering user data and generating recommendations.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1 is a block diagram illustrating a system and environment for implementing a digital assistant according to various examples.

FIG. 2A is a block diagram illustrating a portable multifunction device implementing the client-side portion of a digital assistant according to various examples.

FIG. 2B is a block diagram illustrating exemplary components for event handling according to various examples.

FIG. 3 illustrates a portable multifunction device implementing the client-side portion of a digital assistant according to various examples.

FIG. 4 is a block diagram of an exemplary multifunction device with a display and a touch-sensitive surface according to various examples.

FIG. 5A illustrates an exemplary user interface for a menu of applications on a portable multifunction device according to various examples.

FIG. 5B illustrates an exemplary user interface for a multifunction device with a touch-sensitive surface that is separate from the display according to various examples.

FIG. 6A illustrates a personal electronic device according to various examples.

FIG. 6B is a block diagram illustrating a personal electronic device according to various examples.

FIG. 7A is a block diagram illustrating a digital assistant system or a server portion thereof according to various examples.

FIG. 7B illustrates the functions of the digital assistant shown in FIG. 7A according to various examples.

FIG. 7C illustrates a portion of an ontology according to various examples.

FIGS. 8A-8JJ illustrate exemplary user interfaces for a personal electronic device in accordance with some embodiments. FIGS. 8I and 8II are intentionally omitted to avoid any confusion between the capital letter I and the numeral 1 (one), and FIG. 8O is intentionally omitted to avoid any confusion between the capital letter O and the numeral 0 (zero).

FIGS. 9A-9G illustrate a process for remembering user data and generating recommendations, according to various examples.

FIGS. 10A-10B illustrate functional block diagrams of embodiments of an electronic device according to various examples.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for remembering user data and generating recommendations. As described above, existing techniques are not as effective as they might be, such with unstructured requests. A digital assistant can reduce the cognitive burden on a user who utilizes a digital assistant to remember user data and generate recommendations, thereby enhancing productivity. Further, such techniques can reduce processor and battery power otherwise wasted on redundant user inputs.

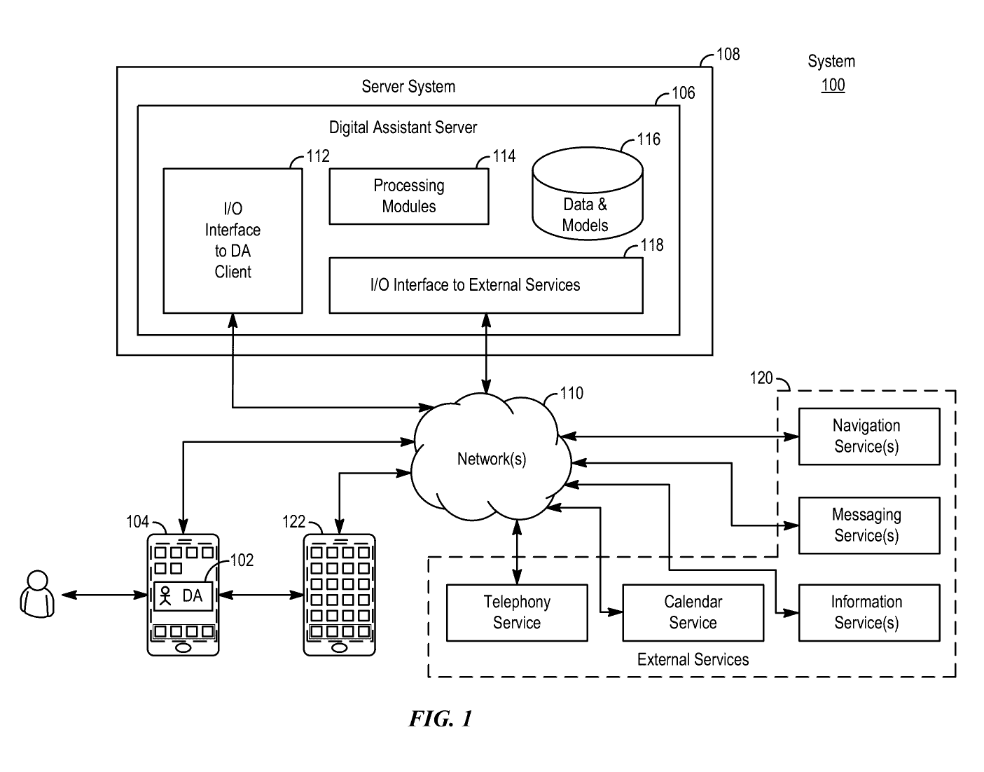

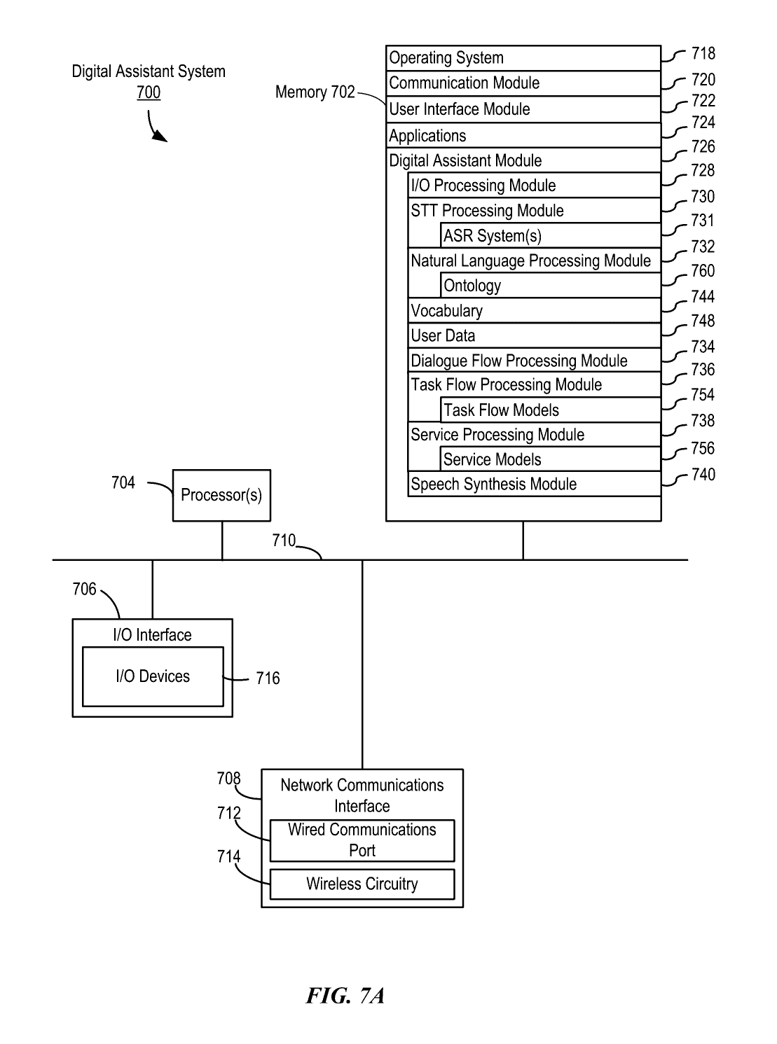

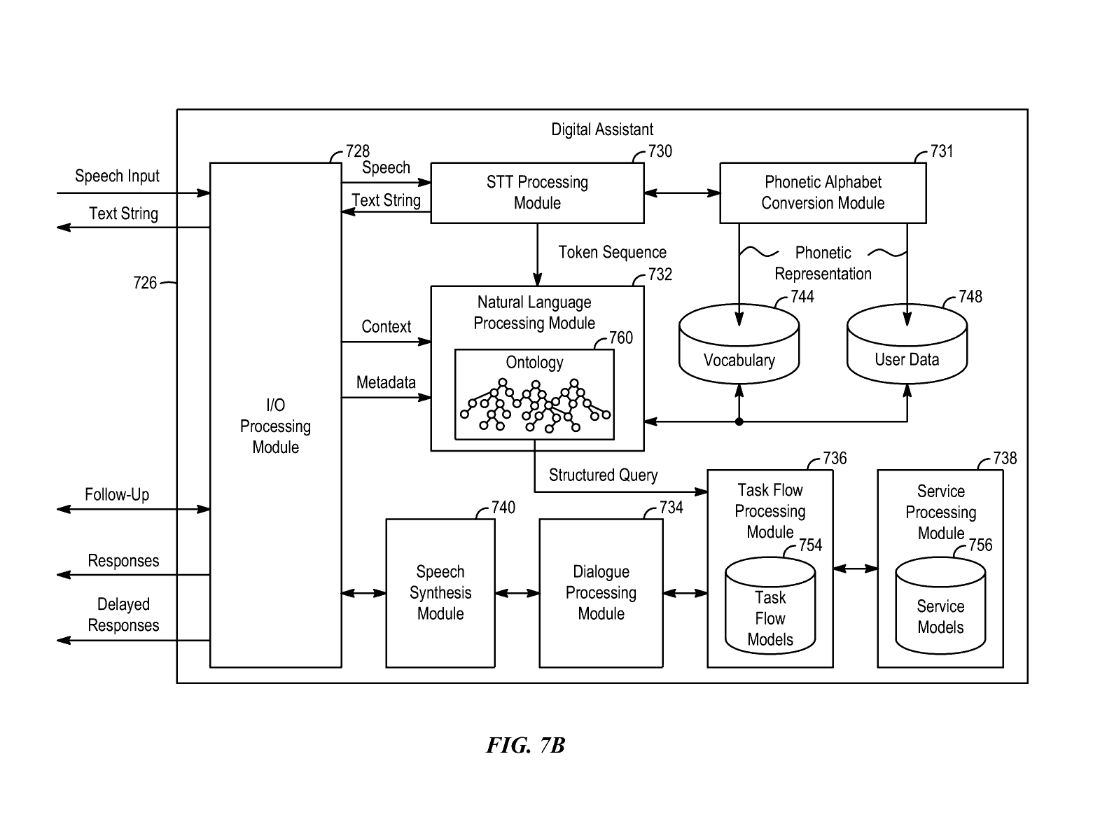

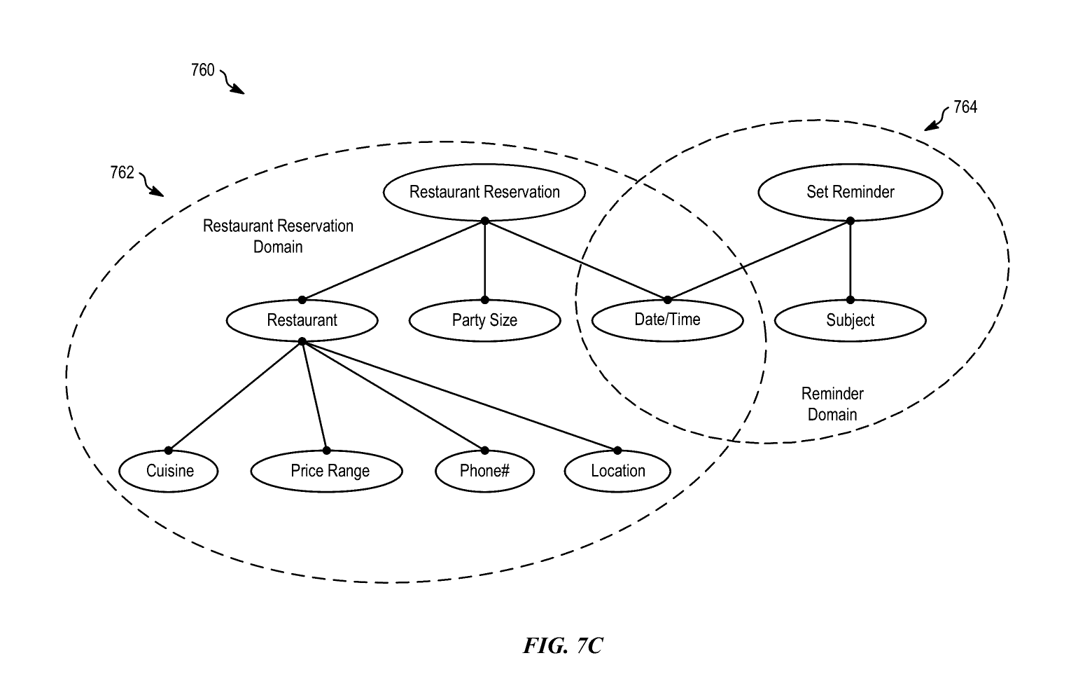

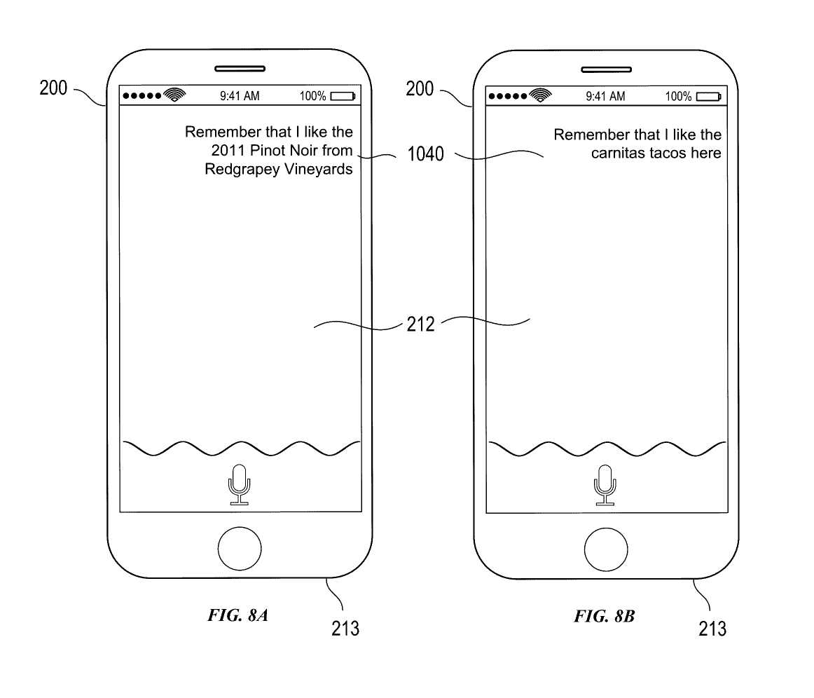

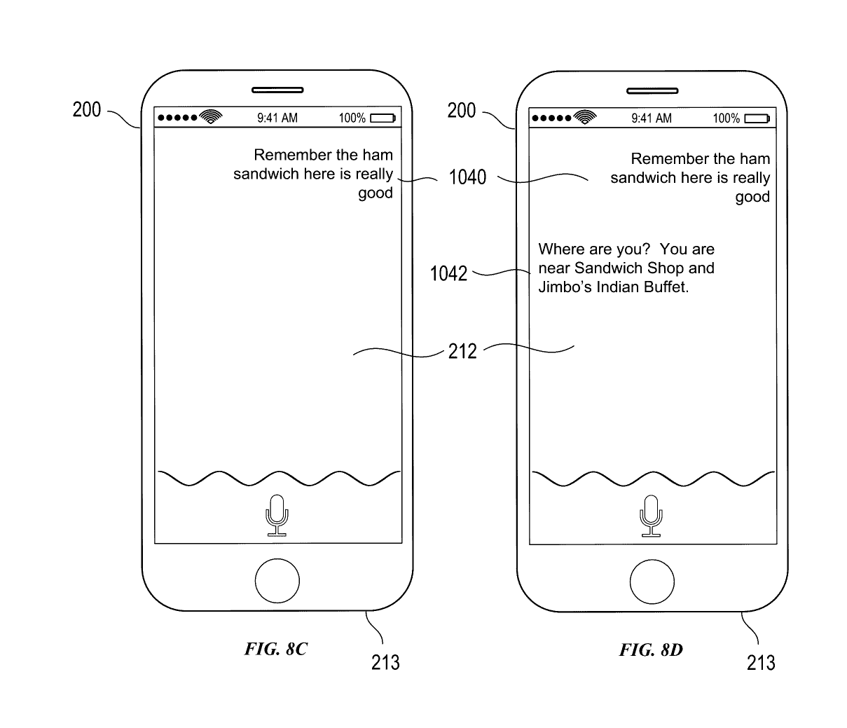

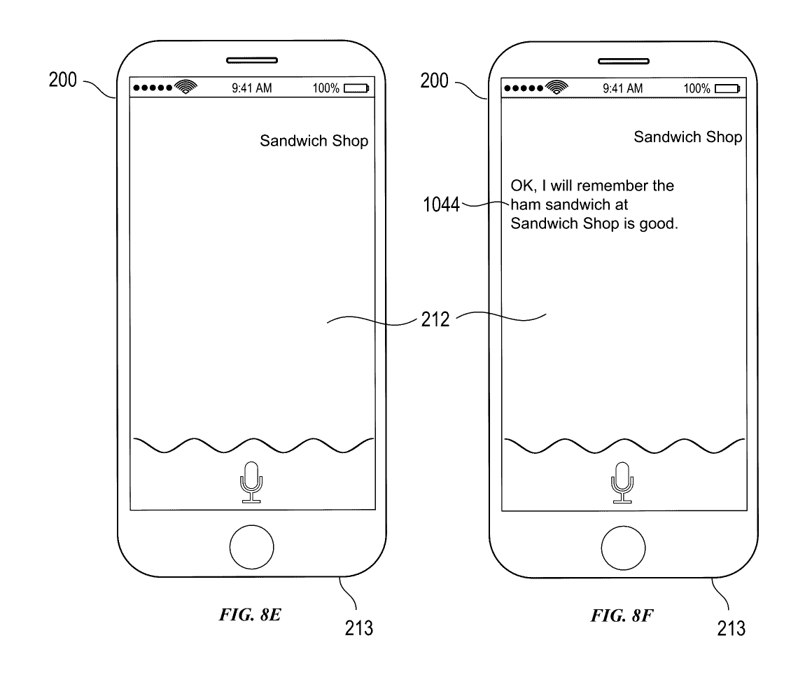

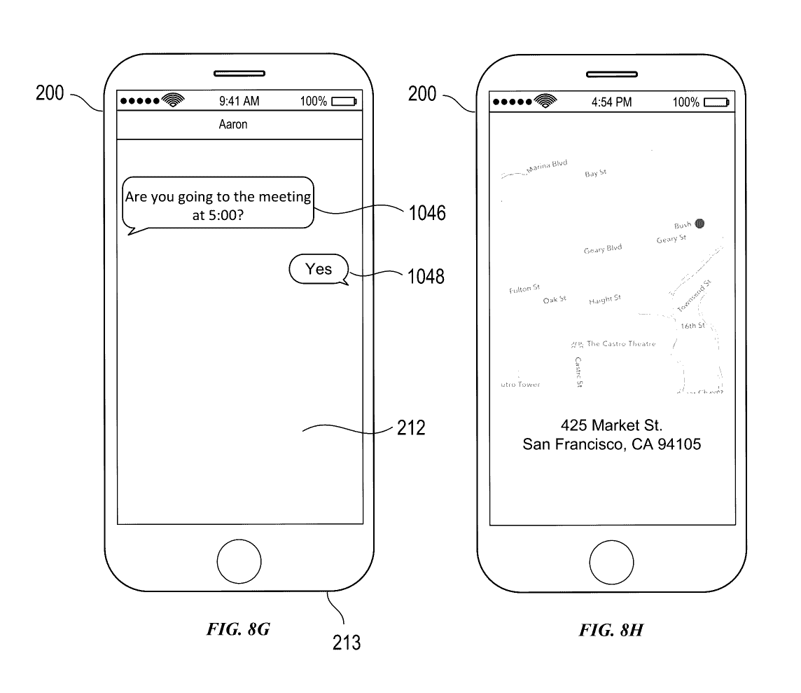

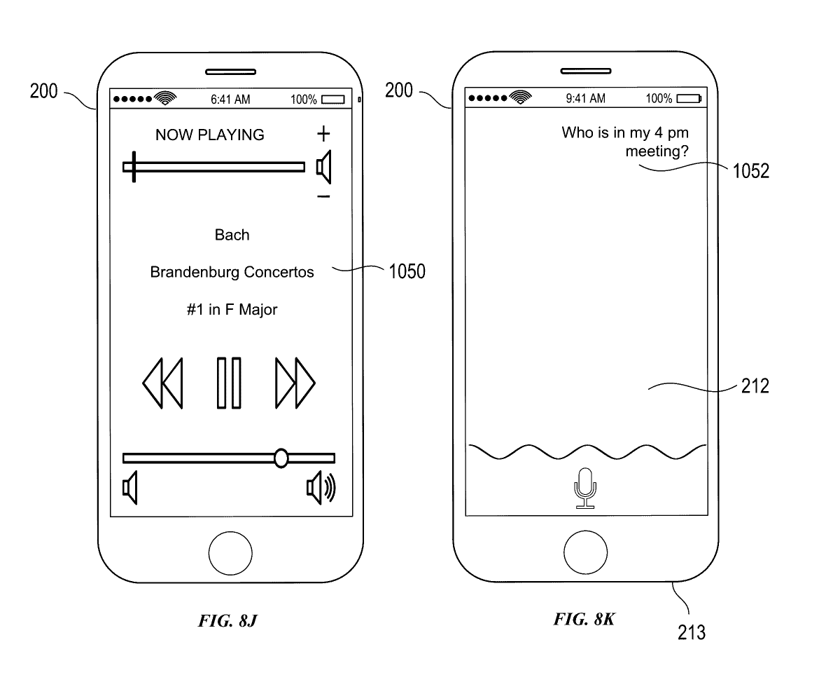

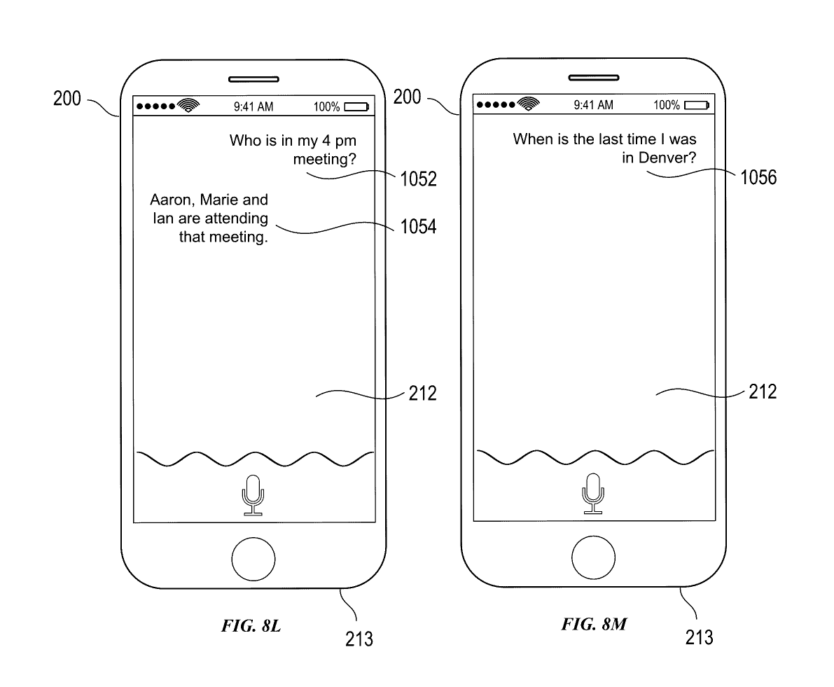

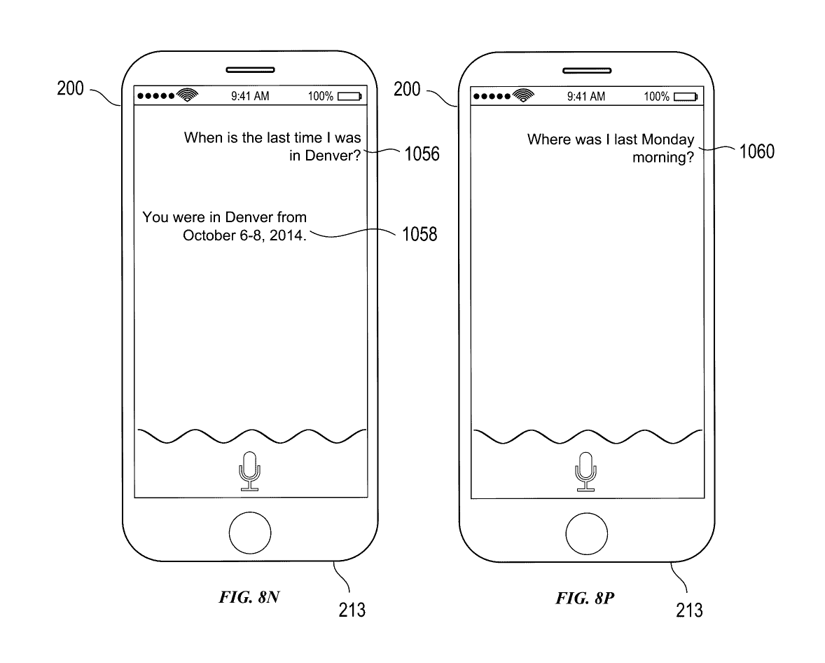

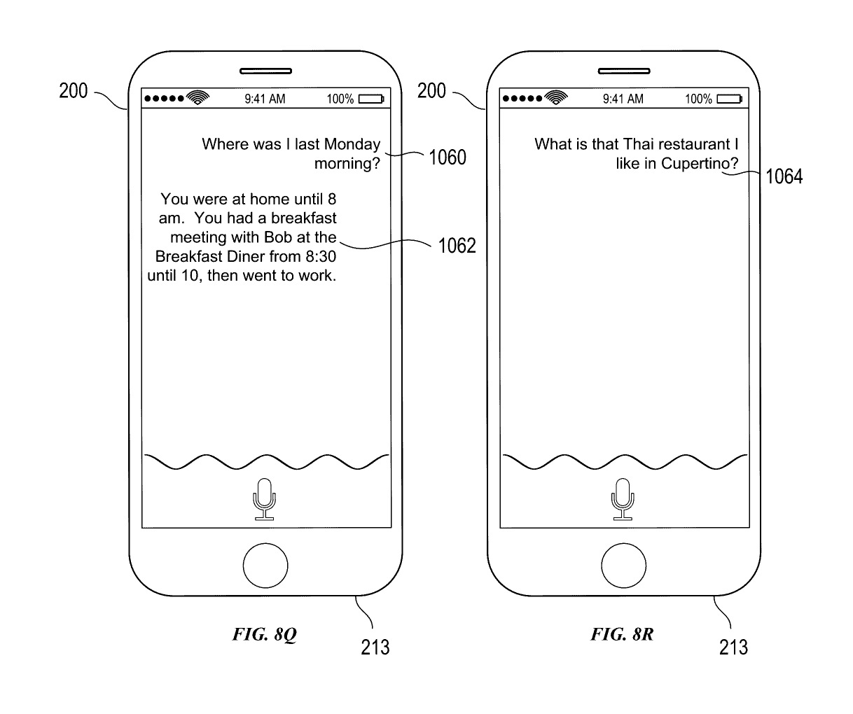

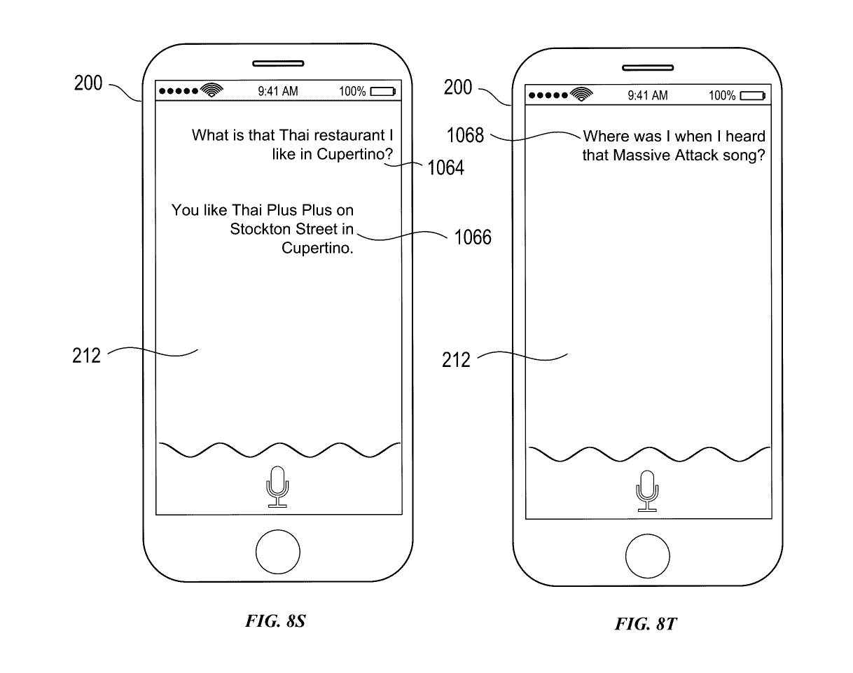

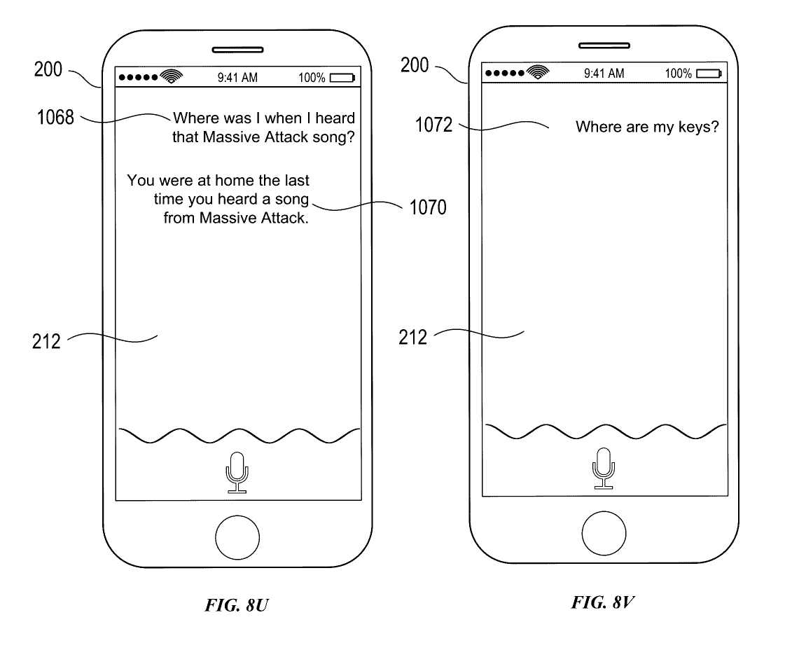

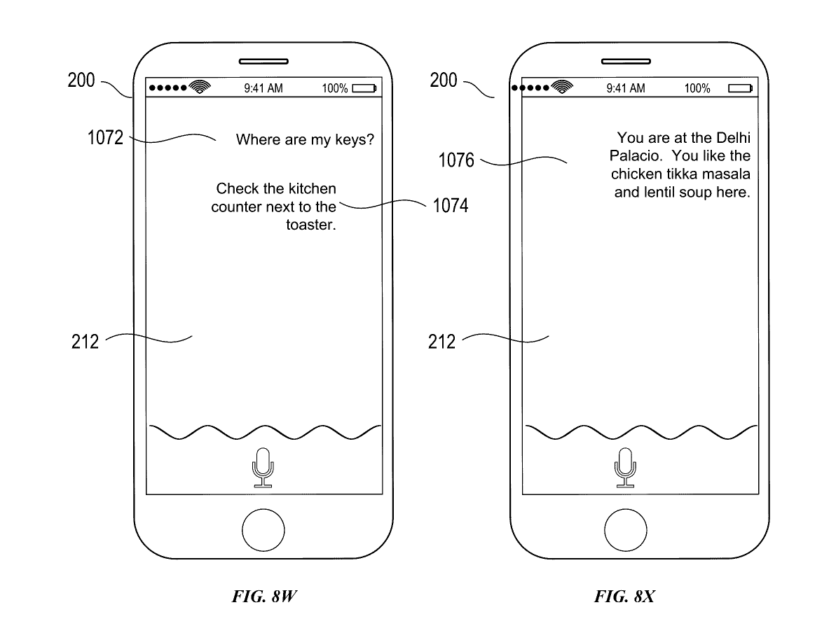

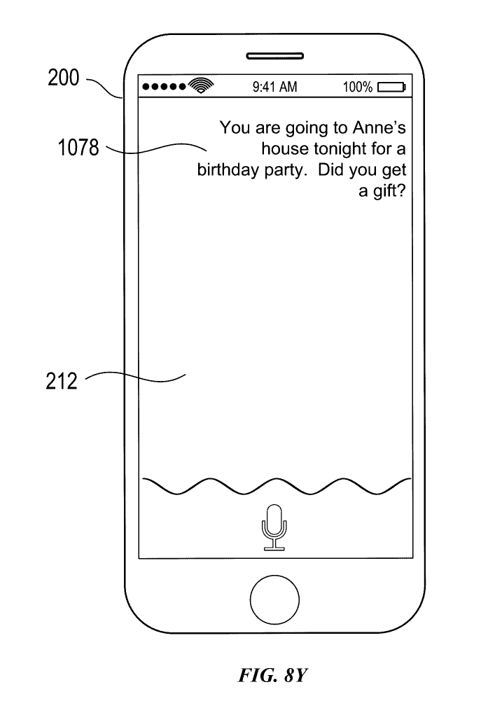

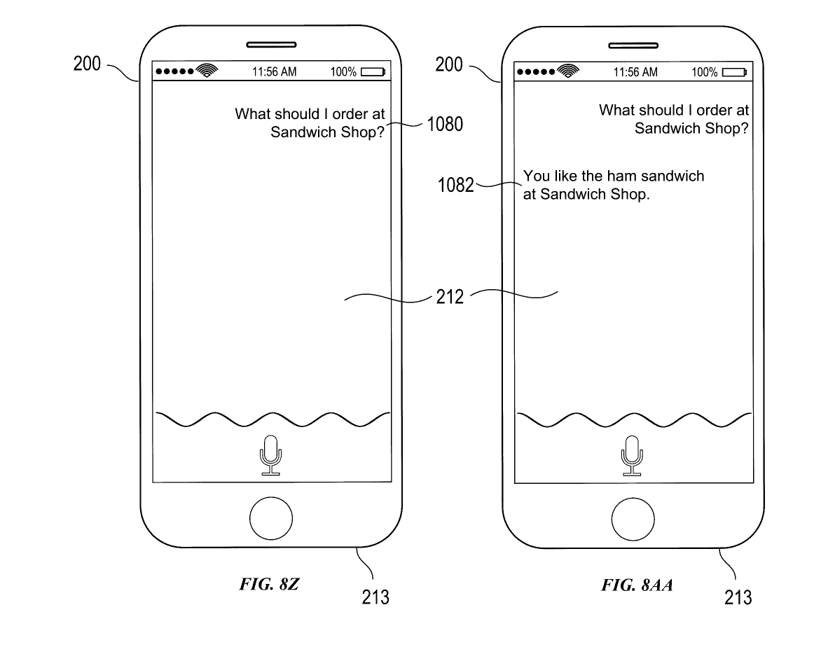

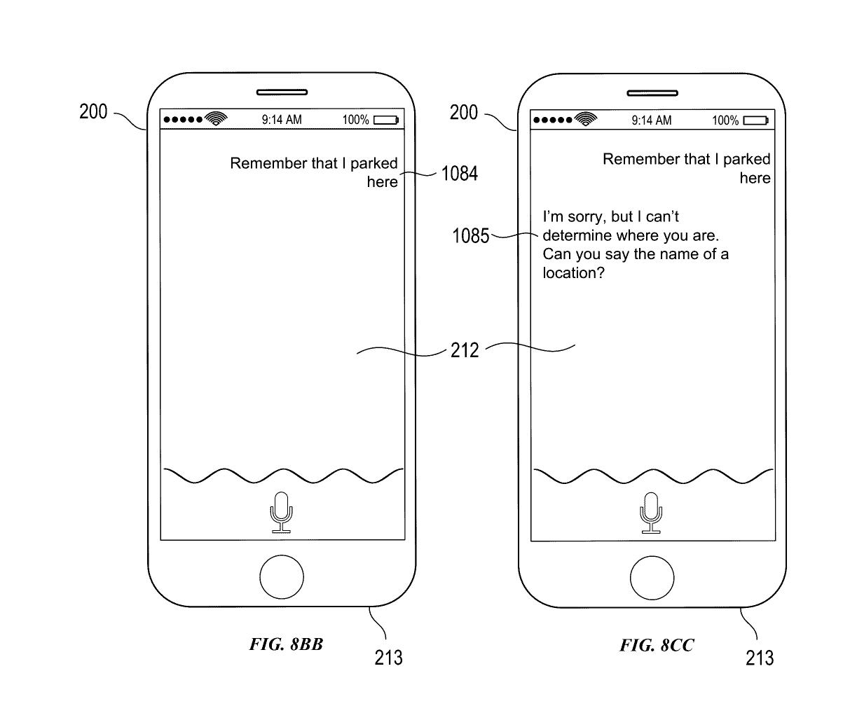

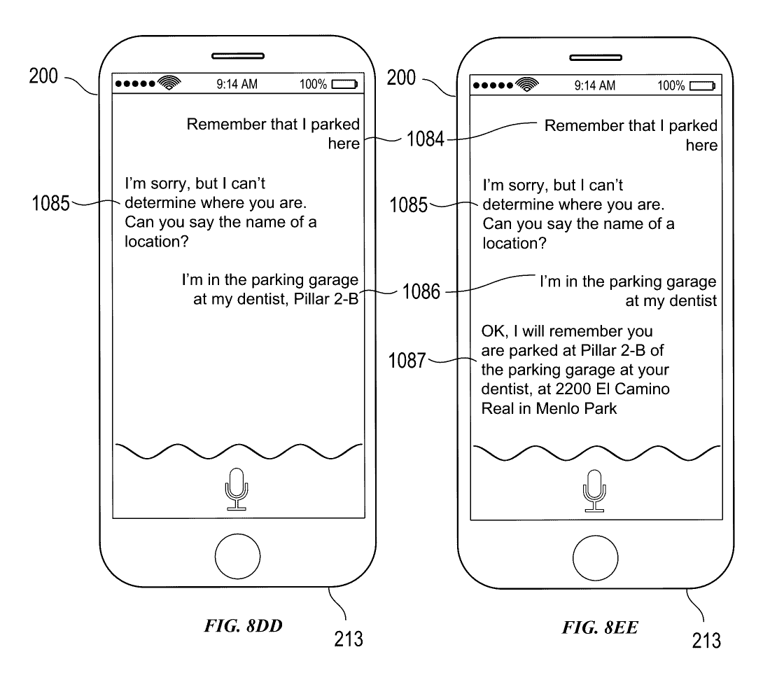

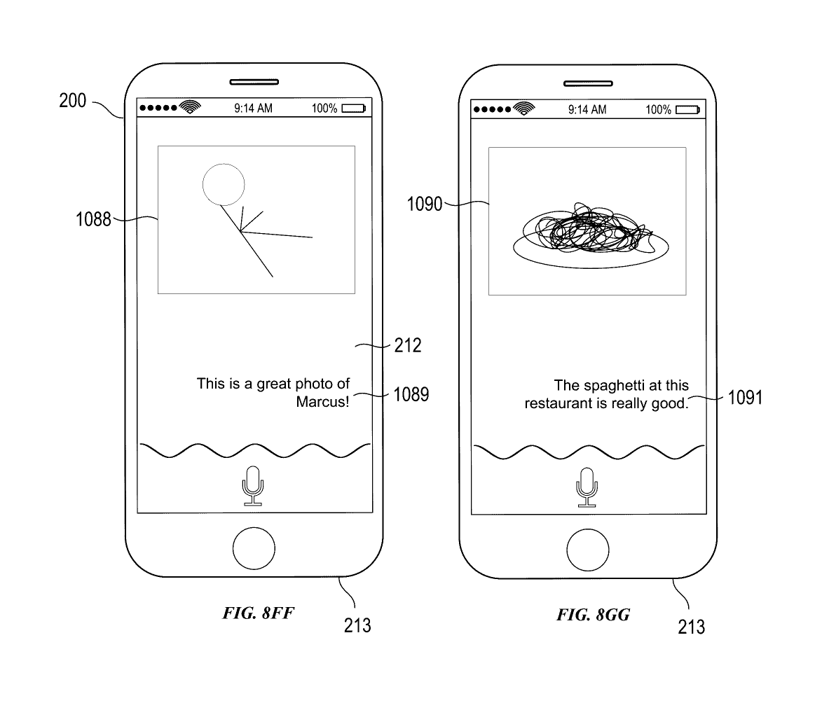

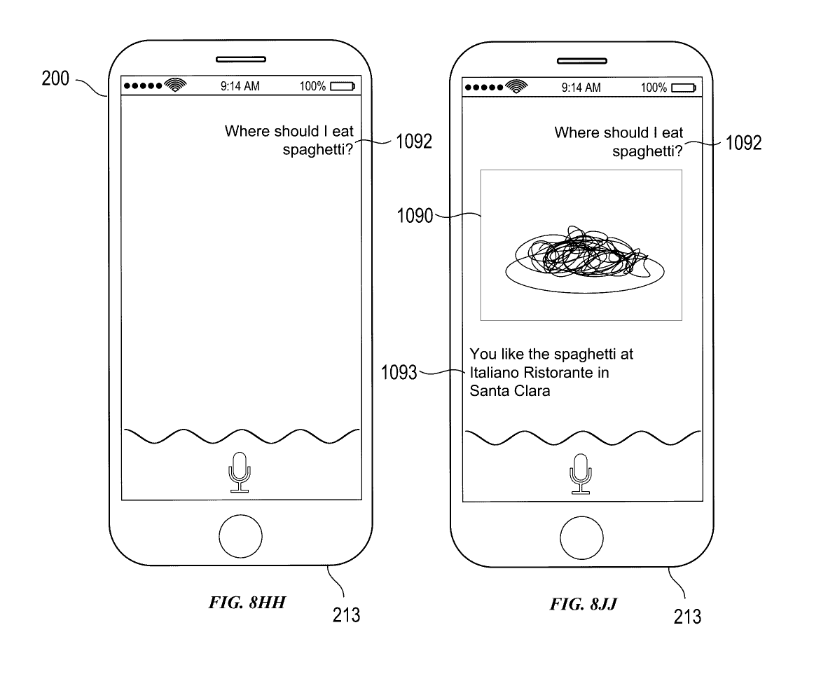

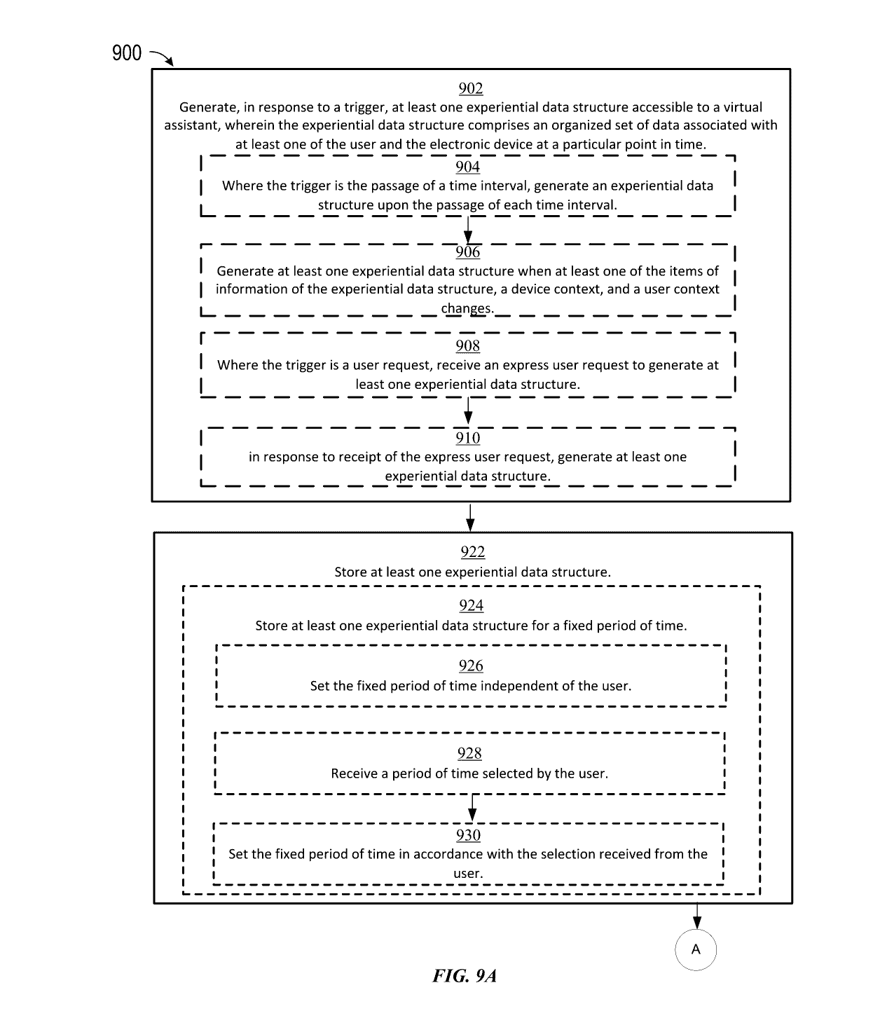

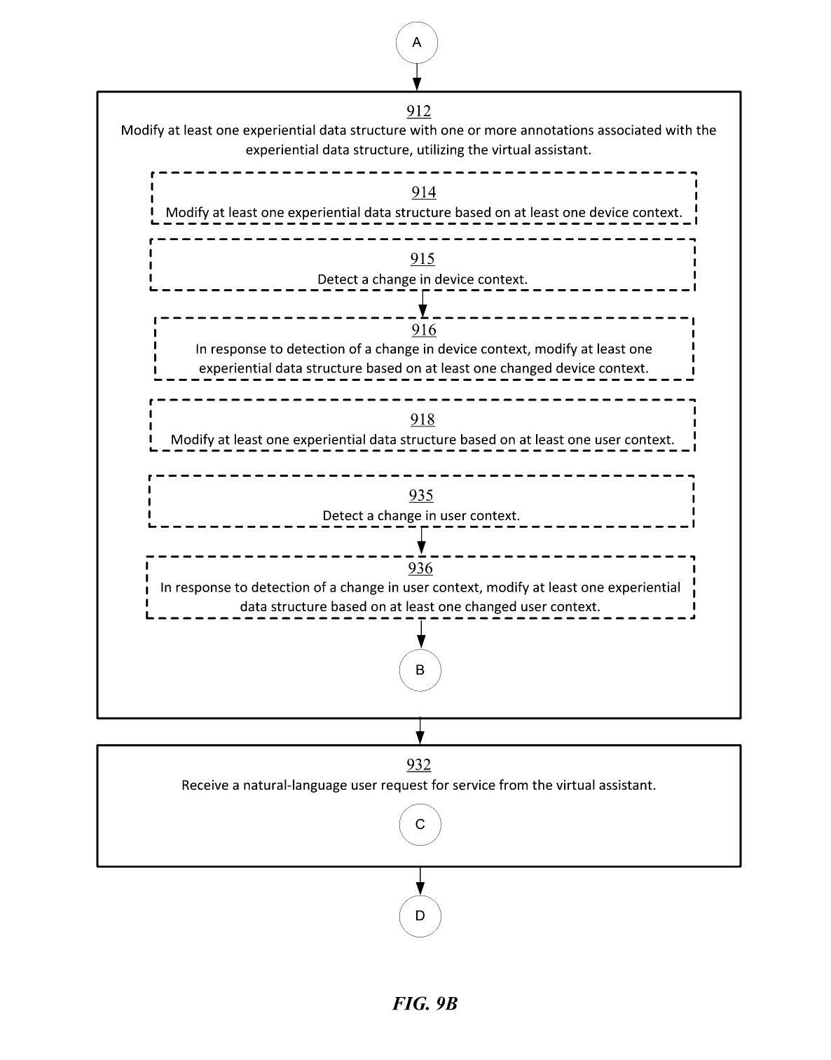

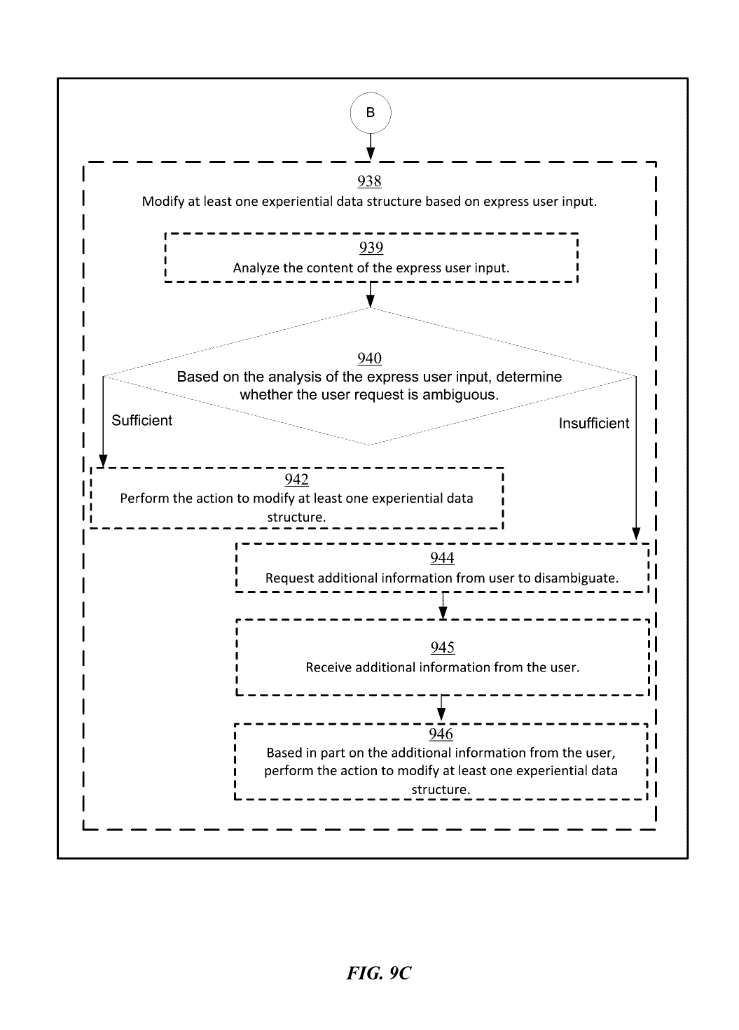

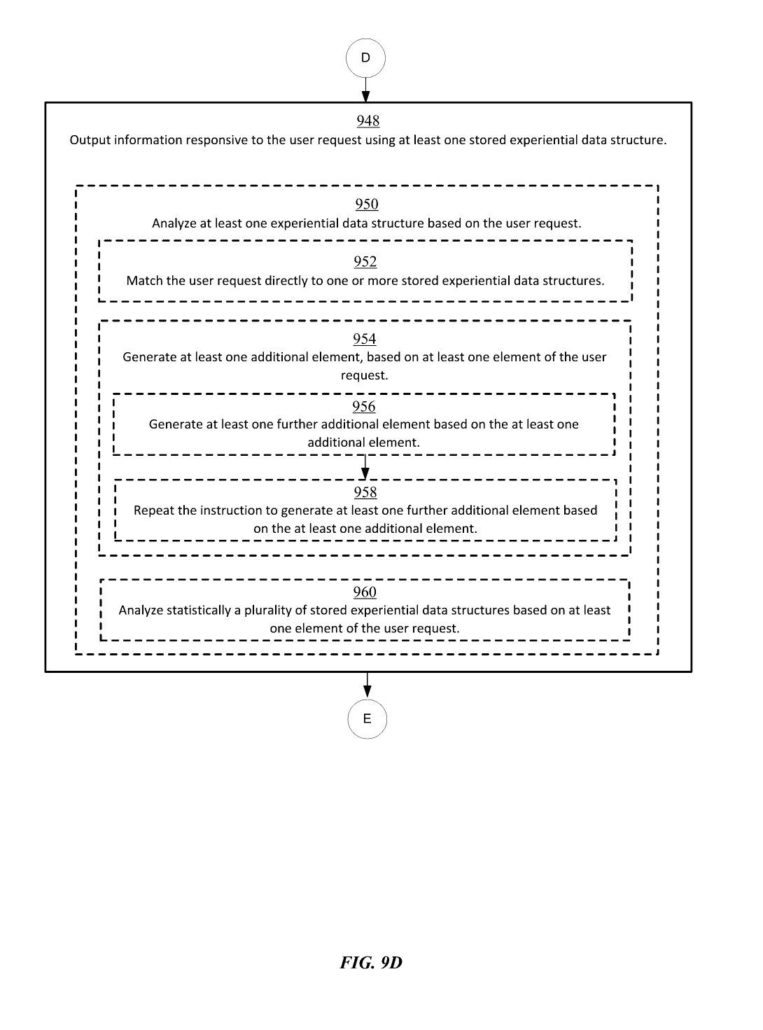

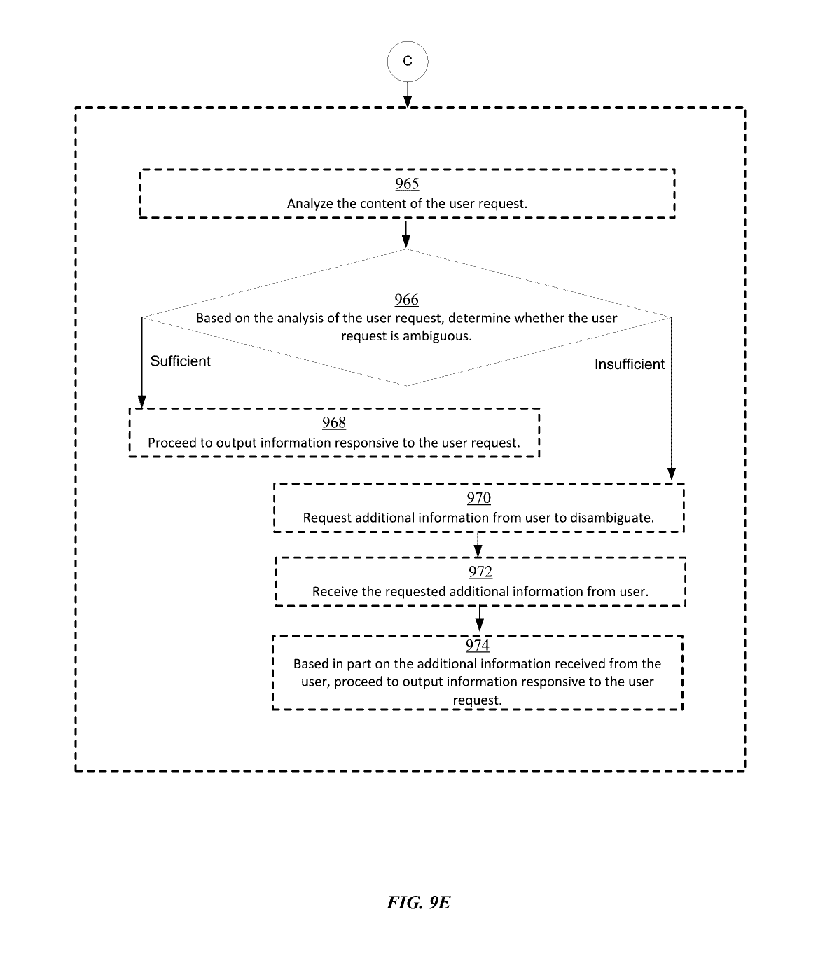

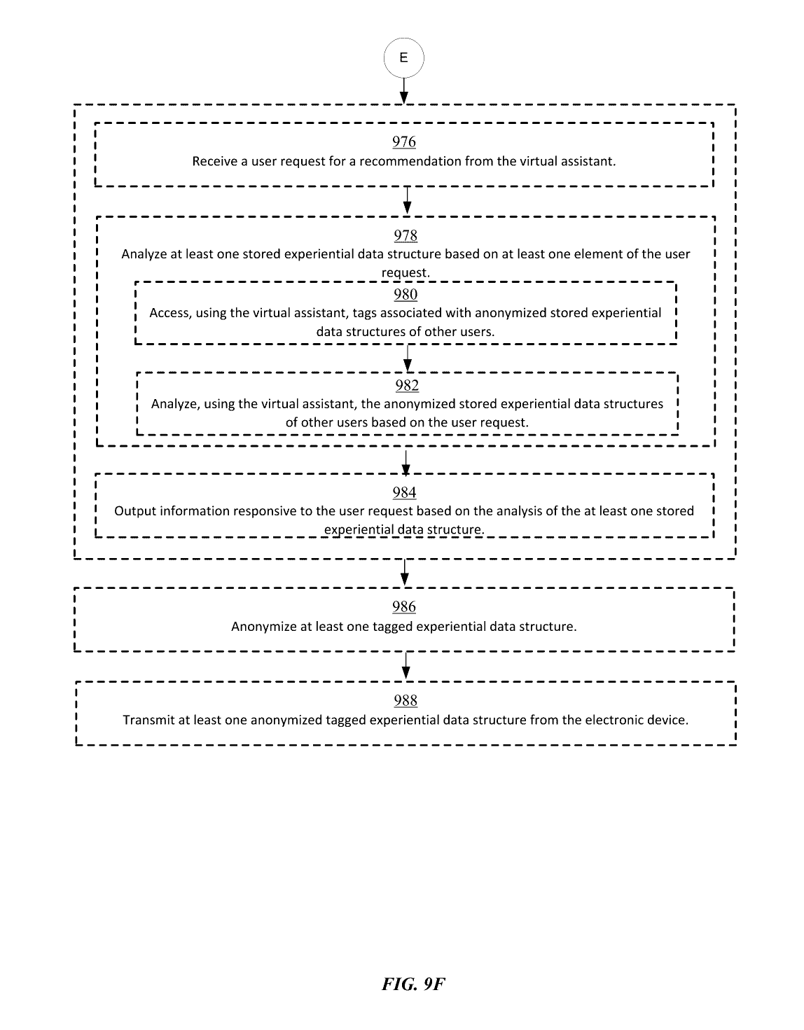

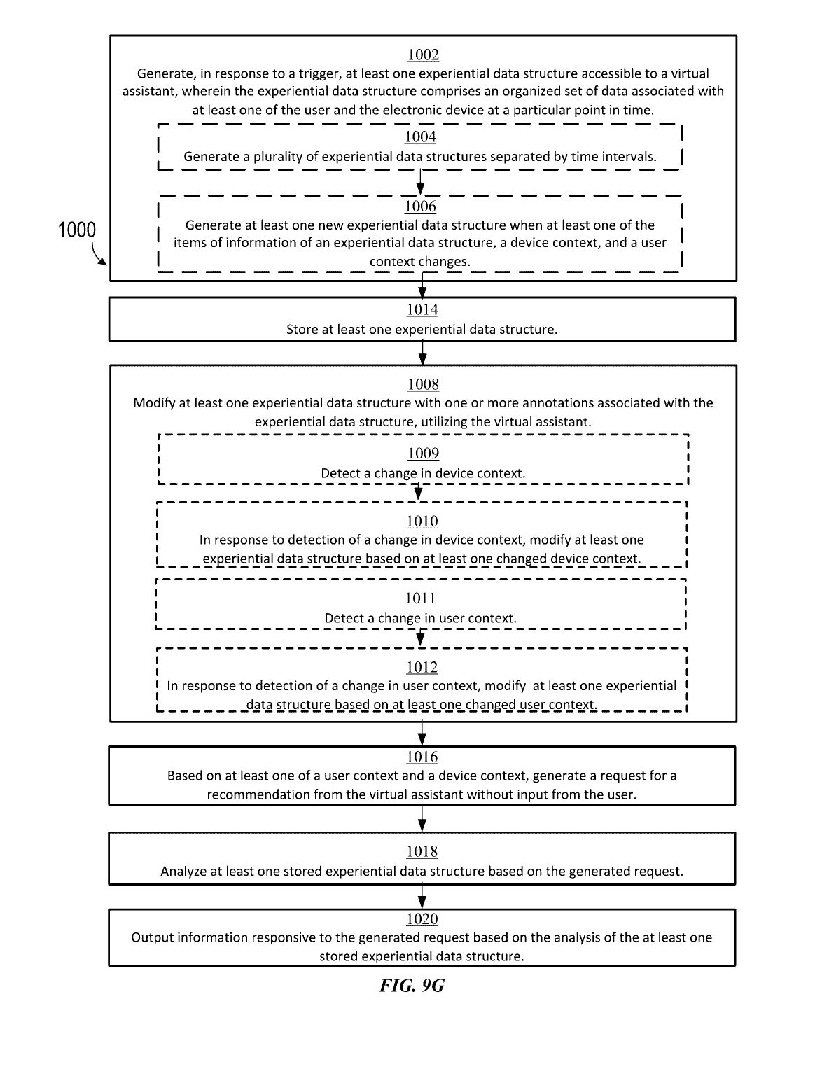

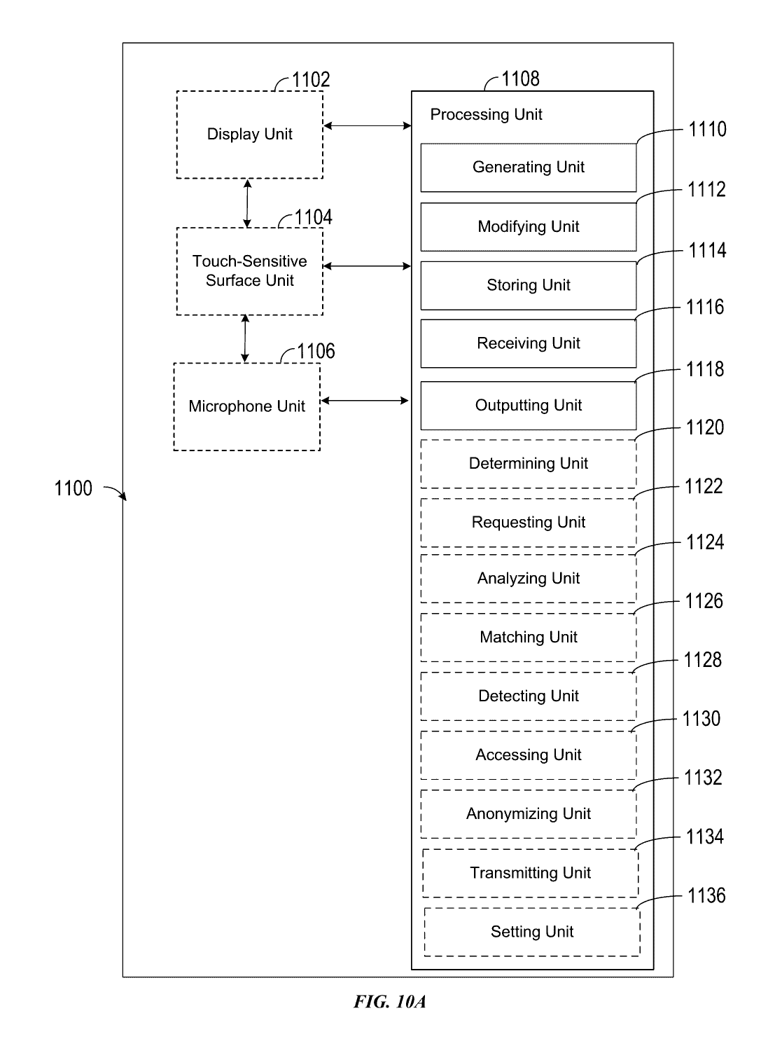

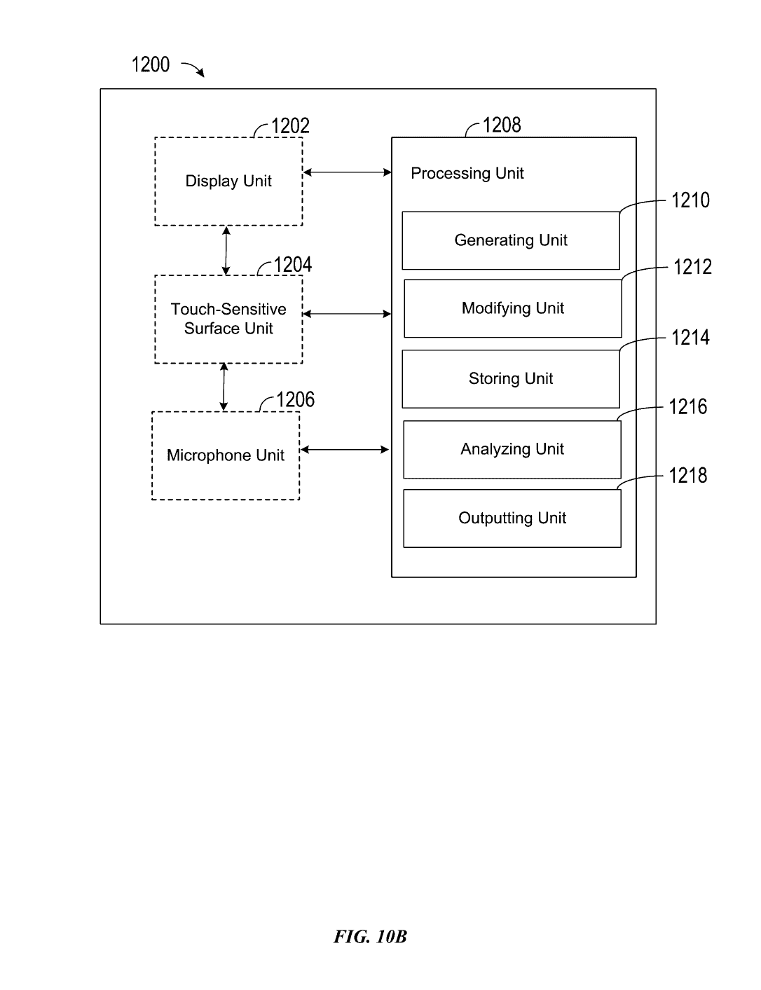

Below, FIGS. 1, 2A-2B, 3, 4, 5A-5B and 6A-6B provide a description of exemplary devices for performing the techniques for remembering user data and generating recommendations. FIGS. 7A-7C are block diagrams illustrating a digital assistant system or a server portion thereof, and a portion of an ontology associated with the digital assistant system. FIGS. 8A-8JJ illustrate exemplary user interfaces for remembering user data and generating recommendations. FIGS. 9A-9G are flow diagrams illustrating methods of remembering user data and generating recommendations in accordance with some embodiments. FIGS. 10A-10B are a functional block diagrams of an electronic device, according to various examples.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device may support a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

FIG. 1 illustrates a block diagram of system 100 according to various examples. In some examples, system 100 can implement a digital assistant. The terms “digital assistant,” “virtual assistant,” “intelligent automated assistant,” or “automatic digital assistant” can refer to any information processing system that interprets natural language input in spoken and/or textual form to infer user intent, and performs actions based on the inferred user intent. For example, to act on an inferred user intent, the system can perform one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form.

Specifically, a digital assistant can be capable of accepting a user request at least partially in the form of a natural language command, request, statement, narrative, and/or inquiry. Typically, the user request can seek either an informational answer or performance of a task by the digital assistant. A satisfactory response to the user request can be a provision of the requested informational answer, a performance of the requested task, or a combination of the two. For example, a user can ask the digital assistant a question, such as “Where am I right now?” Based on the user's current location, the digital assistant can answer, “You are in Central Park near the west gate.” The user can also request the performance of a task, for example, “Please invite my friends to my girlfriend's birthday party next week.” In response, the digital assistant can acknowledge the request by saying “Yes, right away,” and then send a suitable calendar invite on behalf of the user to each of the user's friends listed in the user's electronic address book. During performance of a requested task, the digital assistant can sometimes interact with the user in a continuous dialogue involving multiple exchanges of information over an extended period of time. There are numerous other ways of interacting with a digital assistant to request information or performance of various tasks. In addition to providing verbal responses and taking programmed actions, the digital assistant can also provide responses in other visual or audio forms, e.g., as text, alerts, music, videos, animations, etc.

As shown in FIG. 1, in some examples, a digital assistant can be implemented according to a client-server model. The digital assistant can include client-side portion 102 (hereafter “DA client 102”) executed on user device 104 and server-side portion 106 (hereafter “DA server 106”) executed on server system 108. DA client 102 can communicate with DA server 106 through one or more networks 110. DA client 102 can provide client-side functionalities such as user-facing input and output processing and communication with DA server 106. DA server 106 can provide server-side functionalities for any number of DA clients 102 each residing on a respective user device 104.

In some examples, DA server 106 can include client-facing I/O interface 112, one or more processing modules 114, data and models 116, and I/O interface to external services 118. The client-facing I/O interface 112 can facilitate the client-facing input and output processing for DA server 106. One or more processing modules 114 can utilize data and models 116 to process speech input and determine the user's intent based on natural language input. Further, one or more processing modules 114 perform task execution based on inferred user intent. In some examples, DA server 106 can communicate with external services 120 through network(s) 110 for task completion or information acquisition. I/O interface to external services 118 can facilitate such communications.

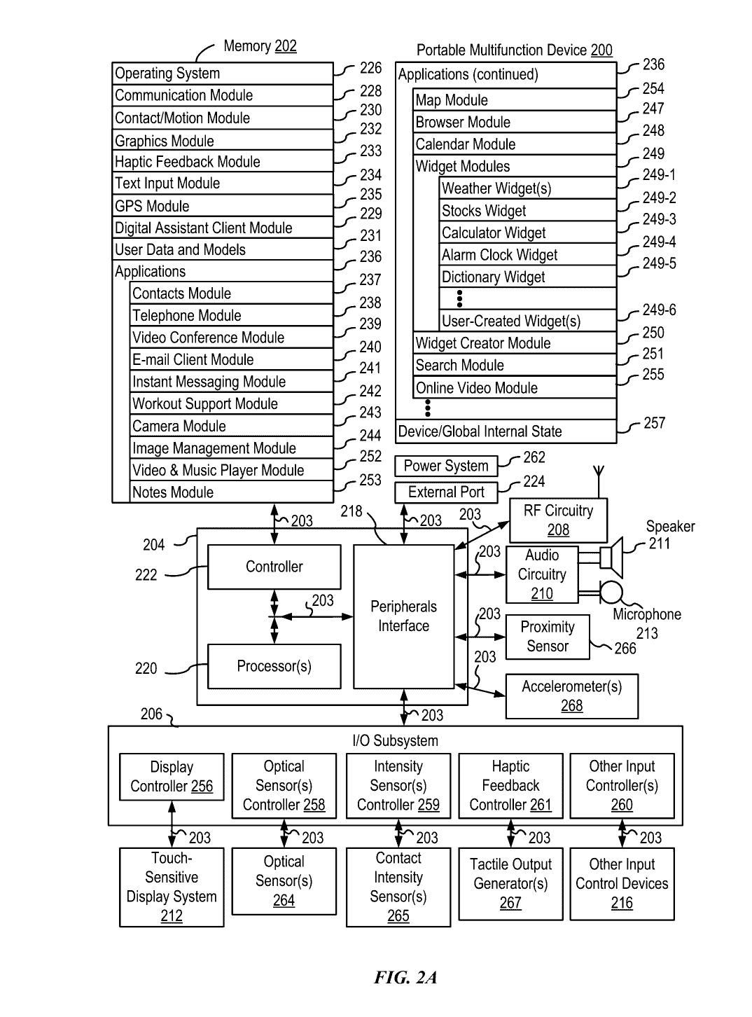

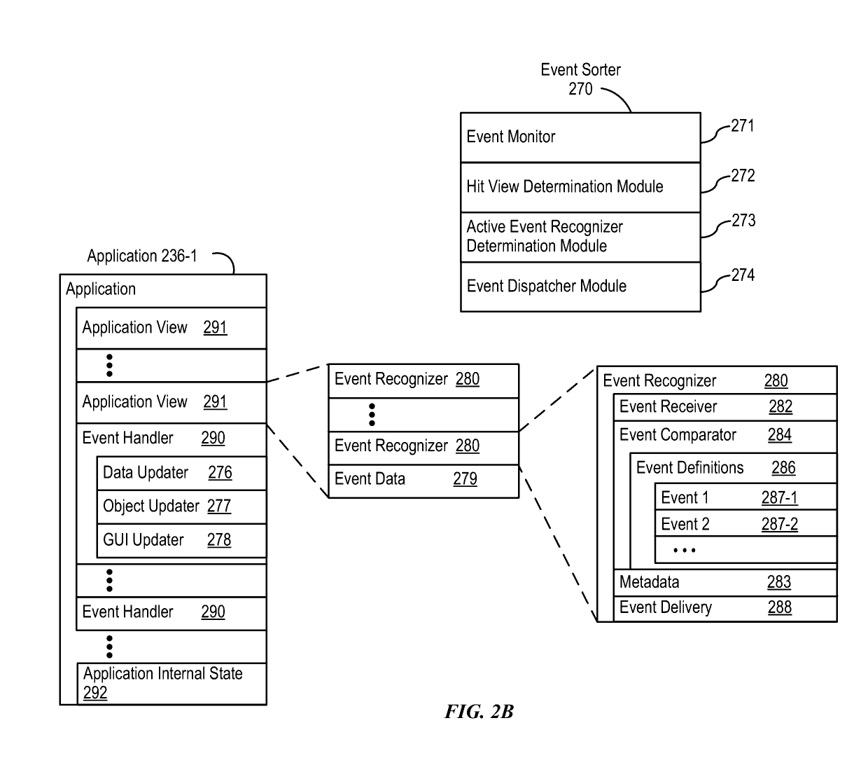

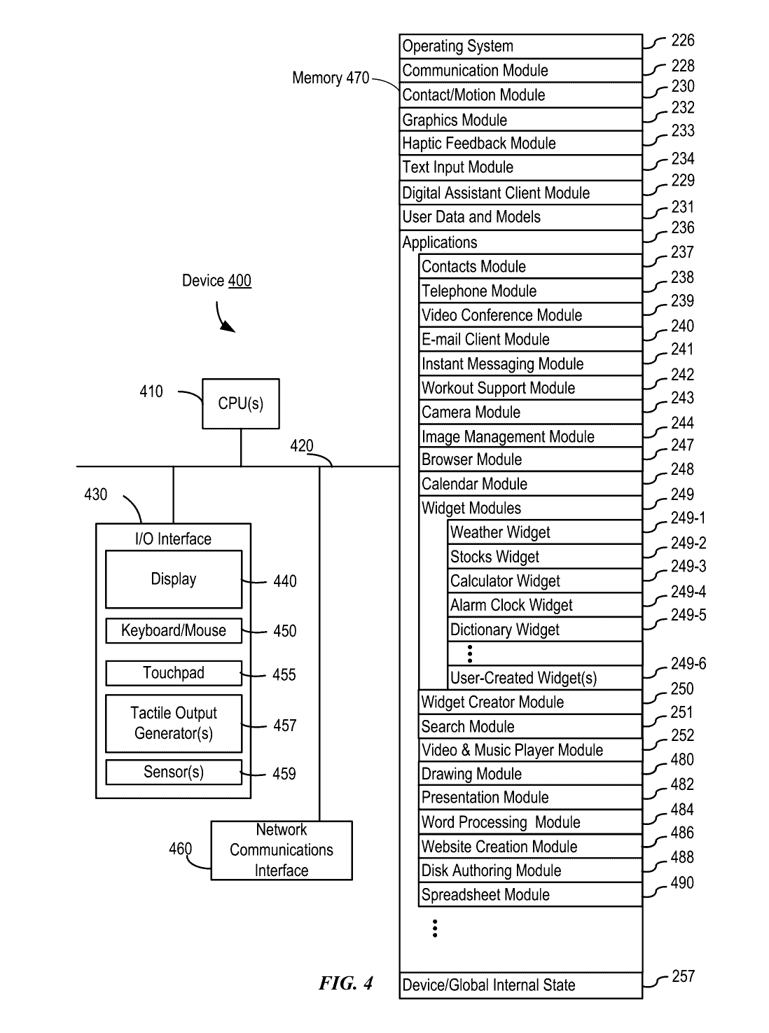

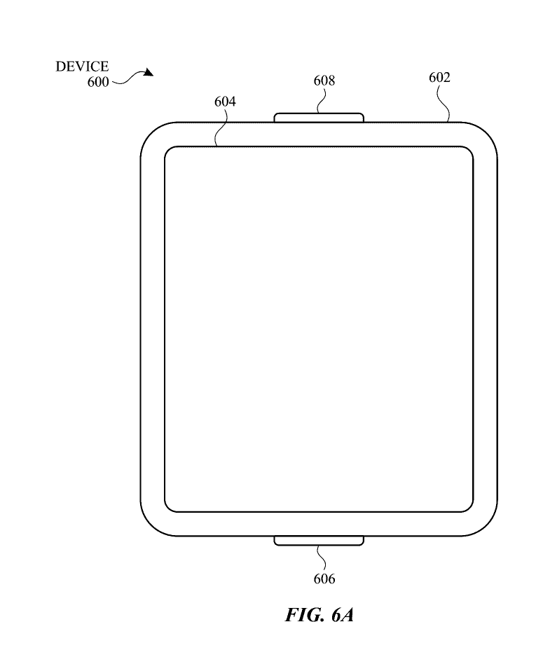

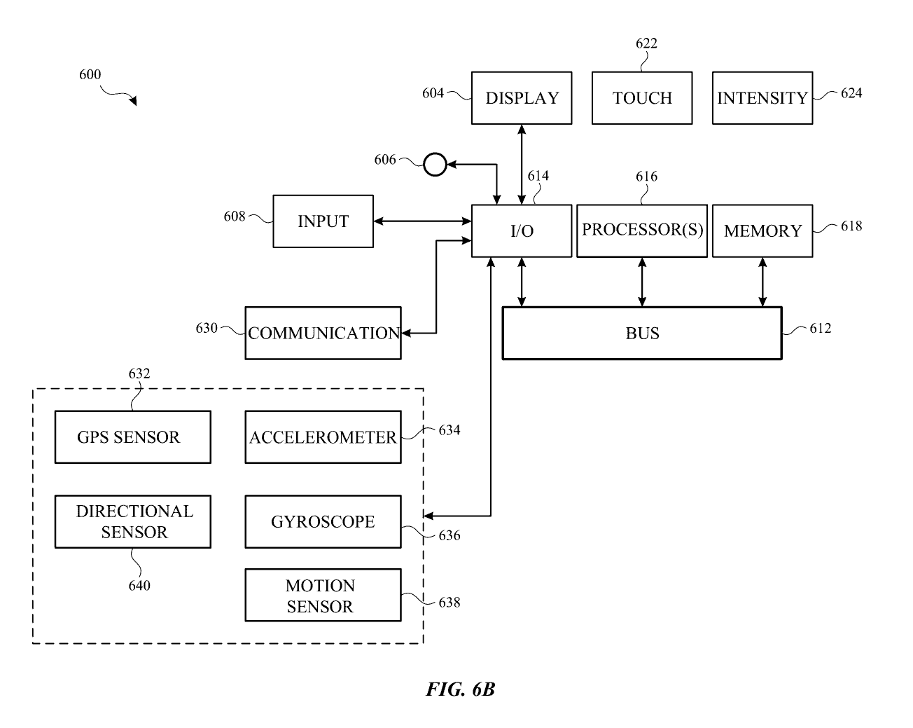

User device 104 can be any suitable electronic device. For example, user devices can be a portable multifunctional device (e.g., device 200, described below with reference to FIG. 2A), a multifunctional device (e.g., device 400, described below with reference to FIG. 4), or a personal electronic device (e.g., device 600, described below with reference to FIG. 6A-B.) A portable multifunctional device can be, for example, a mobile telephone that also contains other functions, such as PDA and/or music player functions. Specific examples of portable multifunction devices can include the iPhone®, iPod Touch®, and iPad® devices from Apple Inc. of Cupertino, Calif. Other examples of portable multifunction devices can include, without limitation, laptop or tablet computers. Further, in some examples, user device 104 can be a non-portable multifunctional device. In particular, user device 104 can be a desktop computer, a game console, a television, or a television set-top box. In some examples, user device 104 can include a touch-sensitive surface (e.g., touch screen displays and/or touchpads). Further, user device 104 can optionally include one or more other physical user-interface devices, such as a physical keyboard, a mouse, and/or a joystick. Various examples of electronic devices, such as multifunctional devices, are described below in greater detail.

Examples of communication network(s) 110 can include local area networks (LAN) and wide area networks (WAN), e.g., the Internet. Communication network(s) 110 can be implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

Server system 108 can be implemented on one or more standalone data processing apparatus or a distributed network of computers. In some examples, server system 108 can also employ various virtual devices and/or services of third-party service providers (e.g., third-party cloud service providers) to provide the underlying computing resources and/or infrastructure resources of server system 108.

In some examples, user device 104 can communicate with DA server 106 via second user device 122. Second user device 122 can be similar or identical to user device 104. For example, second user device 122 can be similar to devices 200, 400, or 600 described below with reference to FIGS. 2A, 4, and 6A-B. User device 104 can be configured to communicatively couple to second user device 122 via a direct communication connection, such as Bluetooth, NFC, BTLE, or the like, or via a wired or wireless network, such as a local Wi-Fi network. In some examples, second user device 122 can be configured to act as a proxy between user device 104 and DA server 106. For example, DA client 102 of user device 104 can be configured to transmit information (e.g., a user request received at user device 104) to DA server 106 via second user device 122. DA server 106 can process the information and return relevant data (e.g., data content responsive to the user request) to user device 104 via second user device 122.

In some examples, user device 104 can be configured to communicate abbreviated requests for data to second user device 122 to reduce the amount of information transmitted from user device 104. Second user device 122 can be configured to determine supplemental information to add to the abbreviated request to generate a complete request to transmit to DA server 106. This system architecture can advantageously allow user device 104 having limited communication capabilities and/or limited battery power (e.g., a watch or a similar compact electronic device) to access services provided by DA server 106 by using second user device 122, having greater communication capabilities and/or battery power (e.g., a mobile phone, laptop computer, tablet computer, or the like), as a proxy to DA server 106. While only two user devices 104 and 122 are shown in FIG. 1, it should be appreciated that system 100 can include any number and type of user devices configured in this proxy configuration to communicate with DA server system 106.

Although the digital assistant shown in FIG. 1 can include both a client-side portion (e.g., DA client 102) and a server-side portion (e.g., DA server 106), in some examples, the functions of a digital assistant can be implemented as a standalone application installed on a user device. In addition, the divisions of functionalities between the client and server portions of the digital assistant can vary in different implementations. For instance, in some examples, the DA client can be a thin-client that provides only user-facing input and output processing functions, and delegates all other functionalities of the digital assistant to a backend server.

### 2. Electronic Devices

Attention is now directed toward embodiments of electronic devices for implementing the client-side portion of a digital assistant. FIG. 2A is a block diagram illustrating portable multifunction device 200 with touch-sensitive display system 212 in accordance with some embodiments. Touch-sensitive display 212 is sometimes called a “touch screen” for convenience and is sometimes known as or called a “touch-sensitive display system.” Device 200 includes memory 202 (which optionally includes one or more computer-readable storage mediums), memory controller 222, one or more processing units (CPUs) 220, peripherals interface 218, RF circuitry 208, audio circuitry 210, speaker 211, microphone 213, input/output (I/O) subsystem 206, other input control devices 216, and external port 224. Device 200 optionally includes one or more optical sensors 264. Device 200 optionally includes one or more contact intensity sensors 265 for detecting intensity of contacts on device 200 (e.g., a touch-sensitive surface such as touch-sensitive display system 212 of device 200). Device 200 optionally includes one or more tactile output generators 267 for generating tactile outputs on device 200 (e.g., generating tactile outputs on a touch-sensitive surface such as touch-sensitive display system 212 of device 200 or touchpad 455 of device 400). These components optionally communicate over one or more communication buses or signal lines 203.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 200 is only one example of a portable multifunction device, and that device 200 optionally has more or fewer components than shown, optionally combines two or more components, or optionally has a different configuration or arrangement of the components. The various components shown in FIG. 2A are implemented in hardware, software, or a combination of both hardware and software, including one or more signal processing and/or application-specific integrated circuits.

Memory 202 optionally can include one or more computer-readable storage mediums. The computer-readable storage mediums optionally can be tangible and non-transitory. Memory 202 optionally can include high-speed random access memory and optionally also can include non-volatile memory, such as one or more magnetic disk storage devices, flash memory devices, or other non-volatile solid-state memory devices. Memory controller 222 optionally can control access to memory 202 by other components of device 200.

In some examples, a non-transitory computer-readable storage medium of memory 202 can be used to store instructions (e.g., for performing aspects of process 900, described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of process 900, described below) can be stored on a non-transitory computer-readable storage medium (not shown) of the server system 108 or can be divided between the non-transitory computer-readable storage medium of memory 202 and the non-transitory computer-readable storage medium of server system 108. In the context of this document, a “non-transitory computer-readable storage medium” can be any medium that can contain or store the program for use by or in connection with the instruction execution system, apparatus, or device.

Peripherals interface 218 can be used to couple input and output peripherals of the device to CPU 220 and memory 202. The one or more processors 220 run or execute various software programs and/or sets of instructions stored in memory 202 to perform various functions for device 200 and to process data. In some embodiments, peripherals interface 218, CPU 220, and memory controller 222 optionally can be implemented on a single chip, such as chip 204. In some other embodiments, they optionally can be implemented on separate chips.

RF (radio frequency) circuitry 208 receives and sends RF signals, also called electromagnetic signals. RF circuitry 208 converts electrical signals to/from electromagnetic signals and communicates with communications networks and other communications devices via the electromagnetic signals. RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 208 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

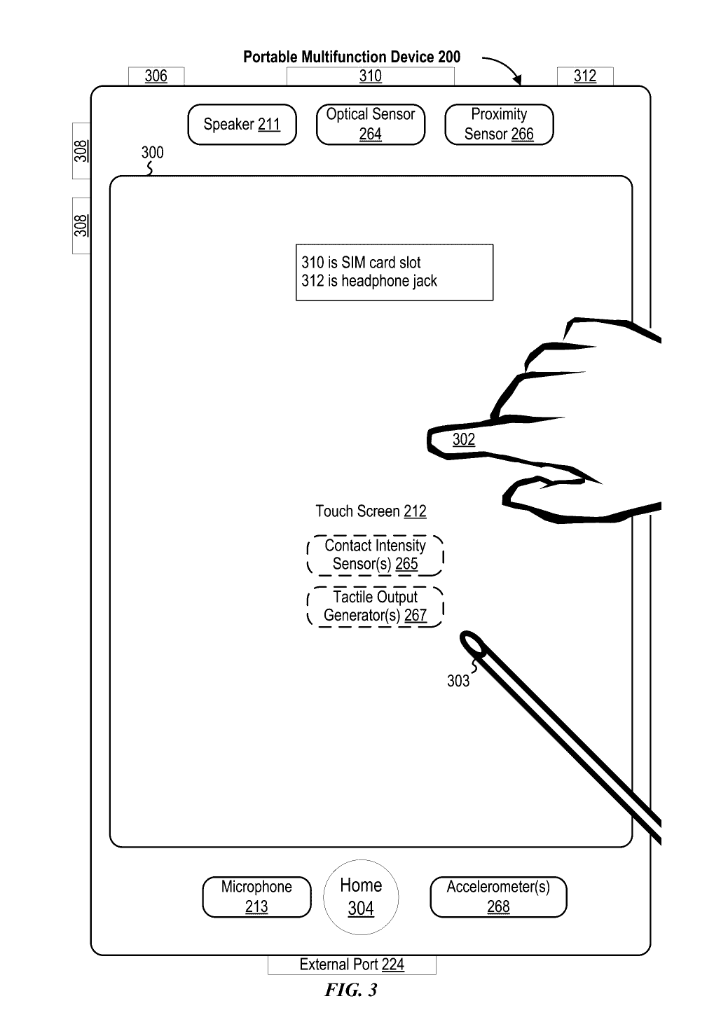

Audio circuitry 210, speaker 211, and microphone 213 provide an audio interface between a user and device 200. Audio circuitry 210 receives audio data from peripherals interface 218, converts the audio data to an electrical signal, and transmits the electrical signal to speaker 211. Speaker 211 converts the electrical signal to human-audible sound waves. Audio circuitry 210 also receives electrical signals converted by microphone 213 from sound waves. Audio circuitry 210 converts the electrical signal to audio data and transmits the audio data to peripherals interface 218 for processing. Audio data optionally can be retrieved from and/or transmitted to memory 202 and/or RF circuitry 208 by peripherals interface 218. In some embodiments, audio circuitry 210 also includes a headset jack (e.g., 312, FIG. 3). The headset jack provides an interface between audio circuitry 210 and removable audio input/output peripherals, such as output-only headphones or a headset with both output (e.g., a headphone for one or both ears) and input (e.g., a microphone).

I/O subsystem 206 couples input/output peripherals on device 200, such as touch screen 212 and other input control devices 216, to peripherals interface 218. I/O subsystem 206 optionally includes display controller 256, optical sensor controller 258, intensity sensor controller 259, haptic feedback controller 261, and one or more input controllers 260 for other input or control devices. The one or more input controllers 260 receive/send electrical signals from/to other input control devices 216. The other input control devices 216 optionally include physical buttons (e.g., push buttons, rocker buttons, etc.), dials, slider switches, joysticks, click wheels, and so forth. In some alternate embodiments, input controller(s) 260 are, optionally, coupled to any (or none) of the following: a keyboard, an infrared port, a USB port, and a pointer device such as a mouse. The one or more buttons (e.g., 308, FIG. 3) optionally include an up/down button for volume control of speaker 211 and/or microphone 213. The one or more buttons optionally include a push button (e.g., 306, FIG. 3).

A quick press of the push button optionally can disengage a lock of touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 306) optionally can turn power to device 200 on or off. The user optionally can be able to customize a functionality of one or more of the buttons. Touch screen 212 is used to implement virtual or soft buttons and one or more soft keyboards.

Touch-sensitive display 212 provides an input interface and an output interface between the device and a user. Display controller 256 receives and/or sends electrical signals from/to touch screen 212. Touch screen 212 displays visual output to the user. The visual output optionally can include graphics, text, icons, video, and any combination thereof (collectively termed “graphics”). In some embodiments, some or all of the visual output optionally can correspond to user-interface objects.

Touch screen 212 has a touch-sensitive surface, sensor, or set of sensors that accepts input from the user based on haptic and/or tactile contact. Touch screen 212 and display controller 256 (along with any associated modules and/or sets of instructions in memory 202) detect contact (and any movement or breaking of the contact) on touch screen 212 and convert the detected contact into interaction with user-interface objects (e.g., one or more soft keys, icons, web pages, or images) that are displayed on touch screen 212. In an exemplary embodiment, a point of contact between touch screen 212 and the user corresponds to a finger of the user.

Touch screen 212 optionally can use LCD (liquid crystal display) technology, LPD (light emitting polymer display) technology, or LED (light emitting diode) technology, although other display technologies optionally can be used in other embodiments. Touch screen 212 and display controller 256 optionally can detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 212. In an exemplary embodiment, projected mutual capacitance sensing technology is used, such as that found in the iPhone® and iPod Touch® from Apple Inc. of Cupertino, Calif.

A touch-sensitive display in some embodiments of touch screen 212 optionally can be analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 212 displays visual output from device 200, whereas touch-sensitive touchpads do not provide visual output.

A touch-sensitive display in some embodiments of touch screen 212 optionally can be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 212 optionally can have a video resolution in excess of 100 dpi. In some embodiments, the touch screen has a video resolution of approximately 160 dpi. The user optionally can make contact with touch screen 212 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 200 optionally can include a touchpad (not shown) for activating or deactivating particular functions. In some embodiments, the touchpad is a touch-sensitive area of the device that, unlike the touch screen, does not display visual output. The touchpad optionally can be a touch-sensitive surface that is separate from touch screen 212 or an extension of the touch-sensitive surface formed by the touch screen.

Device 200 also includes power system 262 for powering the various components. Power system 262 optionally can include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 200 optionally also can include one or more optical sensors 264. FIG. 2A shows an optical sensor coupled to optical sensor controller 258 in I/O subsystem 206. Optical sensor 264 optionally can include charge-coupled device (CCD) or complementary metal-oxide semiconductor (CMOS) phototransistors. Optical sensor 264 receives light from the environment, projected through one or more lenses, and converts the light to data representing an image. In conjunction with imaging module 243 (also called a camera module), optical sensor 264 optionally can capture still images or video. In some embodiments, an optical sensor is located on the back of device 200, opposite touch screen display 212 on the front of the device so that the touch screen display optionally can be used as a viewfinder for still and/or video image acquisition. In some embodiments, an optical sensor is located on the front of the device so that the user's image optionally can be obtained for video conferencing while the user views the other video conference participants on the touch screen display. In some embodiments, the position of optical sensor 264 can be changed by the user (e.g., by rotating the lens and the sensor in the device housing) so that a single optical sensor 264 optionally can be used along with the touch screen display for both video conferencing and still and/or video image acquisition.

Device 200 optionally also includes one or more contact intensity sensors 265. FIG. 2A shows a contact intensity sensor coupled to intensity sensor controller 259 in I/O subsystem 206. Contact intensity sensor 265 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 265 receives contact intensity information (e.g., pressure information or a proxy for pressure information) from the environment. In some embodiments, at least one contact intensity sensor is collocated with, or proximate to, a touch-sensitive surface (e.g., touch-sensitive display system 212). In some embodiments, at least one contact intensity sensor is located on the back of device 200, opposite touch screen display 212, which is located on the front of device 200.

Device 200 optionally also can include one or more proximity sensors 266. FIG. 2A shows proximity sensor 266 coupled to peripherals interface 218. Alternately, proximity sensor 266 optionally can be coupled to input controller 260 in I/O subsystem 206. Proximity sensor 266 optionally can perform as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 212 when the multifunction device is placed near the user's ear (e.g., when the user is making a phone call).

Device 200 optionally also includes one or more tactile output generators 267. FIG. 2A shows a tactile output generator coupled to haptic feedback controller 261 in I/O subsystem 206. Tactile output generator 267 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 265 receives tactile feedback generation instructions from haptic feedback module 233 and generates tactile outputs on device 200 that are capable of being sensed by a user of device 200. In some embodiments, at least one tactile output generator is collocated with, or proximate to, a touch-sensitive surface (e.g., touch-sensitive display system 212) and, optionally, generates a tactile output by moving the touch-sensitive surface vertically (e.g., in/out of a surface of device 200) or laterally (e.g., back and forth in the same plane as a surface of device 200). In some embodiments, at least one tactile output generator sensor is located on the back of device 200, opposite touch screen display 212, which is located on the front of device 200.

Device 200 optionally also can include one or more accelerometers 268. FIG. 2A shows accelerometer 268 coupled to peripherals interface 218. Alternately, accelerometer 268 optionally can be coupled to an input controller 260 in I/O subsystem 206. Accelerometer 268 optionally can perform as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 200 optionally includes, in addition to accelerometer(s) 268, a magnetometer (not shown) and a GPS (or GLONASS or other global navigation system) receiver (not shown) for obtaining information concerning the location and orientation (e.g., portrait or landscape) of device 200.

In some embodiments, the software components stored in memory 202 include operating system 226, communication module (or set of instructions) 228, contact/motion module (or set of instructions) 230, graphics module (or set of instructions) 232, text input module (or set of instructions) 234, Global Positioning System (GPS) module (or set of instructions) 235, Digital Assistant Client Module 229, and applications (or sets of instructions) 236. Further, memory 202 can store data and models, such as user data and models 231. Furthermore, in some embodiments, memory 202 (FIG. 2A) or 470 (FIG. 4) stores device/global internal state 257, as shown in FIGS. 2A and 4. Device/global internal state 257 includes one or more of: active application state, indicating which applications, if any, are currently active; display state, indicating what applications, views or other information occupy various regions of touch screen display 212; sensor state, including information obtained from the device's various sensors and input control devices 216; and location information concerning the device's location and/or attitude.

Operating system 226 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 228 facilitates communication with other devices over one or more external ports 224 and also includes various software components for handling data received by RF circuitry 208 and/or external port 224. External port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 230 optionally detects contact with touch screen 212 (in conjunction with display controller 256) and other touch-sensitive devices (e.g., a touchpad or physical click wheel). Contact/motion module 230 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 230 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 230 and display controller 256 detect contact on a touchpad.

In some embodiments, contact/motion module 230 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 200). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 230 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 232 includes various known software components for rendering and displaying graphics on touch screen 212 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 232 stores data representing graphics to be used. Each graphic is, optionally, assigned a corresponding code. Graphics module 232 receives, from applications etc., one or more codes specifying graphics to be displayed along with, if necessary, coordinate data and other graphic property data, and then generates screen image data to output to display controller 256.

Haptic feedback module 233 includes various software components for generating instructions used by tactile output generator(s) 267 to produce tactile outputs at one or more locations on device 200 in response to user interactions with device 200.

Text input module 234, which optionally can be a component of graphics module 232, provides soft keyboards for entering text in various applications (e.g., contacts 237, e mail 240, IM 241, browser 247, and any other application that needs text input).

GPS module 235 determines the location of the device and provides this information for use in various applications (e.g., to telephone 238 for use in location-based dialing; to camera 243 as picture/video metadata; and to applications that provide location-based services such as weather widgets, local yellow page widgets, and map/navigation widgets).

Digital assistant client module 229 can include various client-side digital assistant instructions to provide the client-side functionalities of the digital assistant. For example, digital assistant client module 229 can be capable of accepting voice input (e.g., speech input), text input, touch input, and/or gestural input through various user interfaces (e.g., microphone 213, accelerometer(s) 268, touch-sensitive display system 212, optical sensor(s) 229, other input control devices 216, etc.) of portable multifunction device 200. Digital assistant client module 229 can also be capable of providing output in audio (e.g., speech output), visual, and/or tactile forms through various output interfaces (e.g., speaker 211, touch-sensitive display system 212, tactile output generator(s) 267, etc.) of portable multifunction device 200. For example, output can be provided as voice, sound, alerts, text messages, menus, graphics, videos, animations, vibrations, and/or combinations of two or more of the above. During operation, digital assistant client module 229 can communicate with DA server 106 using RF circuitry 208.

User data and models 231 can include various data associated with the user (e.g., user-specific vocabulary data, user preference data, user-specified name pronunciations, data from the user's electronic address book, to-do lists, shopping lists, etc.) to provide the client-side functionalities of the digital assistant. Further, user data and models 231 can includes various models (e.g., speech recognition models, statistical language models, natural language processing models, ontology, task flow models, service models, etc.) for processing user input and determining user intent.

In some examples, digital assistant client module 229 can utilize the various sensors, subsystems, and peripheral devices of portable multifunction device 200 to gather additional information from the surrounding environment of the portable multifunction device 200 to establish a context associated with a user, the current user interaction, and/or the current user input. In some examples, digital assistant client module 229 can provide the contextual information or a subset thereof with the user input to DA server 106 to help infer the user's intent. In some examples, the digital assistant can also use the contextual information to determine how to prepare and deliver outputs to the user. Contextual information can be referred to as context data.

In some examples, the contextual information that accompanies the user input can include sensor information, e.g., lighting, ambient noise, ambient temperature, images or videos of the surrounding environment, etc. In some examples, the contextual information can also include the physical state of the device, e.g., device orientation, device location, device temperature, power level, speed, acceleration, motion patterns, cellular signals strength, etc. In some examples, information related to the software state of DA server 106, e.g., running processes, installed programs, past and present network activities, background services, error logs, resources usage, etc., and of portable multifunction device 200 can be provided to DA server 106 as contextual information associated with a user input.

In some examples, the digital assistant client module 229 can selectively provide information (e.g., user data 231) stored on the portable multifunction device 200 in response to requests from DA server 106. In some examples, digital assistant client module 229 can also elicit additional input from the user via a natural language dialogue or other user interfaces upon request by DA server 106. Digital assistant client module 229 can pass the additional input to DA server 106 to help DA server 106 in intent deduction and/or fulfillment of the user's intent expressed in the user request.

A more detailed description of a digital assistant is described below with reference to FIGS. 7A-C. It should be recognized that digital assistant client module 229 can include any number of the sub-modules of digital assistant module 726 described below.

Applications 236 optionally can include the following modules (or sets of instructions), or a subset or superset thereof:
Contacts module 237 (sometimes called an address book or contact list);
Telephone module 238;
Video conference module 239;
E-mail client module 240;
Instant messaging (IM) module 241;
Workout support module 242;
Camera module 243 for still and/or video images;
Image management module 244;
Video player module;
Music player module;
Browser module 247;
Calendar module 248;
Widget modules 249, which optionally can include one or more of: weather widget 249-1, stocks widget 249-2, calculator widget 249-3, alarm clock widget 249-4, dictionary widget 249-5, and other widgets obtained by the user, as well as user-created widgets 249-6;
Widget creator module 250 for making user-created widgets 249-6;
Search module 251;
Video and music player module 252, which merges video player module and music player module;
Notes module 253;
Map module 254; and/or
Online video module 255.

Examples of other applications 236 that optionally can be stored in memory 202 include other word processing applications, other image editing applications, drawing applications, presentation applications, JAVA-enabled applications, encryption, digital rights management, voice recognition, and voice replication.

In conjunction with touch screen 212, display controller 256, contact/motion module 230, graphics module 232, and text input module 234, contacts module 237 optionally can be used to manage an address book or contact list (e.g., stored in application internal state 292 of contacts module 237 in memory 202 or memory 470), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 238, video conference module 239, e-mail 240, or IM 241; and so forth.

In conjunction with RF circuitry 208, audio circuitry 210, speaker 211, microphone 213, touch screen 212, display controller 256, contact/motion module 230, graphics module 232, and text input module 234, telephone module 238 optionally can be used to enter a sequence of characters corresponding to a telephone number, access one or more telephone numbers in contacts module 237, modify a telephone number that has been entered, dial a respective telephone number, conduct a conversation, and disconnect or hang up when the conversation is completed. As noted above, the wireless communication optionally can use any of a plurality of communications standards, protocols, and technologies.

In conjunction with RF circuitry 208, audio circuitry 210, speaker 211, microphone 213, touch screen 212, display controller 256, optical sensor 264, optical sensor controller 258, contact/motion module 230, graphics module 232, text input module 234, contacts module 237, and telephone module 238, video conference module 239 includes executable instructions to initiate, conduct, and terminate a video conference between a user and one or more other participants in accordance with user instructions.

In conjunction with RF circuitry 208, touch screen 212, display controller 256, contact/motion module 230, graphics module 232, and text input module 234, e-mail client module 240 includes executable instructions to create, send, receive, and manage e-mail in response to user instructions. In conjunction with image management module 244, e-mail client module 240 makes it very easy to create and send e-mails with still or video images taken with camera module 243.

In conjunction with RF circuitry 208, touch screen 212, display controller 256, contact/motion module 230, graphics module 232, and text input module 234, the instant messaging module 241 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally can include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 208, touch screen 212, display controller 256, contact/motion module 230, graphics module 232, text input module 234, GPS module 235, map module 254, and music player module, workout support module 242 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 212, display controller 256, optical sensor(s) 264, optical sensor controller 258, contact/motion module 230, graphics module 232, and image management module 244, camera module 243 includes executable instructions to capture still images or video (including a video stream) and store them into memory 202, modify characteristics of a still image or video, or delete a still image or video from memory 202.

In conjunction with touch screen 212, display controller 256, contact/motion module 230, graphics module 232, text input module 234, and camera module 243, image management module 244 includes executable instructions to arrange, modify (e.g., edit), or otherwise manipulate, label, delete, present (e.g., in a digital slide show or album), and store still and/or video images.

In conjunction with RF circuitry 208, touch screen 212, display controller 256, contact/motion module 230, graphics module 232, and text input module 234, browser module 247 includes executable instructions to browse the Internet in accordance with user instructions, including searching, linking to, receiving, and displaying web pages or portions thereof, as well as attachments and other files linked to web pages.

In conjunction with RF circuitry 208, touch screen 212, display controller 256, contact/motion module 230, graphics module 232, text input module 234, e-mail client module 240, and browser module 247, calendar module 248 includes executable instructions to create, display, modify, and store calendars and data associated with calendars (e.g., calendar entries, to-do lists, etc.) in accordance with user instructions.

In conjunction with RF circuitry 208, touch screen 212, display controller 256, contact/motion module 230, graphics module 232, text input module 234, and browser module 247, widget modules 249 are mini-applications that optionally can be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 208, touch screen 212, display controller 256, contact/motion module 230, graphics module 232, text input module 234, and browser module 247, the widget creator module 250 optionally can be used by a user to create widgets (e.g., turning a user-specified portion of a web page into a widget).

In conjunction with touch screen 212, display controller 256, contact/motion module 230, graphics module 232, and text input module 234, search module 251 includes executable instructions to search for text, music, sound, image, video, and/or other files in memory 202 that match one or more search criteria (e.g., one or more user-specified search terms) in accordance with user instructions.

In conjunction with touch screen 212, display controller 256, contact/motion module 230, graphics module 232, audio circuitry 210, speaker 211, RF circuitry 208, and browser module 247, video and music player module 252 includes executable instructions that allow the user to download and play back recorded music and other sound files stored in one or more file formats, such as MP3 or AAC files, and executable instructions to display, present, or otherwise play back videos (e.g., on touch screen 212 or on an external, connected display via external port 224). In some embodiments, device 200 optionally includes the functionality of an MP3 player, such as an iPod (trademark of Apple Inc.).

In conjunction with touch screen 212, display controller 256, contact/motion module 230, graphics module 232, and text input module 234, notes module 253 includes executable instructions to create and manage notes, to-do lists, and the like in accordance with user instructions.

In conjunction with RF circuitry 208, touch screen 212, display controller 256, contact/motion module 230, graphics module 232, text input module 234, GPS module 235, and browser module 247, map module 254 optionally can be used to receive, display, modify, and store maps and data associated with maps (e.g., driving directions, data on stores and other points of interest at or near a particular location, and other location-based data) in accordance with user instructions.

In conjunction with touch screen 212, display controller 256, contact/motion module 230, graphics module 232, audio circuitry 210, speaker 211, RF circuitry 208, text input module 234, e-mail client module 240, and browser module 247, online video module 255 includes instructions that allow the user to access, browse, receive (e.g., by streaming and/or download), play back (e.g., on the touch screen or on an external, connected display via external port 224), send an e-mail with a link to a particular online video, and otherwise manage online videos in one or more file formats, such as H.264. In some embodiments, instant messaging module 241, rather than e-mail client module 240, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules optionally can be combined or otherwise rearranged in various embodiments. For example, video player module optionally can be combined with music player module into a single module (e.g., video and music player module 252, FIG. 2A). In some embodiments, memory 202 optionally can store a subset of the modules and data structures identified above. Furthermore, memory 202 optionally can store additional modules and data structures not described above.

In some embodiments, device 200 is a device where operation of a predefined set of functions on the device is performed exclusively through a touch screen and/or a touchpad. By using a touch screen and/or a touchpad as the primary input control device for operation of device 200, the number of physical input control devices (such as push buttons, dials, and the like) on device 200 optionally can be reduced.

The predefined set of functions that are performed exclusively through a touch screen and/or a touchpad optionally include navigation between user interfaces. In some embodiments, the touchpad, when touched by the user, navigates device 200 to a main, home, or root menu from any user interface that is displayed on device 200. In such embodiments, a “menu button” is implemented using a touchpad. In some other embodiments, the menu button is a physical push button or other physical input control device instead of a touchpad.

FIG. 2B is a block diagram illustrating exemplary components for event handling in accordance with some embodiments. In some embodiments, memory 202 (FIG. 2A) or 470 (FIG. 4) includes event sorter 270 (e.g., in operating system 226) and a respective application 236-1 (e.g., any of the aforementioned applications 237-251, 255, 480-490).

Event sorter 270 receives event information and determines the application 236-1 and application view 291 of application 236-1 to which to deliver the event information. Event sorter 270 includes event monitor 271 and event dispatcher module 274. In some embodiments, application 236-1 includes application internal state 292, which indicates the current application view(s) displayed on touch-sensitive display 212 when the application is active or executing. In some embodiments, device/global internal state 257 is used by event sorter 270 to determine which application(s) is (are) currently active, and application internal state 292 is used by event sorter 270 to determine application views 291 to which to deliver event information.

In some embodiments, application internal state 292 includes additional information, such as one or more of: resume information to be used when application 236-1 resumes execution, user interface state information that indicates information being displayed or that is ready for display by application 236-1, a state queue for enabling the user to go back to a prior state or view of application 236-1, and a redo/undo queue of previous actions taken by the user.

Event monitor 271 receives event information from peripherals interface 218. Event information includes information about a sub-event (e.g., a user touch on touch-sensitive display 212, as part of a multi-touch gesture). Peripherals interface 218 transmits information it receives from I/O subsystem 206 or a sensor, such as proximity sensor 266, accelerometer(s) 268, and/or microphone 213 (through audio circuitry 210). Information that peripherals interface 218 receives from I/O subsystem 206 includes information from touch-sensitive display 212 or a touch-sensitive surface.

In some embodiments, event monitor 271 sends requests to the peripherals interface 218 at predetermined intervals. In response, peripherals interface 218 transmits event information. In other embodiments, peripherals interface 218 transmits event information only when there is a significant event (e.g., receiving an input above a predetermined noise threshold and/or for more than a predetermined duration).

In some embodiments, event sorter 270 also includes a hit view determination module 272 and/or an active event recognizer determination module 273.

Hit view determination module 272 provides software procedures for determining where a sub-event has taken place within one or more views when touch-sensitive display 212 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally can correspond to programmatic levels within a programmatic or view hierarchy of the application. For example, the lowest level view in which a touch is detected optionally can be called the hit view, and the set of events that are recognized as proper inputs optionally can be determined based, at least in part, on the hit view of the initial touch that begins a touch-based gesture.

Hit view determination module 272 receives information related to sub events of a touch-based gesture. When an application has multiple views organized in a hierarchy, hit view determination module 272 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 272, the hit view typically receives all sub-events related to the same touch or input source for which it was identified as the hit view.

Active event recognizer determination module 273 determines which view or views within a view hierarchy should receive a particular sequence of sub-events. In some embodiments, active event recognizer determination module 273 determines that only the hit view should receive a particular sequence of sub-events. In other embodiments, active event recognizer determination module 273 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 274 dispatches the event information to an event recognizer (e.g., event recognizer 280). In embodiments including active event recognizer determination module 273, event dispatcher module 274 delivers the event information to an event recognizer determined by active event recognizer determination module 273. In some embodiments, event dispatcher module 274 stores in an event queue the event information, which is retrieved by a respective event receiver 282.

In some embodiments, operating system 226 includes event sorter 270. Alternatively, application 236-1 includes event sorter 270. In yet other embodiments, event sorter 270 is a stand-alone module, or a part of another module stored in memory 202, such as contact/motion module 230.

In some embodiments, application 236-1 includes a plurality of event handlers 290 and one or more application views 291, each of which includes instructions for handling touch events that occur within a respective view of the application's user interface. Each application view 291 of the application 236-1 includes one or more event recognizers 280. Typically, a respective application view 291 includes a plurality of event recognizers 280. In other embodiments, one or more of event recognizers 280 are part of a separate module, such as a user interface kit (not shown) or a higher level object from which application 236-1 inherits methods and other properties. In some embodiments, a respective event handler 290 includes one or more of: data updater 276, object updater 277, GUI updater 278, and/or event data 279 received from event sorter 270. Event handler 290 optionally can utilize or call data updater 276, object updater 277, or GUI updater 278 to update the application internal state 292. Alternatively, one or more of the application views 291 include one or more respective event handlers 290. Also, in some embodiments, one or more of data updater 276, object updater 277, and GUI updater 278 are included in a respective application view 291.

A respective event recognizer 280 receives event information (e.g., event data 279) from event sorter 270 and identifies an event from the event information. Event recognizer 280 includes event receiver 282 and event comparator 284. In some embodiments, event recognizer 280 also includes at least a subset of: metadata 283, and event delivery instructions 288 (which optionally can include sub-event delivery instructions).

Event receiver 282 receives event information from event sorter 270. The event information includes information about a sub-event, for example, a touch or a touch movement. Depending on the sub-event, the event information also includes additional information, such as location of the sub-event. When the sub-event concerns motion of a touch, the event information optionally can also include speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 284 compares the event information to predefined event or sub-event definitions and, based on the comparison, determines an event or sub event, or determines or updates the state of an event or sub-event. In some embodiments, event comparator 284 includes event definitions 286. Event definitions 286 contain definitions of events (e.g., predefined sequences of sub-events), for example, event 1 (287-1), event 2 (287-2), and others. In some embodiments, sub-events in an event (287) include, for example, touch begin, touch end, touch movement, touch cancellation, and multiple touching. In one example, the definition for event 1 (287-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (287-2) is a dragging on a displayed object. The dragging, for example, comprises a touch (or contact) on the displayed object for a predetermined phase, a movement of the touch across touch-sensitive display 212, and liftoff of the touch (touch end). In some embodiments, the event also includes information for one or more associated event handlers 290.

In some embodiments, event definition 287 includes a definition of an event for a respective user-interface object. In some embodiments, event comparator 284 performs a hit test to determine which user-interface object is associated with a sub-event. For example, in an application view in which three user-interface objects are displayed on touch-sensitive display 212, when a touch is detected on touch-sensitive display 212, event comparator 284 performs a hit test to determine which of the three user-interface objects is associated with the touch (sub-event). If each displayed object is associated with a respective event handler 290, the event comparator uses the result of the hit test to determine which event handler 290 should be activated. For example, event comparator 284 selects an event handler associated with the sub-event and the object triggering the hit test.

In some embodiments, the definition for a respective event (287) also includes delayed actions that delay delivery of the event information until after it has been determined whether the sequence of sub-events does or does not correspond to the event recognizer's event type.

When a respective event recognizer 280 determines that the series of sub-events do not match any of the events in event definitions 286, the respective event recognizer 280 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 280 includes metadata 283 with configurable properties, flags, and/or lists that indicate how the event delivery system should perform sub-event delivery to actively involved event recognizers. In some embodiments, metadata 283 includes configurable properties, flags, and/or lists that indicate how event recognizers optionally can interact, or are enabled to interact, with one another. In some embodiments, metadata 283 includes configurable properties, flags, and/or lists that indicate whether sub-events are delivered to varying levels in the view or programmatic hierarchy.

In some embodiments, a respective event recognizer 280 activates event handler 290 associated with an event when one or more particular sub-events of an event are recognized. In some embodiments, a respective event recognizer 280 delivers event information associated with the event to event handler 290. Activating an event handler 290 is distinct from sending (and deferred sending) sub-events to a respective hit view. In some embodiments, event recognizer 280 throws a flag associated with the recognized event, and event handler 290 associated with the flag catches the flag and performs a predefined process.

In some embodiments, event delivery instructions 288 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 276 creates and updates data used in application 236-1. For example, data updater 276 updates the telephone number used in contacts module 237, or stores a video file used in video player module. In some embodiments, object updater 277 creates and updates objects used in application 236-1. For example, object updater 277 creates a new user-interface object or updates the position of a user-interface object. GUI updater 278 updates the GUI. For example, GUI updater 278 prepares display information and sends it to graphics module 232 for display on a touch-sensitive display.

In some embodiments, event handler(s) 290 includes or has access to data updater 276, object updater 277, and GUI updater 278. In some embodiments, data updater 276, object updater 277, and GUI updater 278 are included in a single module of a respective application 236-1 or application view 291. In other embodiments, they are included in two or more software modules.

It shall be understood that the foregoing discussion regarding event handling of user touches on touch-sensitive displays also applies to other forms of user inputs to operate multifunction devices 200 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 3 illustrates a portable multifunction device 200 having a touch screen 212 in accordance with some embodiments. The touch screen optionally displays one or more graphics within user interface (UI) 300. In this embodiment, as well as others described below, a user is enabled to select one or more of the graphics by making a gesture on the graphics, for example, with one or more fingers 302 (not drawn to scale in the figure) or one or more styluses 303 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 200. In some implementations or circumstances, inadvertent contact with a graphic does not select the graphic. For example, a swipe gesture that sweeps over an application icon optionally does not select the corresponding application when the gesture corresponding to selection is a tap.

Device 200 optionally also can include one or more physical buttons, such as “home” or menu button 304. As described previously, menu button 304 optionally can be used to navigate to any application 236 in a set of applications that optionally can be executed on device 200. Alternatively, in some embodiments, the menu button is implemented as a soft key in a GUI displayed on touch screen 212.

In one embodiment, device 200 includes touch screen 212, menu button 304, push button 306 for powering the device on/off and locking the device, volume adjustment button(s) 308, subscriber identity module (SIM) card slot 310, headset jack 312, and docking/charging external port 224. Push button 306 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 200 also accepts verbal input for activation or deactivation of some functions through microphone 213. Device 200 also, optionally, includes one or more contact intensity sensors 265 for detecting intensity of contacts on touch screen 212 and/or one or more tactile output generators 267 for generating tactile outputs for a user of device 200.

FIG. 4 is a block diagram of an exemplary multifunction device with a display and a touch-sensitive surface in accordance with some embodiments. Device 400 need not be portable. In some embodiments, device 400 is a laptop computer, a desktop computer, a tablet computer, a multimedia player device, a navigation device, an educational device (such as a child's learning toy), a gaming system, or a control device (e.g., a home or industrial controller). Device 400 typically includes one or more processing units (CPUs) 410, one or more network or other communications interfaces 460, memory 470, and one or more communication buses 420 for interconnecting these components. Communication buses 420 optionally include circuitry (sometimes called a chipset) that interconnects and controls communications between system components. Device 400 includes input/output (I/O) interface 430 comprising display 440, which is typically a touch screen display. I/O interface 430 also optionally includes a keyboard and/or mouse (or other pointing device) 450 and touchpad 455, tactile output generator 457 for generating tactile outputs on device 400 (e.g., similar to tactile output generator(s) 267 described above with reference to FIG. 2A), sensors 459 (e.g., optical, acceleration, proximity, touch-sensitive, and/or contact intensity sensors similar to contact intensity sensor(s) 265 described above with reference to FIG. 2A). Memory 470 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 470 optionally includes one or more storage devices remotely located from CPU(s) 410. In some embodiments, memory 470 stores programs, modules, and data structures analogous to the programs, modules, and data structures stored in memory 202 of portable multifunction device 200 (FIG. 2A), or a subset thereof. Furthermore, memory 470 optionally stores additional programs, modules, and data structures not present in memory 202 of portable multifunction device 200. For example, memory 470 of device 400 optionally stores drawing module 480, presentation module 482, word processing module 484, website creation module 486, disk authoring module 488, and/or spreadsheet module 490, while memory 202 of portable multifunction device 200 (FIG. 2A) optionally does not store these modules.

Each of the above-identified elements in FIG. 4 optionally can be stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules optionally can be combined or otherwise rearranged in various embodiments. In some embodiments, memory 470 optionally can store a subset of the modules and data structures identified above. Furthermore, memory 470 optionally can store additional modules and data structures not described above.

Attention is now directed towards embodiments of user interfaces that optionally can be implemented on, for example, portable multifunction device 200.

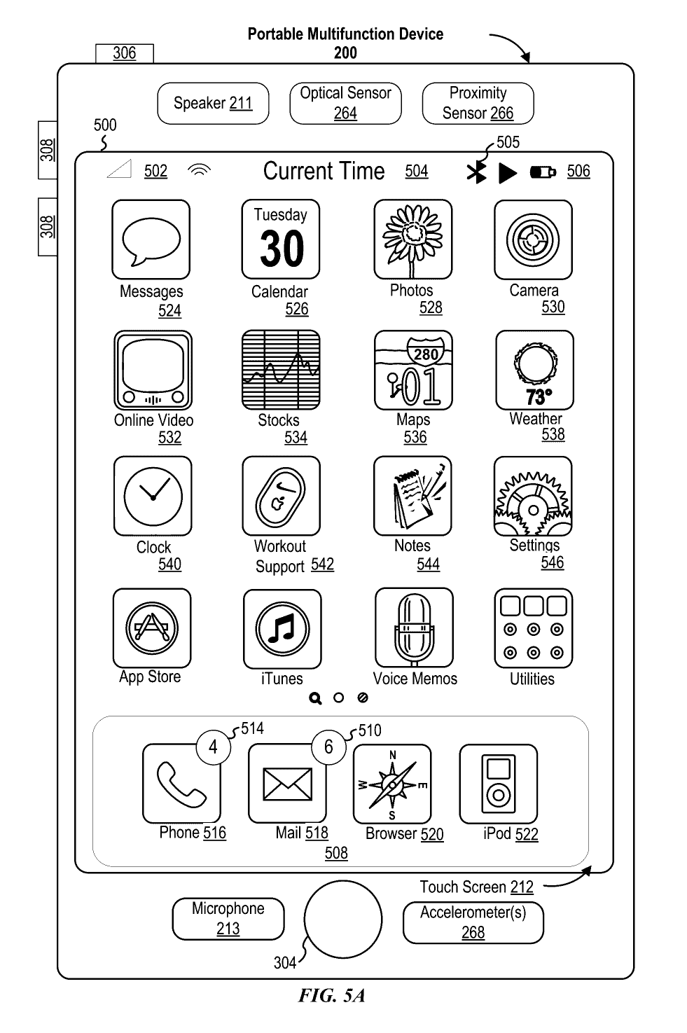

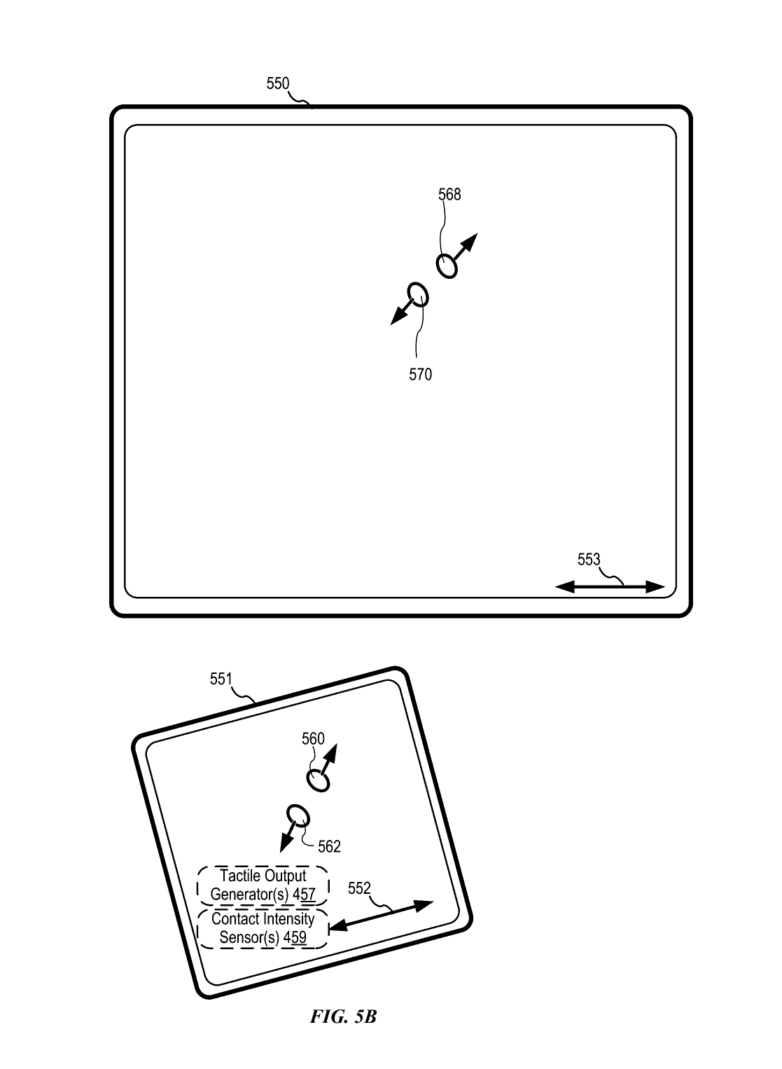

FIG. 5A illustrates an exemplary user interface for a menu of applications on portable multifunction device 200 in accordance with some embodiments. Similar user interfaces optionally can be implemented on device 400. In some embodiments, user interface 500 includes the following elements, or a subset or superset thereof:

Signal strength indicator(s) 502 for wireless communication(s), such as cellular and Wi-Fi signals;
Time 504;
Bluetooth indicator 505;
Battery status indicator 506;
Tray 508 with icons for frequently used applications, such as:
   Icon 516 for telephone module 238, labeled “Phone,” which optionally includes an indicator 514 of the number of missed calls or voicemail messages;
   Icon 518 for e-mail client module 240, labeled “Mail,” which optionally includes an indicator 510 of the number of unread e-mails;
   Icon 520 for browser module 247, labeled “Browser;” and
   Icon 522 for video and music player module 252, also referred to as iPod (trademark of Apple Inc.) module 252, labeled “iPod;” and
Icons for other applications, such as:
   Icon 524 for IM module 241, labeled “Messages;”
   Icon 526 for calendar module 248, labeled “Calendar;”
   Icon 528 for image management module 244, labeled “Photos;”
   Icon 530 for camera module 243, labeled “Camera;”
   Icon 532 for online video module 255, labeled “Online Video;”
   Icon 534 for stocks widget 249-2, labeled “Stocks;”
   Icon 536 for map module 254, labeled “Maps;”
   Icon 538 for weather widget 249-1, labeled “Weather;”
   Icon 540 for alarm clock widget 249-4, labeled “Clock;”
   Icon 542 for workout support module 242, labeled “Workout Support;”
   Icon 544 for notes module 253, labeled “Notes;” and
   Icon 546 for a settings application or module, labeled “Settings,” which provides access to settings for device 200 and its various applications 236.

It should be noted that the icon labels illustrated in FIG. 5A are merely exemplary. For example, icon 522 for video and music player module 252 optionally can be labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5B illustrates an exemplary user interface on a device (e.g., device 400, FIG. 4) with a touch-sensitive surface 551 (e.g., a tablet or touchpad 455, FIG. 4) that is separate from the display 550 (e.g., touch screen display 212). Device 400 also, optionally, includes one or more contact intensity sensors (e.g., one or more of sensors 457) for detecting intensity of contacts on touch-sensitive surface 551 and/or one or more tactile output generators 459 for generating tactile outputs for a user of device 400.

Although some of the examples which follow will be given with reference to inputs on touch screen display 212 (where the touch-sensitive surface and the display are combined), in some embodiments, the device detects inputs on a touch-sensitive surface that is separate from the display, as shown in FIG. 5B. In some embodiments, the touch-sensitive surface (e.g., 551 in FIG. 5B) has a primary axis (e.g., 552 in FIG. 5B) that corresponds to a primary axis (e.g., 553 in FIG. 5B) on the display (e.g., 550). In accordance with these embodiments, the device detects contacts (e.g., 560 and 562 in FIG. 5B) with the touch-sensitive surface 551 at locations that correspond to respective locations on the display (e.g., in FIG. 5B, 560 corresponds to 568 and 562 corresponds to 570). In this way, user inputs (e.g., contacts 560 and 562, and movements thereof) detected by the device on the touch-sensitive surface (e.g., 551 in FIG. 5B) are used by the device to manipulate the user interface on the display (e.g., 550 in FIG. 5B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 6A illustrates exemplary personal electronic device 600. Device 600 includes body 602. In some embodiments, device 600 can include some or all of the features described with respect to devices 200 and 400 (e.g., FIGS. 2A-4B). In some embodiments, device 600 has touch-sensitive display screen 604, hereafter touch screen 604. Alternatively, or in addition to touch screen 604, device 600 has a display and a touch-sensitive surface. As with devices 200 and 400, in some embodiments, touch screen 604 (or the touch-sensitive surface) optionally can have one or more intensity sensors for detecting intensity of contacts (e.g., touches) being applied. The one or more intensity sensors of touch screen 604 (or the touch-sensitive surface) can provide output data that represents the intensity of touches. The user interface of device 600 can respond to touches based on their intensity, meaning that touches of different intensities can invoke different user interface operations on device 600.

Techniques for detecting and processing touch intensity can be found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 600 has one or more input mechanisms 606 and 608. Input mechanisms 606 and 608, if included, can be physical. Examples of physical input mechanisms include push buttons and rotatable mechanisms. In some embodiments, device 600 has one or more attachment mechanisms. Such attachment mechanisms, if included, can permit attachment of device 600 with, for example, hats, eyewear, earrings, necklaces, shirts, jackets, bracelets, watch straps, chains, trousers, belts, shoes, purses, backpacks, and so forth. These attachment mechanisms optionally can permit device 600 to be worn by a user.

FIG. 6B depicts exemplary personal electronic device 600. In some embodiments, device 600 can include some or all of the components described with respect to FIGS. 2A, 2B, and 4. Device 600 has bus 612 that operatively couples I/O section 614 with one or more computer processors 616 and memory 618. I/O section 614 can be connected to display 604, which can have touch-sensitive component 622 and, optionally, touch-intensity sensitive component 624. In addition, I/O section 614 can be connected with communication unit 630 for receiving application and operating system data, using Wi-Fi, Bluetooth, near field communication (NFC), cellular, and/or other wireless communication techniques. Device 600 can include input mechanisms 606 and/or 608. Input mechanism 606 optionally can be a rotatable input device or a depressible and rotatable input device, for example. Input mechanism 608 optionally can be a button, in some examples.

Input mechanism 608 optionally can be a microphone, in some examples. Personal electronic device 600 can include various sensors, such as GPS sensor 632, accelerometer 634, directional sensor 640 (e.g., compass), gyroscope 636, motion sensor 638, and/or a combination thereof, all of which can be operatively connected to I/O section 614.

Memory 618 of personal electronic device 600 can be a non-transitory computer-readable storage medium, for storing computer-executable instructions, which, when executed by one or more computer processors 616, for example, can cause the computer processors to perform the techniques described below, including process 900 (FIGS. 8A-D). The computer-executable instructions can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. For purposes of this document, a “non-transitory computer-readable storage medium” can be any medium that can tangibly contain or store computer-executable instructions for use by or in connection with the instruction execution system, apparatus, or device. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 600 is not limited to the components and configuration of FIG. 6B, but can include other or additional components in multiple configurations.

As used here, the term “affordance” refers to a user-interactive graphical user interface object that optionally can be displayed on the display screen of devices 200, 400, and/or 600 (FIGS. 2, 4, and 6). For example, an image (e.g., icon), a button, and text (e.g., hyperlink) optionally can each constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 455 in FIG. 4 or touch-sensitive surface 551 in FIG. 5B) while the cursor is over a particular user interface element (e.g., a button, window, slider or other user interface element), the particular user interface element is adjusted in accordance with the detected input. In some implementations that include a touch screen display (e.g., touch-sensitive display system 212 in FIG. 2A or touch screen 212 in FIG. 5A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally can include a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface optionally can receive a continuous swipe contact transitioning from a start location and reaching an end location, at which point the intensity of the contact increases. In this example, the characteristic intensity of the contact at the end location optionally can be based on only a portion of the continuous swipe contact, and not the entire swipe contact (e.g., only the portion of the swipe contact at the end location). In some embodiments, a smoothing algorithm optionally can be applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface optionally can be characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

### 3. Digital Assistant System

FIG. 7A illustrates a block diagram of digital assistant system 700 in accordance with various examples. In some examples, digital assistant system 700 can be implemented on a standalone computer system. In some examples, digital assistant system 700 can be distributed across multiple computers. In some examples, some of the modules and functions of the digital assistant can be divided into a server portion and a client portion, where the client portion resides on one or more user devices (e.g., devices 104, 122, 200, 400, or 600) and communicates with the server portion (e.g., server system 108) through one or more networks, e.g., as shown in FIG. 1. In some examples, digital assistant system 700 can be an implementation of server system 108 (and/or DA server 106) shown in FIG. 1. It should be noted that digital assistant system 700 is only one example of a digital assistant system, and that digital assistant system 700 can have more or fewer components than shown, optionally can combine two or more components, or optionally can have a different configuration or arrangement of the components. The various components shown in FIG. 7A can be implemented in hardware, software instructions for execution by one or more processors, firmware, including one or more signal processing and/or application specific integrated circuits, or a combination thereof.

Digital assistant system 700 can include memory 702, one or more processors 704, input/output (I/O) interface 706, and network communications interface 708. These components can communicate with one another over one or more communication buses or signal lines 710.

In some examples, memory 702 can include a non-transitory computer-readable medium, such as high-speed random access memory and/or a non-volatile computer-readable storage medium (e.g., one or more magnetic disk storage devices, flash memory devices, or other non-volatile solid-state memory devices).

In some examples, I/O interface 706 can couple input/output devices 716 of digital assistant system 700, such as displays, keyboards, touch screens, and microphones, to user interface module 722. I/O interface 706, in conjunction with user interface module 722, can receive user inputs (e.g., voice input, keyboard inputs, touch inputs, etc.) and processes them accordingly. In some examples, e.g., when the digital assistant is implemented on a standalone user device, digital assistant system 700 can include any of the components and I/O communication interfaces described with respect to devices 200, 400, or 600 in FIGS. 2A, 4, 6A-B, respectively. In some examples, digital assistant system 700 can represent the server portion of a digital assistant implementation, and can interact with the user through a client-side portion residing on a user device (e.g., devices 104, 200, 400, or 600).

In some examples, the network communications interface 708 can include wired communication port(s) 712 and/or wireless transmission and reception circuitry 714. The wired communication port(s) can receive and send communication signals via one or more wired interfaces, e.g., Ethernet, Universal Serial Bus (USB), FIREWIRE, etc. The wireless circuitry 714 can receive and send RF signals and/or optical signals from/to communications networks and other communications devices. The wireless communications can use any of a plurality of communications standards, protocols, and technologies, such as GSM, EDGE, CDMA, TDMA, Bluetooth, Wi-Fi, VoIP, Wi-MAX, or any other suitable communication protocol. Network communications interface 708 can enable communication between digital assistant system 700 with networks, such as the Internet, an intranet, and/or a wireless network, such as a cellular telephone network, a wireless local area network (LAN), and/or a metropolitan area network (MAN), and other devices.

In some examples, memory 702, or the computer-readable storage media of memory 702, can store programs, modules, instructions, and data structures including all or a subset of: operating system 718, communications module 720, user interface module 722, one or more applications 724, and digital assistant module 726. In particular, memory 702, or the computer-readable storage media of memory 702, can store instructions for performing process 900, described below. One or more processors 704 can execute these programs, modules, and instructions, and reads/writes from/to the data structures.

Operating system 718 (e.g., Darwin, RTXC, LINUX, UNIX, iOS, OS X, WINDOWS, or an embedded operating system such as VxWorks) can include various software components and/or drivers for controlling and managing general system tasks (e.g., memory management, storage device control, power management, etc.) and facilitates communications between various hardware, firmware, and software components.

Communications module 720 can facilitate communications between digital assistant system 700 with other devices over network communications interface 708. For example, communications module 720 can communicate with RF circuitry 208 of electronic devices such as devices 200, 400, and 600 shown in FIG. 2A, 4, 6A-B, respectively. Communications module 720 can also include various components for handling data received by wireless circuitry 714 and/or wired communications port 712.

User interface module 722 can receive commands and/or inputs from a user via I/O interface 706 (e.g., from a keyboard, touch screen, pointing device, controller, and/or microphone), and generate user interface objects on a display. User interface module 722 can also prepare and deliver outputs (e.g., speech, sound, animation, text, icons, vibrations, haptic feedback, light, etc.) to the user via the I/O interface 706 (e.g., through displays, audio channels, speakers, touch-pads, etc.).

Applications 724 can include programs and/or modules that are configured to be executed by one or more processors 704. For example, if the digital assistant system is implemented on a standalone user device, applications 724 can include user applications, such as games, a calendar application, a navigation application, or an email application. If digital assistant system 700 is implemented on a server, applications 724 can include resource management applications, diagnostic applications, or scheduling applications, for example.

Memory 702 can also store digital assistant module 726 (or the server portion of a digital assistant). In some examples, digital assistant module 726 can include the following sub-modules, or a subset or superset thereof: input/output processing module 728, speech-to-text (STT) processing module 730, natural language processing module 732, dialogue flow processing module 734, task flow processing module 736, service processing module 738, and speech synthesis module 740. Each of these modules can have access to one or more of the following systems or data and models of the digital assistant module 726, or a subset or superset thereof: ontology 760, vocabulary index 744, user data 748, task flow models 754, service models 756, and ASR systems.

In some examples, using the processing modules, data, and models implemented in digital assistant module 726, the digital assistant can perform at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some examples, as shown in FIG. 7B, I/O processing module 728 can interact with the user through I/O devices 716 in FIG. 7A or with a user device (e.g., devices 104, 200, 400, or 600) through network communications interface 708 in FIG. 7A to obtain user input (e.g., a speech input) and to provide responses (e.g., as speech outputs) to the user input. I/O processing module 728 can optionally obtain contextual information associated with the user input from the user device, along with or shortly after the receipt of the user input. The contextual information can include user-specific data, vocabulary, and/or preferences relevant to the user input. In some examples, the contextual information also includes software and hardware states of the user device at the time the user request is received, and/or information related to the surrounding environment of the user at the time that the user request was received. In some examples, I/O processing module 728 can also send follow-up questions to, and receive answers from, the user regarding the user request. When a user request is received by I/O processing module 728 and the user request can include speech input, I/O processing module 728 can forward the speech input to STT processing module 730 (or speech recognizer) for speech-to-text conversions.

STT processing module 730 can include one or more ASR systems. The one or more ASR systems can process the speech input that is received through I/O processing module 728 to produce a recognition result. Each ASR system can include a front-end speech pre-processor. The front-end speech pre-processor can extract representative features from the speech input. For example, the front-end speech pre-processor can perform a Fourier transform on the speech input to extract spectral features that characterize the speech input as a sequence of representative multi-dimensional vectors. Further, each ASR system can include one or more speech recognition models (e.g., acoustic models and/or language models) and can implement one or more speech recognition engines. Examples of speech recognition models can include Hidden Markov Models, Gaussian-Mixture Models, Deep Neural Network Models, n-gram language models, and other statistical models. Examples of speech recognition engines can include the dynamic time warping based engines and weighted finite-state transducers (WFST) based engines. The one or more speech recognition models and the one or more speech recognition engines can be used to process the extracted representative features of the front-end speech pre-processor to produce intermediate recognitions results (e.g., phonemes, phonemic strings, and sub-words), and ultimately, text recognition results (e.g., words, word strings, or sequence of tokens). In some examples, the speech input can be processed at least partially by a third-party service or on the user's device (e.g., device 104, 200, 400, or 600) to produce the recognition result. Once STT processing module 730 produces recognition results containing a text string (e.g., words, or sequence of words, or sequence of tokens), the recognition result can be passed to natural language processing module 732 for intent deduction.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

In some examples, STT processing module 730 can include and/or access a vocabulary of recognizable words via phonetic alphabet conversion module 731. Each vocabulary word can be associated with one or more candidate pronunciations of the word represented in a speech recognition phonetic alphabet. In particular, the vocabulary of recognizable words can include a word that is associated with a plurality of candidate pronunciations. For example, the vocabulary optionally can include the word “tomato” that is associated with the candidate pronunciations of / [symbol] / [symbol] /. Further, vocabulary words can be associated with custom candidate pronunciations that are based on previous speech inputs from the user. Such custom candidate pronunciations can be stored in STT processing module 730 and can be associated with a particular user via the user's profile on the device. In some examples, the candidate pronunciations for words can be determined based on the spelling of the word and one or more linguistic and/or phonetic rules. In some examples, the candidate pronunciations can be manually generated, e.g., based on known canonical pronunciations.

In some examples, the candidate pronunciations can be ranked based on the commonness of the candidate pronunciation. For example, the candidate pronunciation / [symbol] / can be ranked higher than / [symbol] /, because the former is a more commonly used pronunciation (e.g., among all users, for users in a particular geographical region, or for any other appropriate subset of users). In some examples, candidate pronunciations can be ranked based on whether the candidate pronunciation is a custom candidate pronunciation associated with the user. For example, custom candidate pronunciations can be ranked higher than canonical candidate pronunciations. This can be useful for recognizing proper nouns having a unique pronunciation that deviates from canonical pronunciation. In some examples, candidate pronunciations can be associated with one or more speech characteristics, such as geographic origin, nationality, or ethnicity. For example, the candidate pronunciation / [symbol] / can be associated with the United States, whereas the candidate pronunciation / [symbol] / can be associated with Great Britain. Further, the rank of the candidate pronunciation can be based on one or more characteristics (e.g., geographic origin, nationality, ethnicity, etc.) of the user stored in the user's profile on the device. For example, it can be determined from the user's profile that the user is associated with the United States. Based on the user being associated with the United States, the candidate pronunciation / [symbol] / (associated with the United States) can be ranked higher than the candidate pronunciation / [symbol] / (associated with Great Britain). In some examples, one of the ranked candidate pronunciations can be selected as a predicted pronunciation (e.g., the most likely pronunciation).

When a speech input is received, STT processing module 730 can be used to determine the phonemes corresponding to the speech input (e.g., using an acoustic model), and then attempt to determine words that match the phonemes (e.g., using a language model). For example, if STT processing module 730 can first identify the sequence of phonemes / [symbol] / corresponding to a portion of the speech input, it can then determine, based on vocabulary index 744, that this sequence corresponds to the word “tomato.”

In some examples, STT processing module 730 can use approximate matching techniques to determine words in an utterance. Thus, for example, the STT processing module 730 can determine that the sequence of phonemes / [symbol] / corresponds to the word “tomato,” even if that particular sequence of phonemes is not one of the candidate sequence of phonemes for that word.

In some examples, natural language processing module 732 can be configured to receive metadata associated with the speech input. The metadata can indicate whether to perform natural language processing on the speech input (or the sequence of words or tokens corresponding to the speech input). If the metadata indicates that natural language processing is to be performed, then the natural language processing module can receive the sequence of words or tokens from the STT processing module to perform natural language processing. However, if the metadata indicates that natural language process is not to be performed, then the natural language processing module can be disabled and the sequence of words or tokens (e.g., text string) from the STT processing module can be outputted from the digital assistant. In some examples, the metadata can further identify one or more domains corresponding to the user request. Based on the one or more domains, the natural language processor can disable domains in ontology 760 other than the one or more domains. In this way, natural language processing is constrained to the one or more domains in ontology 760. In particular, the structure query (described below) can be generated using the one or more domains and not the other domains in the ontology.

Natural language processing module 732 (“natural language processor”) of the digital assistant can take the sequence of words or tokens (“token sequence”) generated by STT processing module 730, and attempt to associate the token sequence with one or more “actionable intents” recognized by the digital assistant. An “actionable intent” can represent a task that can be performed by the digital assistant, and can have an associated task flow implemented in task flow models 754. The associated task flow can be a series of programmed actions and steps that the digital assistant takes in order to perform the task. The scope of a digital assistant's capabilities can be dependent on the number and variety of task flows that have been implemented and stored in task flow models 754, or in other words, on the number and variety of “actionable intents” that the digital assistant recognizes. The effectiveness of the digital assistant, however, can also be dependent on the assistant's ability to infer the correct “actionable intent(s)” from the user request expressed in natural language.

In some examples, in addition to the sequence of words or tokens obtained from STT processing module 730, natural language processing module 732 can also receive contextual information associated with the user request, e.g., from I/O processing module 728. The natural language processing module 732 can optionally use the contextual information to clarify, supplement, and/or further define the information contained in the token sequence received from STT processing module 730. The contextual information can include, for example, user preferences, hardware, and/or software states of the user device, sensor information collected before, during, or shortly after the user request, prior interactions (e.g., dialogue) between the digital assistant and the user, and the like. As described herein, contextual information can be dynamic, and can change with time, location, content of the dialogue, and other factors.

In some examples, the natural language processing can be based on, e.g., ontology 760. Ontology 760 can be a hierarchical structure containing many nodes, each node representing either an “actionable intent” or a “property” relevant to one or more of the “actionable intents” or other “properties.” As noted above, an “actionable intent” can represent a task that the digital assistant is capable of performing, i.e., it is “actionable” or can be acted on. A “property” can represent a parameter associated with an actionable intent or a sub-aspect of another property. A linkage between an actionable intent node and a property node in ontology 760 can define how a parameter represented by the property node pertains to the task represented by the actionable intent node.

In some examples, ontology 760 can be made up of actionable intent nodes and property nodes. Within ontology 760, each actionable intent node can be linked to one or more property nodes either directly or through one or more intermediate property nodes. Similarly, each property node can be linked to one or more actionable intent nodes either directly or through one or more intermediate property nodes. For example, as shown in FIG. 7C, ontology 760 can include a “restaurant reservation” node (i.e., an actionable intent node). Property nodes “restaurant,” “date/time” (for the reservation), and “party size” can each be directly linked to the actionable intent node (i.e., the “restaurant reservation” node).

In addition, property nodes “cuisine,” “price range,” “phone number,” and “location” can be sub-nodes of the property node “restaurant,” and can each be linked to the “restaurant reservation” node (i.e., the actionable intent node) through the intermediate property node “restaurant.” For another example, as shown in FIG. 7C, ontology 760 can also include a “set reminder” node (i.e., another actionable intent node). Property nodes “date/time” (for setting the reminder) and “subject” (for the reminder) can each be linked to the “set reminder” node. Since the property “date/time” can be relevant to both the task of making a restaurant reservation and the task of setting a reminder, the property node “date/time” can be linked to both the “restaurant reservation” node and the “set reminder” node in ontology 760.

An actionable intent node, along with its linked concept nodes, can be described as a “domain.” In the present discussion, each domain can be associated with a respective actionable intent, and refers to the group of nodes (and the relationships there between) associated with the particular actionable intent. For example, ontology 760 shown in FIG. 7C can include an example of restaurant reservation domain 762 and an example of reminder domain 764 within ontology 760. The restaurant reservation domain includes the actionable intent node “restaurant reservation,” property nodes “restaurant,” “date/time,” and “party size,” and sub-property nodes “cuisine,” “price range,” “phone number,” and “location.” Reminder domain 764 can include the actionable intent node “set reminder,” and property nodes “subject” and “date/time.” In some examples, ontology 760 can be made up of many domains. Each domain can share one or more property nodes with one or more other domains. For example, the “date/time” property node can be associated with many different domains (e.g., a scheduling domain, a travel reservation domain, a movie ticket domain, etc.), in addition to restaurant reservation domain 762 and reminder domain 764.

While FIG. 7C illustrates two example domains within ontology 760, other domains can include, for example, “find a movie,” “initiate a phone call,” “find directions,” “schedule a meeting,” “send a message,” and “provide an answer to a question,” “read a list,” “providing navigation instructions,” “provide instructions for a task” and so on. A “send a message” domain can be associated with a “send a message” actionable intent node, and optionally can further include property nodes such as “recipient(s),” “message type,” and “message body.” The property node “recipient” can be further defined, for example, by the sub-property nodes such as “recipient name” and “message address.”

In some examples, ontology 760 can include all the domains (and hence actionable intents) that the digital assistant is capable of understanding and acting upon. In some examples, ontology 760 can be modified, such as by adding or removing entire domains or nodes, or by modifying relationships between the nodes within the ontology 760.

In some examples, nodes associated with multiple related actionable intents can be clustered under a “super domain” in ontology 760. For example, a “travel” super-domain can include a cluster of property nodes and actionable intent nodes related to travel. The actionable intent nodes related to travel can include “airline reservation,” “hotel reservation,” “car rental,” “get directions,” “find points of interest,” and so on. The actionable intent nodes under the same super domain (e.g., the “travel” super domain) can have many property nodes in common. For example, the actionable intent nodes for “airline reservation,” “hotel reservation,” “car rental,” “get directions,” and “find points of interest” can share one or more of the property nodes “start location,” “destination,” “departure date/time,” “arrival date/time,” and “party size.”

In some examples, each node in ontology 760 can be associated with a set of words and/or phrases that are relevant to the property or actionable intent represented by the node. The respective set of words and/or phrases associated with each node can be the so-called “vocabulary” associated with the node. The respective set of words and/or phrases associated with each node can be stored in vocabulary index 744 in association with the property or actionable intent represented by the node. For example, returning to FIG. 7B, the vocabulary associated with the node for the property of “restaurant” can include words such as “food,” “drinks,” “cuisine,” “hungry,” “eat,” “pizza,” “fast food,” “meal,” and so on. For another example, the vocabulary associated with the node for the actionable intent of “initiate a phone call” can include words and phrases such as “call,” “phone,” “dial,” “ring,” “call this number,” “make a call to,” and so on. The vocabulary index 744 can optionally include words and phrases in different languages.

Natural language processing module 732 can receive the token sequence (e.g., a text string) from STT processing module 730, and determine what nodes are implicated by the words in the token sequence. In some examples, if a word or phrase in the token sequence is found to be associated with one or more nodes in ontology 760 (via vocabulary index 744), the word or phrase can “trigger” or “activate” those nodes. Based on the quantity and/or relative importance of the activated nodes, natural language processing module 732 can select one of the actionable intents as the task that the user intended the digital assistant to perform. In some examples, the domain that has the most “triggered” nodes can be selected. In some examples, the domain having the highest confidence value (e.g., based on the relative importance of its various triggered nodes) can be selected. In some examples, the domain can be selected based on a combination of the number and the importance of the triggered nodes. In some examples, additional factors are considered in selecting the node as well, such as whether the digital assistant has previously correctly interpreted a similar request from a user.

User data 748 can include user-specific information, such as user-specific vocabulary, user preferences, user address, user's default and secondary languages, user's contact list, and other short-term or long-term information for each user. In some examples, natural language processing module 732 can use the user-specific information to supplement the information contained in the user input to further define the user intent. For example, for a user request “invite my friends to my birthday party,” natural language processing module 732 can be able to access user data 748 to determine who the “friends” are and when and where the “birthday party” would be held, rather than requiring the user to provide such information explicitly in his/her request.

Other details of searching an ontology based on a token string is described in U.S. Utility application Ser. No. 12/341,743 for “Method and Apparatus for Searching Using An Active Ontology,” filed Dec. 22, 2008, the entire disclosure of which is incorporated herein by reference.

In some examples, once natural language processing module 732 identifies an actionable intent (or domain) based on the user request, natural language processing module 732 can generate a structured query to represent the identified actionable intent. In some examples, the structured query can include parameters for one or more nodes within the domain for the actionable intent, and at least some of the parameters are populated with the specific information and requirements specified in the user request. For example, the user may say “Make me a dinner reservation at a sushi place at 7.” In this case, natural language processing module 732 can be able to correctly identify the actionable intent to be “restaurant reservation” based on the user input. According to the ontology, a structured query for a “restaurant reservation” domain optionally can include parameters such as {Cuisine}, {Time}, {Date}, {Party Size}, and the like. In some examples, based on the speech input and the text derived from the speech input using STT processing module 730, natural language processing module 732 can generate a partial structured query for the restaurant reservation domain, where the partial structured query includes the parameters {Cuisine=“Sushi”} and {Time=“7 pm”}. However, in this example, the user's utterance contains insufficient information to complete the structured query associated with the domain. Therefore, other necessary parameters such as {Party Size} and {Date} optionally cannot be specified in the structured query based on the information currently available. In some examples, natural language processing module 732 can populate some parameters of the structured query with received contextual information. For example, in some examples, if the user requested a sushi restaurant “near me,” natural language processing module 732 can populate a {location} parameter in the structured query with GPS coordinates from the user device.

In some examples, natural language processing module 732 can pass the generated structured query (including any completed parameters) to task flow processing module 736 (“task flow processor”). Task flow processing module 736 can be configured to receive the structured query from natural language processing module 732, complete the structured query, if necessary, and perform the actions required to “complete” the user's ultimate request. In some examples, the various procedures necessary to complete these tasks can be provided in task flow models 754. In some examples, task flow models 754 can include procedures for obtaining additional information from the user and task flows for performing actions associated with the actionable intent.

As described above, in order to complete a structured query, task flow processing module 736 optionally can need to initiate additional dialogue with the user in order to obtain additional information, and/or disambiguate potentially ambiguous utterances. When such interactions are necessary, task flow processing module 736 can invoke dialogue flow processing module 734 to engage in a dialogue with the user. In some examples, dialogue flow processing module 734 can determine how (and/or when) to ask the user for the additional information and receives and processes the user responses. The questions can be provided to and answers can be received from the users through I/O processing module 728. In some examples, dialogue flow processing module 734 can present dialogue output to the user via audio and/or visual output, and receives input from the user via spoken or physical (e.g., clicking) responses. Continuing with the example above, when task flow processing module 736 invokes dialogue flow processing module 734 to determine the “party size” and “date” information for the structured query associated with the domain “restaurant reservation,” dialogue flow processing module 734 can generate questions such as “For how many people?” and “On which day?” to pass to the user. Once answers are received from the user, dialogue flow processing module 734 can then populate the structured query with the missing information, or pass the information to task flow processing module 736 to complete the missing information from the structured query.

Once task flow processing module 736 has completed the structured query for an actionable intent, task flow processing module 736 can proceed to perform the ultimate task associated with the actionable intent. Accordingly, task flow processing module 736 can execute the steps and instructions in the task flow model according to the specific parameters contained in the structured query. For example, the task flow model for the actionable intent of “restaurant reservation” can include steps and instructions for contacting a restaurant and actually requesting a reservation for a particular party size at a particular time. For example, using a structured query such as: {restaurant reservation, restaurant=ABC Café, date=3/12/2012, time=7 pm, party size=5}, task flow processing module 736 can perform the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some examples, task flow processing module 736 can employ the assistance of service processing module 738 (“service processing module”) to complete a task requested in the user input or to provide an informational answer requested in the user input. For example, service processing module 738 can act on behalf of task flow processing module 736 to make a phone call, set a calendar entry, invoke a map search, invoke or interact with other user applications installed on the user device, and invoke or interact with third-party services (e.g., a restaurant reservation portal, a social networking website, a banking portal, etc.). In some examples, the protocols and application programming interfaces (API) required by each service can be specified by a respective service model among service models 756. Service processing module 738 can access the appropriate service model for a service and generate requests for the service in accordance with the protocols and APIs required by the service according to the service model.

For example, if a restaurant has enabled an online reservation service, the restaurant can submit a service model specifying the necessary parameters for making a reservation and the APIs for communicating the values of the necessary parameter to the online reservation service. When requested by task flow processing module 736, service processing module 738 can establish a network connection with the online reservation service using the web address stored in the service model, and send the necessary parameters of the reservation (e.g., time, date, party size) to the online reservation interface in a format according to the API of the online reservation service.

In some examples, natural language processing module 732, dialogue flow processing module 734, and task flow processing module 736 can be used collectively and iteratively to infer and define the user's intent, obtain information to further clarify and refine the user intent, and finally generate a response (i.e., an output to the user, or the completion of a task) to fulfill the user's intent. The generated response can be a dialogue response to the speech input that at least partially fulfills the user's intent. Further, in some examples, the generated response can be output as a speech output. In these examples, the generated response can be sent to speech synthesis module 740 (e.g., speech synthesizer) where it can be processed to synthesize the dialogue response in speech form. In yet other examples, the generated response can be data content relevant to satisfying a user request in the speech input.

Speech synthesis module 740 can be configured to synthesize speech outputs for presentation to the user. Speech synthesis module 740 synthesizes speech outputs based on text provided by the digital assistant. For example, the generated dialogue response can be in the form of a text string. Speech synthesis module 740 can convert the text string to an audible speech output. Speech synthesis module 740 can use any appropriate speech synthesis technique in order to generate speech outputs from text, including, but not limited, to concatenative synthesis, unit selection synthesis, diphone synthesis, domain-specific synthesis, formant synthesis, articulatory synthesis, hidden Markov model (HMM) based synthesis, and sinewave synthesis. In some examples, speech synthesis module 740 can be configured to synthesize individual words based on phonemic strings corresponding to the words. For example, a phonemic string can be associated with a word in the generated dialogue response. The phonemic string can be stored in metadata associated with the word. Speech synthesis model 740 can be configured to directly process the phonemic string in the metadata to synthesize the word in speech form.

In some examples, instead of (or in addition to) using speech synthesis module 740, speech synthesis can be performed on a remote device (e.g., the server system 108), and the synthesized speech can be sent to the user device for output to the user. For example, this can occur in some implementations where outputs for a digital assistant are generated at a server system. And because server systems generally have more processing power or resources than a user device, it can be possible to obtain higher quality speech outputs than would be practical with client-side synthesis.

Additional details on digital assistants can be found in the U.S. Utility application Ser. No. 12/987,982, entitled “Intelligent Automated Assistant,” filed Jan. 10, 2011, and U.S. Utility application Ser. No. 13/251,088, entitled “Generating and Processing Task Items That Represent Tasks to Perform,” filed Sep. 30, 2011, the entire disclosures of which are incorporated herein by reference.

FIGS. 8A-8JJ illustrate exemplary user interfaces for remembering user data and generating recommendations, in accordance with some embodiments. The user interfaces in these figures are used to illustrate the processes described below, including the exemplary processes in FIGS. 9A-9G.

Referring to FIG. 8A, an electronic device 200 includes a display 212 and a microphone 213 in accordance with some embodiments. A digital assistant, as described above, is accessed by a user, who utters unstructured natural language user input that is acquired via the microphone 213. The timing of the user utterance is under the control of the user. The user input is converted from speech to text, and, in accordance with some embodiments, the textual user input 1040 is displayed on the display 212. By displaying the textual user input 1040, in accordance with some embodiments, the user can verify that the digital assistant has received correctly the request to remember user data. In other embodiments, such as but not limited to embodiments in which the digital assistant is operable in a hands-free mode, the textual user input 1040 is not displayed.

As illustrated in the example of FIG. 8A, the user requests that the digital assistant remember user data: in this case, a particular wine that the user likes. The digital assistant generates at least one experiential data structure, as described below in greater detail relative to FIGS. 9A-9G. The experiential data structure is a data structure that includes an organized set of data associated with at least one of the user and the electronic device 200 at a particular point in time. The data is associated with items that a user wishes to remember, as well as data that has utility in generating recommendations to the user. According to some embodiments, the kinds of data that the user finds significant to remember, and has utility in generating recommendations to the user, are referred to as dimensions of the experiential data structure. The dimensions are flexible and optionally can change over time or with context, according to some embodiments. In the example of FIG. 8A, the primary dimension is the user's daily activity dimension, which includes reminders. As described in greater detail below with regard to block 906, according to some embodiments there are six primary dimensions: a social dimension, a location dimension, a media dimension, a content dimension, a photographic dimension, and a daily activity dimension. As is seen below, there can be overlap between dimensions, and a given data item can be assigned to any suitable dimension consistent with the method 900. As used in this document, the six primary dimensions also are referred to interchangeably as social information, location information, media information, content information, photographic information, and daily activity information.

Next, the virtual assistant tags the experiential data structure with one or more annotations, as described below in greater detail relative to FIGS. 9A-9G. The annotations include at least one of user context and device context, as described below in greater detail relative to FIGS. 9A-9G. A number of examples are provided below, illustrating the operation of the method 900 of FIGS. 9A-9G in remembering user data and generating recommendations. In the example of FIG. 8A, the device context includes the location of the device (e.g., map coordinates, the name of a restaurant or wine retailer). The virtual assistant tags the experiential data structure, then stores the experiential data structure. The experiential data structure is stored at the DA server 106 or server system 108 according to some embodiments, in order to reduce the load on memory storage of the electronic device 200. This is particularly useful where the electronic device 200 is portable (e.g., a smartphone, a smart watch). According to other embodiments, at least one experiential data structure or part of an experiential data structure is stored at the electronic device 200. This is particularly useful where the electronic device 200 has ample memory, and/or where the experiential data structure is particularly important to the user or is expected to be utilized in the near future.

As illustrated in the example of FIG. 8B, the user requests that the digital assistant remember user data: in this case, that the user likes the carnitas tacos here. The digital assistant generates at least one experiential data structure, similar to the manner described above with regard to FIG. 8A. In the example of FIG. 8B, one dimension of the experiential data structure is the user's daily activity dimension, which includes reminders, and another dimension of the experiential data structure is the location, which in this example is “here.” “Here” is a word that, standing alone, does not denote a particular, unique location. The digital assistant recognizes that “here” is a word with insufficient clarity to allow for the creation of an experiential data structure. However, the word “here” refers to a particular geographical location at the time of its utterance, and the virtual assistant utilizes the GPS module 235 and/or the map module 254 of the electronic device 250 to determine where “here” is, according to some embodiments. In some embodiments, the digital assistant generates an experiential data structure that includes the map coordinates of the location where the request to remember user data were uttered. In some embodiments, the digital assistant uses the map coordinates in conjunction with the map module to determine that the map coordinates are associated with a restaurant (e.g., Heinrich's Taqueria), and generates an experiential data structure that includes the restaurant as well as, or instead of, the map coordinates. The digital assistant tags the experiential data structure with user or device context, such as time, and stores the experiential data structure.

As illustrated in FIG. 8C, the user requests that the digital assistant remember user data: in this case, that the user likes the ham sandwich here. The digital assistant generates at least one experiential data structure in response. As described above with regard to FIG. 8B, the word “here” is ambiguous, but in the example of FIG. 8B, was disambiguated by the use of location modules that are part of the electronic device 200. In the example of FIG. 8C, the user is sitting inside, which can cause a loss of resolution of a GPS or other locator signal, and the user is sitting at a table against the wall separating two restaurants. In this example, the digital assistant thus cannot on its own disambiguate the location between the two restaurants. Continuing the example, the digital assistant then requests additional information from the user, as seen in FIG. 8D. The electronic device 200 could be located at one of two restaurants, so the digital assistant makes a request 1042 of the user: “Where are you? You are near Sandwich Shop and Jimbo's Indian Buffet.” In response, referring to FIG. 8E, the user responds “Sandwich Shop.” The digital assistant now has enough information to generate and store an experiential data structure remembering that the user likes the ham sandwich at Sandwich Shop. Optionally, referring to FIG. 8F, the digital assistant confirms 1044 with a message on the display that it received the user input and has generated an experiential data structure associated with the user request.

According to some embodiments, the virtual assistant is configured to allow the user to annotate any virtual object—a photo, a song, a website, a news article, a calendar event, an electronic mail message, and/or any content that is viewable or listenable via the electronic device. Such annotations provide for a richer set of data that is usable by the virtual assistant to satisfy user requests. As one example, referring to FIG. 8FF, the display 212 displays a photo 1088 to the user, such as through a photo application. The user likes the photo, and invokes the virtual assistant and states 1089 to the virtual assistant that “This is a great photo of Marcus!”. In response, the virtual assistant generates an experiential data structure, and includes information (e.g., the photo dimension) associated with the fact that Marcus is in the photo. Optionally, the virtual assistant searches the user's contact list for a person named Marcus. If one is found, the virtual assistant automatically includes that information in the experiential data structure, or alternately requests the user to confirm the identity of the person (i.e., disambiguate to ensure the correct “Marcus”).

As another example, referring to FIG. 8GG, the user takes a photograph 1090 of a plate of spaghetti at dinner at a restaurant. The user invokes the virtual assistant and states 1091 that “The spaghetti at this restaurant is really good!” The virtual assistant recognizes that this statement is associated with a desire to remember the information. For example, the invocation of the virtual assistant coupled with the utterance “really good” allows the virtual assistant to infer that the user wishes to remember something. In response, the virtual assistant generates an experiential data structure, and includes information relating to spaghetti, and that the user really likes it. As set forth above, the virtual assistant optionally utilizes global positioning system information or other information to determine the location of the device at the time of creation of the experiential data structure, and uses that information to determine the name of the particular restaurant at which the user is located. For example, the restaurant is Italiano Ristorante in Santa Clara, Calif. The virtual assistant then includes that information in the experiential data structure, such as in the location dimension of that experiential data structure.

As illustrated in the examples of FIGS. 8G-8J, the virtual assistant automatically generates experiential data structures, such at intervals of time (regular or irregular), or upon changes to dimension or context associated with the user or device. This automatic generation of experiential data structures occurs without an express user request to generate an experiential data structure. For example, referring to FIG. 8G, the user receives a message 1046 from Aaron asking if she is going to the meeting at 5:00. The user responds 1048 “yes.” The messages optionally can be SMS messages, messages in the iMessage® software feature of Apple, Inc., Cupertino, Calif., or any other kind of message. The digital assistant determines that an interaction has occurred in the social dimension and/or daily activity dimension, and generates an experiential data structure accordingly, including relevant content from the messages 1046, 1048. In this example, the relevant content includes the time of the meeting, the time of the communication, the person with whom messages were exchanged (Aaron), and the content of the communication.

As another example, referring to FIG. 8H, the electronic device has moved to 425 Market Street, San Francisco, Calif., from a different location. The digital assistant determines that the electronic device 200 has moved, such that the location dimension has changed, and generates an experiential data structure accordingly, for example including the address, the time (4:54 p.m., as seen in FIG. 8H), and the date.

As another example, referring to FIG. 8G, the user has requested electronic device 200 to play back media 1050, such as Bach's Brandenburg Concerto #1 in F Major. Upon commencing playback, the digital assistant determines that media playback has begun, such that the media dimension has changed, and generates an experiential data structure accordingly, for example including one or more identifiers of the media, and the time and date at which media playback occurred.

Referring to FIG. 8K, as one example, the virtual assistant receives a natural-language request 1052 for service. In the example of FIG. 8K, the user asks “who is in my 5 pm meeting?” In response to the receipt of this request for service, the virtual assistant utilizes at least one stored experiential data structure. For example, the virtual assistant, which includes at least one of the DA client 102 and DA server 106, searches experiential data structures stored at the electronic device 200 and the server system 108, respectively. An exemplary search strategy starts with experiential data structures that include information associated with a 5:00 p.m. meeting on today's date. After identifying those experiential data structure(s), the virtual assistant identifies information associated with those experiential data structures (whether as dimensions, contexts, or tags) that includes names of attendees of the meeting. Referring to FIG. 8L, the virtual assistant displays that information on the display 212, indicating to the user that Aaron, Marie, and Ian are attending the meeting. Referring back to FIG. 8G, in that example, an experiential data structure was generated indicating that Aaron planned to attend the 5:00 p.m. meeting; at least that experiential data structure was utilized to determine that Aaron is in the 5:00 p.m. meeting.

Referring to FIG. 8M, as one example, the virtual assistant receives a natural-language request 1052 for service. In the example of FIG. 8M, the user asks “when is the last time I was in Denver?” In response to the receipt of this request for service, the virtual assistant utilizes at least one stored experiential data structure. For example, the virtual assistant, which includes at least one of the DA client 102 and DA server 106, searches experiential data structures stored at the electronic device 200 and the server system 108, respectively. An exemplary search strategy starts with experiential data structures that include a location dimension within the Denver city limits. After identifying those experiential data structure(s), the virtual assistant identifies date and time information associated with those experiential data structures. The user may have visited Denver during Oct. 6-8 of 2014. The virtual assistant determines that the most recent experiential data structure associated with the city of Denver that was tagged with a date was tagged on Oct. 8, 2014. As used herein, the term “tagged” refers to the addition or placement of data in an experiential data structure. The virtual assistant also determines that experiential data structures associated with the city of Denver were generated on October 6 and October 7. Because the user's electronic device 200 was in Denver on three contiguous days, the virtual assistant infers (in a manner, for example, as previously described) that the time span between October 6 and October 8 was the last time the user was in Denver, and presents 1058 that information on display 212 as shown in FIG. 8N.

Referring to FIG. 8P, as one example, the virtual assistant receives a natural-language request 1060 for service. In the example of FIG. 8P, the user asks “where was I last Monday morning?” In response to the receipt of this request for service, the virtual assistant utilizes at least one stored experiential data structure. For example, the virtual assistant, which includes at least one of the DA client 102 and DA server 106, searches experiential data structures stored at the electronic device 200 and the server system 108, respectively. An exemplary search strategy starts with identifying the date of the previous Monday (e.g., Sep. 28, 2015) and then searches for experiential data structures tagged with a time between 12:01 am and noon on Sep. 28, 2015. After identifying those experiential data structure(s), the virtual assistant identifies location information associated with those experiential data structures. Based on those experiential data structures, the virtual assistant determines the user was at the location of his home until 8 am, was in motion until approximately 8:30 am, was at a location associated with the Breakfast Diner from 8:30 until 10:00 am, was in motion after that, and was then at a location associated with “work.” Further, the virtual assistant determines from the stored experiential data structures that the experiential data structures tagged with the location of Breakfast Diner also include information about a meeting with Bob at Breakfast Diner. The location associated with “work” may be so associated as a result of a previously-stored user input identifying a particular location as a work location, or may be automatically tagged as “work” by the virtual assistant due to the amount of time spent there and the content of communications transmitted and received there. The virtual assistant presents 1062 that information on display 212 as shown in FIG. 8N.

Referring to FIG. 8R, as one example, the virtual assistant receives a natural-language request 1062 for service. In the example of FIG. 8P, the user asks “what is that Thai restaurant I like in Cupertino?” In response to the receipt of this request for service, the virtual assistant utilizes at least one stored experiential data structure. For example, the virtual assistant, which includes at least one of the DA client 102 and DA server 106, searches experiential data structures stored at the electronic device 200 and the server system 108, respectively. An exemplary search strategy starts with searching for experiential data structures tagged with the location “Cupertino, Calif.” After identifying those experiential data structure(s), the virtual assistant identifies location information associated with those experiential data structures. The virtual assistant then determines which of those experiential data structures are tagged with or associated with data indicating a location of a restaurant, and then out of those experiential data structures, determines which are tagged with or associated with data indicating Thai cuisine. As another exemplary search strategy, the virtual assistant starts with search for experiential data structures tagged with or associated with information including a restaurant. After identifying those experiential data structure(s), the virtual assistant identifies location information of Cupertino, Calif. associated with those experiential data structures, and also determines which experiential data structures are tagged with or associated with data indicating Thai cuisine. The virtual assistant then determines which of those restaurants were tagged by the user as a restaurant that he or she liked. Alternately, in some embodiments the virtual assistant starts off looking for experiential data structures tagged with an indication that the user liked something, and then narrows the search for a Thai restaurant in Cupertino, Calif. The virtual assistant determines that the user has tagged Thai Plus Plus as a restaurant that she likes, and the virtual assistant presents 1064 that information on display 212 as shown in FIG. 8S.

Referring to FIG. 8T, as one example, the virtual assistant receives a natural-language request 1068 for service. In the example of FIG. 8T, the user asks “where was I when I heard that Massive Attack song?” In response to the receipt of this request for service, the virtual assistant utilizes at least one stored experiential data structure. For example, the virtual assistant, which includes at least one of the DA client 102 and DA server 106, searches experiential data structures stored at the electronic device 200 and the server system 108, respectively. An exemplary search strategy starts with identifying the date and time that that a song or album from Massive Attack was last played on the electronic device 200, and then searches for experiential data structures tagged with that date and time. After identifying those experiential data structure(s), the virtual assistant identifies location information associated with those experiential data structures. Based on those experiential data structures, the virtual assistant determines the user was at home the last time that Massive Attack was played. The location associated with “home” may be so associated as a result of a previously-stored user input identifying a particular location as a home location, or may be automatically tagged as “home” by the virtual assistant due to the amount of time spent there and the content of communications transmitted and received there. The virtual assistant presents 1070 that information on display 212 as shown in FIG. 8U.

Referring to FIG. 8V, as one example, the virtual assistant receives a natural-language request 1072 for service. In the example of FIG. 8V, the user asks “Where are my keys?” This request is at a higher level of abstraction. In response to the receipt of this request for service, the virtual assistant utilizes at least one stored experiential data structure. For example, the virtual assistant, which includes at least one of the DA client 102 and DA server 106, searches experiential data structures stored at the electronic device 200 and the server system 108, respectively. An exemplary search strategy starts with searching for experiential data structures tagged with the word “keys.” According to some embodiments, the search optionally can start with, or be limited to, experiential data structures generated in response to receipt of a user request. After identifying those experiential data structure(s), the virtual assistant identifies location information associated with those experiential data structures. For example, the user may have misplaced keys before, found them in a location, and requested the virtual assistant to remember the location. Depending on the overall forgetfulness of the user, the user may do so multiple times in different locations. Based on those experiential data structures, the virtual assistant determines the keys are most likely on the kitchen counter next to the toaster. In this example, the user noted 3 times in the past that the keys were there, and noted once that the keys were on the ottoman in the living room. By applying statistical analysis, including the dates and times the 4 inputs were made in the past, the virtual assistant determines that the keys are most likely on the kitchen counter next to the toaster. The virtual assistant presents 1074 that information on display 212 as shown in FIG. 8W. According to some embodiments, when the user asks the virtual assistant to remember the location of his or her keys, the virtual assistant disambiguates the location, in a manner such as that described with reference to FIG. 8D. The virtual assistant, in some embodiments, recognizes that a request to remember the location of a small item, such as “keys,” requires a finer level of location discernment than may be available to the electronic device. As a result, the virtual assistant asks the user, “where exactly are you leaving your keys?” Upon receiving a response from the user, the virtual assistant stores that information in an experiential data structure, which includes the location (e.g., “next to the toaster”), time of request (e.g., 11:45 p.m.) and item to be remembered (e.g., “keys”).

With reference to FIG. 8V, in a different example the user asks “Where are my keys?” In this example, the user's keys are attached or associated with a tracking unit, such as a Bluetooth® wireless device, radio-frequency identification device (RFID), or other tracking device. Such a tracking device is attached to a key ring in some embodiments, and/or is included within one or more keys in some embodiments. The electronic device 200 periodically receives a signal from the tracking device, whether in response to a request for a signal from the tracking device, or by listening periodically (e.g., once every minute, once every 10 minutes) for the signal from the tracking device. In response to such a receipt of a signal from the tracking device, the virtual assistant generates an experiential data structure that includes a location dimension associated with the location of the tracking device, and therefore the keys. When the user asks “where are my keys?”, the virtual assistant detects a signal from the tracking device, and responds based on that signal. In other embodiments, the virtual assistant identifies experiential data structures that include location dimension information associated with the tracking device. The virtual assistant determines which of those experiential data structures is most recent in time, and uses the location dimension information associated with the most recent experiential data structure to determine that the keys are most likely on the kitchen counter next to the toaster. The virtual assistant presents 1074 that information on display 212 as shown in FIG. 8W.

As with the example above, the stored experiential data structures provide an archive of locations where the keys have been located across a span of time. The virtual assistant, in some embodiments, applies statistical analysis to that data just as described above, to determine the user's most common places to leave his keys. In response, the virtual assistant provides information to the user associated with the most likely location of the keys.

Further, the electronic device (e.g., device 104, 200, 400, 600) is configured to recognize multiple tracking devices, such as RFID tags, according to some embodiments. One or more tracking devices recognizable to the electronic device 104, 200, 400, 600 is associated with a particular person, in some embodiments. For example, one or more tracking devices may be associated with the user, and may be attached to or associated with the user's keys, the user's wallet, the user's glasses, and/or other objects important to the user. One or more other tracking devices may be associated with the user's spouse or significant other, and similarly may be attached to or associated with that person's keys, wallet, glasses, and/or other objects. In this way, if the user's spouse has lost his wallet, the user requests the virtual assistant to “find Jim's wallet.” As set forth above, the virtual assistant determines the location of Jim's wallet, in the same or similar manner as the virtual assistant would do for the user.

Additionally, by associating a particular person with particular RFID tags or tracking devices, the virtual assistant is able to add information about who the user is with when generating experiential data structures. By way of example, the user may be at dinner with her spouse at a restaurant. As the virtual assistant generates one or more experiential data structures associated with the dinner, it adds the name of the spouse (e.g., as determined through proximity to a tracking device on the spouse's keys, wallet, or other object) to the social dimension of that experiential data structure. At a later time, if the user forgets the name of the restaurant, she can ask “What was that restaurant I went to with Kate?” In a similar manner as described above with regard to FIGS. 8R-8S, the virtual assistant searches stored experiential data structures to determine which restaurants the user has patronized within a recent period of time, then searches those experiential data structures for information associated with Kate being at the restaurant at the same time. The virtual assistant then presents a list of one or more restaurants, optionally including information such as addresses, links to reviews, and photo thumbnails, to the user on display 212.

Referring to FIG. 8HH, the user requests 1092 a recommendation from the virtual assistant of “Where should I eat spaghetti?” Referring back to FIG. 8GG, the user previously had taken a photograph 1090 of a plate of spaghetti and requested the virtual assistant to remember that it is really good. The virtual assistant generated and stored an experiential data structure that includes the photo 1090, information that the user liked the spaghetti, and the name of the restaurant. Upon receiving the request 1092 of “where should I eat spaghetti?”, the virtual assistant searches stored experiential data structures for “spaghetti,” and upon finding them, determines for each experiential data structure whether a restaurant is associated with the term “spaghetti”. By searching for restaurants, not locations, locations such as “Grandma's house” that are not relevant to the request are not included. In other embodiments, the virtual assistant first searches stored experiential data structures for restaurants, then searches for the term “spaghetti.” In still further embodiments, the virtual assistant searches stored experiential data structures for both the term “spaghetti” and for restaurants, in order to maximize speed. Upon completion of the faster search, the other search is abandoned, and the results of the faster search are then searched further in order to respond to the user request. In the example of FIG. 8HH, the virtual assistant finds the stored experiential data structure that includes the photo 1090, information that the user liked the spaghetti, and the name of the restaurant, then displays the photo 1090 to the user and indicates 1093 that the user likes the spaghetti at Italiano Ristorante in Santa Clara.

Referring to FIG. 8X, as one example, the virtual assistant makes a recommendation without input from the user. In the context of this example, the user is at the Delhi Palacio and has the electronic device 200 in her possession. The electronic device 200 recognizes that it is at the Delhi Palacio, and passes this information to the virtual assistant. The virtual assistant searches stored experiential data structures for the location Delhi Palacio, and determines if any of those experiential data structures include stored user information relating to the user's preferences. The virtual assistant determines that one stored experiential data structure includes information that the user likes the chicken tikka masala, and that another stored experiential data structure includes information that the user likes the lentil soup. Without receiving a user request for a recommendation, the virtual assistant presents 1076 information on the display 212 as shown in FIG. 8X, reminding the user that she likes the chicken tikka masala and the lentil soup at the Delhi Palacio.

Referring to FIG. 8Y, as another example, the virtual assistant makes a recommendation without input from the user. In the context of this example, the user's calendar includes an entry for a birthday party. The virtual assistant periodically checks the calendar for upcoming events, and recognizes that the birthday party is tonight. It also recognizes the location of that birthday party (“Anne's house”). The virtual assistant includes one or more task templates, and the presence of the words “birthday party” in association with the event trigger performance of a task to remind the user to purchase a gift. The virtual assistant determines that none of the stored experiential data structures includes information that the user has purchased a birthday gift. Without receiving a user request for a recommendation, the virtual assistant presents 1078 information on the display 212 as shown in FIG. 8Y, reminding the user that he is scheduled to go to a birthday party tonight, and asking the user if he purchased a gift.

With reference to FIG. 8Z, the user asks for a recommendation from Sandwich Shop restaurant. Referring back to FIGS. 8C-8F, the user had previously generated experiential data structures tagged with the user's liking of the ham sandwich at Sandwich Shop. The virtual assistant analyzes at least one stored experiential data structure based on the user request. For example, the virtual assistant locates the at least one stored experiential data structure including a location dimension of Sandwich Shop, where that experiential data structure includes the user's like of the ham sandwich. According to some embodiments, the virtual assistant satisfies the user request based on analysis of at least one stored experiential data structure, and in FIG. 8AA reminds the user that he likes the ham sandwich.

With reference to FIG. 8BB, the user asks the virtual assistant to “Remember that I parked here.” Remembering the location of a vehicle can be challenging in a parking garage, at a shopping mall, or other location with a large capacity for vehicles. As described above with regard to FIGS. 8B and 8C, the virtual assistant first disambiguates the term “here,” meaning that the virtual assistant determines the particular location associated with the term “here.” In this example, the user (and thus the electronic device 200) are located in a parking garage, where the structure interferes with the ability of the electronic device 200 to receive global positioning system (GPS) signals. Consequently, the virtual assistant is unable to determine the particular location associated with the term “here.” The virtual assistant then requests additional information from the user, as illustrated in FIG. 8CC, and makes a request 1085 of the user: “I'm sorry, but I can't determine where you are. Can you say the name of a location?” In response, referring to FIG. 8DD, the user responds “I'm in the parking garage at my dentist.” In other embodiments, the user takes a picture of the location, where the picture is stored an experiential data structure. According to some embodiments, the virtual assistant is able to disambiguate the term “here”, at least partially, based on the motion of the user prior to arriving at the parking garage. For example, the electronic device 200 is able to receive a GPS signal up to a time shortly before the user parks. In this example, the last location at which the GPS signal is received by the electronic device 200 is used to infer that the current location is in proximity to (e.g., under, or inside) the location at which the signal was last received. A BLUETOOTH® wireless pairing is used to disambiguate location, at least in part, according to other embodiments. Such a wireless pairing allows the electronic device 200 to use positioning information from another device, such as the user's car, that is connected to the electronic device via BLUETOOTH® wireless connectivity. According to some embodiments, after receiving location information from the user, the virtual assistant generates and stores an experiential data structure, including a location that is specified by the phrase “parking garage at my dentist, Pillar 2-B.” This information provides adequate specificity to allow the user to find his or her vehicle upon receiving that information from the virtual assistant. Referring to FIG. 8EE, in some embodiments, the virtual assistant indicates 1087 on the display 212, and/or via audio, that the information has been received. Further, according to some embodiments, the virtual assistant searches the user's contacts, and determines that an entry is associated with the term “dentist.” The virtual assistant then acquires address information from the that contact, and populates the location dimension of the experiential data structure with that address. As illustrated in FIG. 8EE, that address may be shown to the user to confirm that the virtual assistant has acquired that information.

As illustrated above by FIGS. 8A-8JJ, and described in the text associated with those figures and further described below, a user utilizes the virtual assistant to search any dimension of the stored experiential data structures in order to satisfy a user request. As one example, a user may find music by time and/or place. As another example, a user may find a place by asking about an meeting with a person (i.e., “where was I when I met Paul?”) In this way, the virtual assistant performs actions that may be similar to the workings of human memory. Human memory is associational, and creates interconnections between things that happen at the same time. The virtual assistant uses the experiential data structures to store information across dimensions in discrete data structures separated in time. Retrieving information from those experiential data structures then occurs, in some embodiments, by using a portion of that information. That is, the virtual assistant stores and indexes data that can be retrieved using a subset of that data. Further, the virtual assistant can group experiential data structures based on any dimension and/or one or more tags. For example, if a user is visiting San Francisco for a weekend, that user may request information about food, about restaurants, photos from previous visits, and music from previous visits. To fulfill this request, the location dimension is dominant, and the time and date of the experiential data structures is less important or unimportant. For example, the user may ask the virtual assistant to show all photos she has taken in the city of San Francisco, in order to remember previous trips with friends and family. In response to that request, the virtual assistant searches stored experiential data structures that include the location of San Francisco, then searches the photo dimension of those experiential data structures to determine which photos were taken in San Francisco (or vice versa), then displays those photos to the user such as on the display 212 of the electronic device 200. As is apparent from this example, the virtual assistant can proceed along several paths in satisfying a user request, and end at the same data set regardless of the path. In this way, retrieval of information from the experiential data structures may be referred to as path-independent.

As illustrated above by FIGS. 8A-8JJ, and described in the text associated with those figures and further described below, a user utilizes the virtual assistant to search any dimension of the stored experiential data structures in order to satisfy a user request. According to some embodiments, a recommendation made by the virtual assistant to satisfy a user request (e.g., the name and location of a restaurant, such as in FIG. 8S) is one item of several presented to the user. For example, where the user requests “Where should I eat spaghetti?”, such as in FIG. 8HH, the result of FIG. 8JJ (Italiano Ristorante in Santa Clara) is presented in a list (at the top, or at another location) of recommendations that include recommendations from other sources, such as reviews in social media, and/or a simple list of Italian restaurants in physical proximity to the user's location (i.e., the location of the electronic device 200) regardless of their reviews.

FIGS. 9A-9G illustrate a process 900 for operating a digital assistant according to various examples. More specifically, process 900 can be implemented to remember user data and generate recommendations using a digital assistant. The process 900 can be performed using one or more electronic devices implementing a digital assistant. In some examples, the process 900 can be performed using a client-server system (e.g., system 100) implementing a digital assistant. The individual blocks of the process 900 optionally can be distributed in any appropriate manner among one or more computers, systems, or electronic devices. For instances, in some examples, process 900 can be performed entirely on an electronic device (e.g., devices 104, 200, 400, or 600). References in this document to any one particular electronic device (104, 200, 400, or 600) shall be understood to encompass all of the electronic devices (104, 200, 400, or 600) unless one or more of those electronic devices (104, 200, 400 or 600) is excluded by the plain meaning of the text. For example, the electronic device (104, 200, 400 or 600) utilized in several examples is a smartphone. However, the process 900 is not limited to use with a smartphone; the process 900 optionally can be implemented on any other suitable electronic device, such as a tablet, a desktop computer, a laptop, or a smart watch. Electronic devices with greater computing power and greater battery life optionally can perform more of the blocks of the process 900. The distribution of blocks of the process 900 need not be fixed, and optionally can vary depending upon network connection bandwidth, network connection quality, server load, availability of computer power and battery power at the electronic device (e.g., 104, 200, 400, 600), and/or other factors. Further, while the following discussion describes process 900 as being performed by a digital assistant system (e.g., system 100 and/or digital assistant system 700), it should be recognized that the process or any particular part of the process is not limited to performance by any particular device, combination of devices, or implementation. The description of the process is further illustrated and exemplified by FIGS. 8A-8JJ, and the description above related to those figures.

FIGS. 9A-9F are a flow diagram 900 illustrating a method for remembering user data and generating recommendations using a digital assistant and an electronic device (104, 200, 400, or 600) in accordance with some embodiments. Some operations in process 900 optionally can be combined, the order of some operations optionally can be changed, and some operations optionally can be omitted. In particular, optional operations indicated with dashed-line shapes in FIGS. 9A-9F optionally can be performed in any suitable order, if at all, and need not be performed in the order set forth in FIGS. 9A-9F.

As described below, method 900 provides an intuitive way for remembering user data and generating recommendations using a digital assistant. The method reduces the cognitive burden on a user for remembering user data and generating recommendations using a digital assistant, thereby creating a more efficient human-machine interface. For battery-operated computing devices, enabling a user to remember user data and generate recommendations based on a nonspecific, unstructured natural-language request using a digital assistant more accurately and more efficiently conserves power and increases the time between battery charges.

At the beginning of process 900, in block 902, the digital assistant generates at least one experiential data structure and/or the electronic device 104, 200, 400, 600 generates at least one experiential data structure accessible to the digital assistant. The experiential data structure is a data structure that includes an organized set of data associated with the user and/or the electronic device 200 at a particular point in time. The data is associated with items that a user wishes to remember, and data that has utility in generating recommendations to the user.

Optionally, in block 904, the digital assistant and/or electronic device 104, 200, 400, 600 generate a plurality of experiential data structures separated by time intervals. According to some embodiments, the time intervals are substantially regular. For example, the digital assistant and/or electronic device 104, 200, 400, 600 generate a new experiential data structure every second, every thirty seconds, every minute, every five minutes, or at any other suitable interval. According to some embodiments, the user selects the time interval. More experiential data structures provide a greater resolution with regard to items to be remembered, but require more memory space. According to other embodiments, the time interval is set by the digital assistant or the electronic device 104, 200, 400, 600. According to other embodiments, the time interval is variable. For example, late at night when the electronic device 104, 200, 400, 600 is stationary at home, and little to no use is made of the electronic device 104, 200, 400, 600, the digital assistant infers that the user is asleep and generate a new experiential data structure once per hour, or less. When the user wakes, the digital assistant and/or electronic device 104, 200, 400, 600 begin to generate experiential data structures more frequently, and that frequency of generation increases when the user begins his or her work day.

Optionally, instead of (or in addition to) generating a new experiential data structure after an interval of time since the previous one, the digital assistant and/or electronic device 104, 200, 400, 600 generate a new experiential data structure in block 906 when at least one dimension of the experiential data structure changes, when the device context changes, or when the user context changes. As described above with regard to FIGS. 8A-8JJ, according to some embodiments, the kinds of data that the user finds significant to remember, and has utility in generating recommendations to the user, are referred to as dimensions of the experiential data structure. The dimensions optionally can overlap with the device context and/or user context. Generally speaking, the dimension(s) of the experiential data structure are the elements of information likely to be more important in terms of remembering user data and generating recommendations. By generating a new experiential data structure when a dimension of the experiential data structure or a context changes, the digital assistant captures those changes, and can reduce the generation of experiential data structures that have negligible value in remembering user data and generating recommendations.

According to some embodiments, there are six primary dimensions: a social dimension, a location dimension, a media dimension, a content dimension, a photographic dimension, and a daily activity dimension. As is seen below, there can be overlap between dimensions, and a given data item can be assigned to any suitable dimension consistent with the method 900.

According to some embodiments, the social dimension includes information associated with at least one person other than the user, such as, communications and social links between people. In some embodiments, the social dimension includes the content of email accessible by the digital assistant, such as sender information, recipient information, time sent, and message content. In some embodiments, the social dimension includes the content of text messages accessible by the digital assistant, such as sender information, recipient information, time sent, and message content. The text messages optionally can be SMS messages, messages in the iMessage® software feature of Apple, Inc., Cupertino, Calif., or any other kind of message. In some embodiments, the social dimension includes the characteristics of calendar events (for example, meetings and events) accessible by the digital assistant. The characteristics of the calendar events include the identity of the participants, the time of the calendar event, and the time of the calendar event. In some embodiments, the social dimension includes information associated with contacts accessible to the virtual assistant, such as name, address, phone number, email address, and social media connections, as well as information associated with the creation of contacts. In some embodiments, the social dimension includes notes about people that are accessible by the virtual assistant. Such notes optionally can include information about the contact's family, preferences of food, birthdays, and any other information relevant to the user and the contact.

According to some embodiments, the location dimension includes information relating to the location of the electronic device 104, 200, 400, 600, and by extension the location of the user. In some embodiments, the location dimension includes information associated with a period of time during which the electronic device 104, 200, 400, 600 is generally stationary at a location, such as a restaurant, a classroom, or a church. In some embodiments, the location dimension includes information associated with a period of time during which the electronic device 104, 200, 400, 600 is generally in motion. In some embodiments, the location dimension includes information associated with the frequency with which the electronic device 104, 200, 400, 600 is at a particular location, such as the ice cream shop or the gym. In some embodiments, the location dimension includes information associated with a user-identified location. In some embodiments, location information includes a location of an object associated with the electronic device, such as a tracking device (e.g., an RFID tag). The location of the electronic device 104, 200, 400, 600 is determined in any suitable manner. In some embodiments, the location is determined at least in part via a GPS; the virtual assistant utilizes the GPS module 235 and/or the map module 254 to determine location. In some embodiments, the location of the electronic device 104, 200, 400, 600 is determined at least in part via nearby communications towers, such as cell phone signal towers, by comparing the relative signal strength from multiple towers at the electronic device 104, 200, 400, 600. In some embodiments, the location of the electronic device 104, 200, 400, 600 is determined at least in part via nearby wireless communication access points compliant with the IEEE 802.11x standard. In some embodiments, the electronic device 104, 200, 400, 600 is configured to receive signals from a wireless location transmitter or transmitters other than GPS, such as a Bluetooth® wireless location transmitter, or an iBeacon™ location and proximity detector of Apple, Inc., Cupertino, Calif.; the virtual assistant is configured to determine location information based on the receipt of such transmissions. In some embodiments, the location of the electronic device 104, 200, 400, 600 is determined by its proximity to the electronic devices of other users, and/or by communications received from the electronic devices of other users.

According to some embodiments, the media dimension includes information relating to user media stored on the electronic device 104, 200, 400, 600 or accessible to the digital assistant. The data associated with media (such as music, videos, and books) stored on the electronic device 104, 200, 400, 600 includes, in some embodiments, the presence of that media, bibliographic information of that media (e.g., title, album, release date), information relating to the playback history of that media (e.g., number of times the media has been played back, date the media was last played back, date the media was added to the electronic device), and metadata relating to that media. In some embodiments, the media dimension includes information associated with a podcast (such as the podcast title, podcaster, and production date) played via the electronic device 104, 200, 400, 600. In some embodiments, the media dimension includes information associated with an electronic book (such as the title, author, and publication date) played via the electronic device 104, 200, 400, 600. In accordance with some embodiments, the user context includes media associated with the user, regardless of the storage location of the media. Such media optionally can be stored in the cloud, or optionally can be associated with a streaming music service accessible to the user, such as Apple Music or iTunes Radio' (services of Apple, Inc. of Cupertino, Calif.).

According to some embodiments, the content dimension includes information relating to one of the content and/or application streams stored on the electronic device 104, 200, 400, 600 or accessible to the digital assistant. In some embodiments, the content dimension includes the browsing stream, which refers to the Internet browsing history of the user via the electronic device 104, 200, 400, 600, and the content accessed by the user via that browsing history. In some embodiments, the content dimension includes the written stream, which refers to user-generated notes and documents produced with or through the electronic device 104, 200, 400, 600. In some embodiments, the content dimension includes the application history usage stream, which includes the history of use of apps and applications at the electronic device 104, 200, 400, 600.

According to some embodiments, the photographic dimension includes information relating to photographs taken by and stored on the electronic device 104, 200, 400, 600 or other location accessible to the digital assistant. In accordance with some embodiments, the photographic dimension includes metadata associated with the photograph, such as the date taken and the location taken.

According to some embodiments, the daily activity dimension includes information relating to personal day-to-day activities of the user. In accordance with some embodiments, the daily activity dimension includes reminders, such as those set by the user, stored at the electronic device 104, 200, 400, 600 and/or otherwise accessible to the digital assistant. In accordance with some embodiments, the daily activity dimension includes at least one of diet and exercise information stored at the electronic device 104, 200, 400, 600 and/or otherwise accessible to the digital assistant. For example, the electronic device 104, 200, 400, 600 optionally can be coupled to an Apple Watch® wrist wearable device of Apple, Inc. of Cupertino, Calif., which acquires exercise information associated with a user's daily activity. In accordance with some embodiments, the daily activity dimension includes a user journal or blog stored at the electronic device 104, 200, 400, 600 and/or otherwise accessible to the digital assistant.

According to some embodiments, device context includes information associated with the electronic device 200 itself. In some embodiments, the device context includes the location of the electronic device 200. A GPS system or other system optionally can be used to localize the electronic device 200, and optionally can be able to determine whether the user is moving, where the user is located (e.g., home, school, work, park, gym), and other information. In accordance with some embodiments, the electronic device 200 is configured to receive signals from a wireless location transmitter other than GPS, such as a Bluetooth® wireless location transmitter, or an iBeacon™ location and proximity detector of Apple, Inc., Cupertino, Calif. As one example, the digital assistant determines that the electronic device 200, and thus the user, is moving at a rate of speed consistent with automobile travel. In accordance with some embodiments, the device context includes audio input from the microphone other than user speech, such as sound in the vicinity of the electronic device 200. The electronic device, according to some embodiments, generates an acoustic fingerprint from that sound. An acoustic fingerprint is a condensed digital summary, generated from that sound, that can be used to identify that sound by comparing that acoustic fingerprint to a database. The electronic device, in other embodiments, also or instead converts that sound to text, where that sound includes recognizable speech. According to some embodiments, device context includes proximity of the electronic device 104, 200, 400, 600 to a second electronic device, which in some embodiments is a smart watch such as the Apple Watch® wrist wearable device of Apple, Inc. of Cupertino, Calif.; the Apple TV® digital media extender of Apple, Inc. of Cupertino, Calif.; a home automation device;or other electronic device. According to some embodiments, the device context includes the connectivity status of one or more wireless networks at the electronic device 104, 200, 400, 600.

User context includes information associated with the user of the electronic device 200. In accordance with some embodiments, user context includes demographic information about the user, such as the user's age, gender, or the like. In accordance with some embodiments, the user context includes specific locations associated with the user, such as “home,” “work,” “Mom's house,” and/or other locations that are defined by their association with the user in addition to their physical address and/or map coordinates.

Returning to method 900, optionally at block 908 the electronic device 104, 200, 400, 600 and/or digital assistant receive a user request to generate at least one experiential data structure. Such a request corresponds to, for example, FIGS. 8A-8C, in which the user expressly requests that the digital assistant remember information. In some embodiments, the user request optionally can be implied rather than express. In response to receipt of that user request, the electronic device 104, 200, 400, 600 and/or the digital assistant generates at least one experiential data structure in block 910.

Next, at block 922, at least one experiential data structure is stored. As described above, experiential data structures are stored at the electronic device 104, 200, 400, 600 and/or server system 108, or any other location accessible to the digital assistant that includes the client-side DA client 102 or the server-side DA server 106. Optionally, referring to block 924, at least one experiential data structure is stored for a fixed period of time, such as 1 month, 1 year, or 10 years. Different experiential data structures optionally are stored for different amounts of time, depending on their contents, according to some embodiments. Referring to block 926, optionally the fixed period of time of block 924 is set independent of the user. For example, the virtual assistant controls the amount of time the stored experiential data structures are retained, based on data it requires to satisfy user requests, and the frequency of certain types of user requests (e.g., requests referring to or requiring data from the far past), according to some embodiments. Alternately, according to some embodiments, optionally the virtual assistant receives in block 928 a period of time selected by the user, and in block 930 sets the fixed period of time of block 930 in accordance with the selection received from the user. For example, for privacy reasons, the user may desire that personal data contained in the experiential data structure is deleted sooner than a default time setting provided by the virtual assistant. The storing operations of block 922 optionally can be performed at any time in the method 900, and/or repeated at any suitable time or location. The storage is short term storage, long term storage, or any other suitable storage that effectuates the performance of the method 900.

Next, referring to FIG. 8B, at block 912, utilizing the virtual assistant, at least one experiential data structure is modified with one or more annotations associated with the experiential data structure. Where the contents of the experiential data structure are sufficient to describe fully the information needed to remember user data and/or generate recommendations, annotations need not be associated with the experiential data structure. Further, the modifying of block 912 optionally can be performed as part of the generating of block 902. The annotations may have any content associated with the experiential data structure, and one or more annotations optionally can be made to an experiential data structure as needed to describe fully a particular experiential data structure. For example, optionally at least one experiential data structure is tagged based on at least one device context (as described above) in block 914. In some embodiments, optionally modifying is performed automatically. A change in device context is detected in block 915. For example, the GPS coordinates of the electronic device 104, 200, 400, 600 change by a non-trivial amount, which is detected in block 915. In block 916, in response to detection of the change in device context in block 915, at least one experiential data structure is modified based on that changed device context. As another example, optionally at least one experiential data structure is tagged based on at least one user context (as described above) in block 918. In some embodiments, optionally modifying is performed automatically. A change in user context is detected in block 935. For example, personal information about the user changes. In block 936, in response to detection of the change in user context in block 935, at least one experiential data structure is modified based on that changed user context. Optionally, at least one experiential data structure is tagged based on express user input, in block 938. Optionally, at block 939, the virtual assistant analyzes the content of the express user input. Such analysis is a standard semantic analysis in the context of natural language processing, according to some embodiments. Other or additional analysis is performed on the content of the express user input at block 939, according to some embodiments. At block 940, the virtual assistant determines, based on the analysis of block 939, whether that express user input is ambiguous. If the express user input is not ambiguous, then the method continues to block 942, in which the electronic device 104, 200, 400, 600 and/or digital assistant perform the action to modify at least one experiential data structure, after which the method continues to block 912. If the express user input is ambiguous, the method continues to block 944, where the virtual assistant requests additional information from the user to disambiguate the user input. For example, as seen in FIG. 8C, the user wishes to annotate an experiential data structure with a liking of a ham sandwich. However, as described in the examples above, disambiguation is required, so the virtual assistant performs block 944 as seen in FIG. 8D. Additional information is received from the user in block 945. Next, in block 946, based at least in part on the additional information received from the user (such as seen in FIG. 8E, for example), the virtual assistant performs the action to modify at least one experiential data structure, as confirmed by the virtual assistant in FIG. 8F, after which the method continues to block 912.

In block 932, the digital assistant receives from the user a natural-language request for service. Optionally, the method 900 proceeds to block 965, referring also to FIG. 9E. At block 939, the virtual assistant analyzes the content of the natural-language request for service. Such analysis is a standard semantic analysis in the context of natural language processing, according to some embodiments. Other or additional analysis is performed on the content of the natural-language request for service at block 939, according to some embodiments. At block 966, the virtual assistant determines, based on the analysis of block 965, whether that natural-language request for service is ambiguous. If the natural-language request for service is not ambiguous, then the method continues to block 968, where the virtual assistant then proceeds to output information responsive to the natural-language request for service. If the express user input is ambiguous, the method continues to block 970, where the virtual assistant requests additional information from the user to disambiguate the user input. For example, in the example of FIG. 8R, the user may have tagged no Thai restaurants in Cupertino. In that case, the virtual assistant searches for experiential data structures including a user annotation associated with a Thai restaurant the user liked, and finds two in nearby cities, one in Sunnyvale and one in San Jose. The virtual assistant then, in block 970, informs the user that there are no Thai restaurants in Cupertino that the user indicated she liked, but there are Thai restaurants she liked in Sunnyvale and San Jose, and requests that the user select one. The user, in response, selects Sunnyvale, and that information is received in block 972. Based in part on that additional information received in block 972, optionally in block 974 the virtual assistant satisfies the user request by displaying the name, address, and other information associated with the Thai restaurant in Sunnyvale that the user likes.

Referring also to FIG. 9D, next, the method 900 outputs information responsive to the user request of block 932 at block 948, using at least one stored experiential data structure. Such information may be output in any format, such as but not limited to visually on the display 212, or as audio output through the speaker 211. As used in this document and as is commonly understood by those skilled in the art, the terms “satisfy” and “fulfill” a user request are synonymous with output of information responsive to the user request. Optionally, the digital assistant analyzes at least one experiential data structure based on the user request at block 950. In some embodiments, this analysis optionally can include matching the user request directly to one or more stored experiential data structures in block 952. The direct matching of block 952 means that the one or more stored experiential data structures include all of the information responsive to the user request. For example, the request of FIG. 8K is met by finding and analyzing experiential data structure(s) associated with the 4:00 p.m. meeting that include the names of the other attendees. According to other embodiments, the virtual assistant utilizes at least one element of the user request to infer at least one additional element in block 956. For example, with respect to FIG. 8T, as described above, no experiential data structures expressly include the answer to the user request. The virtual assistant uses the band name “Massive Attack” to search experiential data structures that include a media dimension associated with Massive Attack, then infers the user request relating to a “Massive Attack” song refers to the last time such a song was played. Referring to block 958, the virtual assistant repeats the generation, and determines which experiential data structure that includes a media dimension associated with Massive Attack is the latest in time, then finds the location dimension in that experiential data structure. That is, the virtual assistant optionally repeats the instructions to generate at least one further additional element, one or more additional times in order to find the data in the stored experiential data structures that is capable of satisfying the user request. Optionally, the Optionally, referring to block 960, the virtual assistant in some embodiments performs a statistical analysis on a plurality of stored experiential data structures based on at least one element of the user request. As a simple example, referring to FIG. 8V and the discussion of that figure above, the user noted three times in the past that the keys were there, and noted once that the keys were on the ottoman in the living room. By applying statistical analysis, including the dates and times the four inputs were made in the past, the virtual assistant determines that the keys are most likely on the kitchen counter next to the toaster. As another example, referring to the second example making user of FIG. 8V in which an experiential data structure was generated periodically that included the location of a tracking device associated with the keys, the virtual assistant applies statistical analysis to those stored experiential data structures to determine the location or locations at which the user generally leaves the keys, without requiring that the user expressly input the location of the keys. A tracking unit, such as a Bluetooth® wireless tracking unit, has the advantage of providing finer location resolution than possible with GPS or similar location systems alone. Greater degrees of sophistication can be applied to larger sets of experiential data structures as needed to satisfy a user request.

Optionally, in some embodiments, in block 976 the virtual assistant receives a user request for a recommendation. For example, referring to FIG. 8Z, the user asks for a recommendation from Sandwich Shop restaurant. Referring back to FIGS. 8C-8F, the user had previously generated experiential data structures tagged with the user's liking of the ham sandwich at Sandwich Shop. In block 978, the virtual assistant analyzes at least one stored experiential data structure based on the user request. For example, the virtual assistant locates the at least one stored experiential data structure including a location dimension of Sandwich Shop, where that experiential data structure includes the user's preference for the ham sandwich. The virtual assistant, in block 984, optionally satisfies the user request based on analysis of at least one stored experiential data structure, and in FIG. 8JJ reminds the user that he likes the ham sandwich. Optionally, in block 980, the virtual assistant accesses tags associated with anonymized stored experiential data structures of other users, and analyzes those anonymized stored experiential data structures based on the user request in block 982. Access to a large number of anonymized stored experiential data structures of other users is helpful in generating recommendations whether or not the user has expressed a liking of an item at that location in the past. For example, 96% of all diners at Sandwich Shop generated experiential data structures to remind them that they love the hot pastrami sandwich with piquillo peppers and bacalao. The user may not have considered this sandwich, and receiving a recommendation from the virtual assistant based on the stored experiential data structures of other users helps the user not to miss out on a delicious lunch. As another example, the user may want a recommendation of a dish at a restaurant where she has never eaten, and receiving a recommendation from the virtual assistant based on the stored experiential data structures of other users helps the user make a decision in the absence of any expressed previous user preference. Where blocks 980 and 982 are implemented, they end in block 984, where at least one stored experiential data structure was anonymized and from someone other than the user.

Optionally, in some embodiments, the virtual assistant anonymizes at least one experiential data structure of the user in block 986, then transmits at least one anonymized tagged experiential data structure from the electronic device 104, 200, 400, 600 in block 988. In this way, just as anonymized stored experiential data structures of other users were used in optional blocks 980 and 982 to satisfy a user request, the anonymized store experiential data structure(s) of the user can be aggregated with those of a wider user population in order to satisfy the requests of other users.

In accordance with some embodiments, FIG. 10A shows an exemplary functional block diagram of an electronic device 1100 configured in accordance with the principles of the various described embodiments. In accordance with some embodiments, the functional blocks of electronic device 1100 are configured to perform the techniques described above. The functional blocks of the device 1100 are, optionally, implemented by hardware, software, or a combination of hardware and software to carry out the principles of the various described examples. It is understood by persons of skill in the art that the functional blocks described in FIG. 10A are, optionally, combined or separated into sub-blocks to implement the principles of the various described examples. Therefore, the description herein optionally supports any possible combination or separation or further definition of the functional blocks described herein.

As shown in FIG. 11, an electronic device 1100 optionally includes a display unit 1102 configured to display a graphic user interface; optionally, a touch-sensitive surface unit 1104 configured to receive contacts; optionally, a microphone unit 1106 configured to receive audio signals; and a processing unit 1108 coupled optionally to one or more of the display unit 1102, the touch-sensitive surface unit 1104, and microphone unit 1106. In some embodiments, the processing unit 1108 includes a generating unit 1110, a modifying unit 1112, a storing unit 1114, a receiving unit 1116, an outputting unit 1118, and optionally, a determining unit 1120, a requesting unit 1122, an analyzing unit 1124, a matching unit 1126, a detecting unit 1128, an accessing unit 1130, an anonymizing unit 1132, a transmitting unit 1134, and a setting unit 1136.

The processing unit 1108 is configured to generate (e.g., with generating unit 1110) at least one experiential data structure accessible to a virtual assistant, where the experiential data structure comprises an organized set of data associated with at least one of the user and the electronic device at a particular point in time; store (e.g., with the storing unit 1114) at least one experiential data structure; modify (e.g., with the modifying unit 1112) at least one experiential data structure with one or more annotations associated with the experiential data structure utilizing the virtual assistant; receive (e.g., with the receiving unit 1116), a natural-language user request for service from the virtual assistant; and output (e.g., with the outputting unit 1118) information responsive to the user request using at least one experiential data structure.

In some embodiments, the processing unit 1108 is further configured to generate (e.g., with the generating unit 1110) an experiential data structure upon the passage of each time interval, where the trigger is the passage of a time interval.

In some embodiments, the processing unit 1108 is further configured to modify (e.g., with the modifying unit 1112) at least one experiential data structure based on at least one device context.

In some embodiments, the processing unit 1108 is further configured to detect (e.g., with the detecting unit 1128) a change in device context and, in response to detection of a change in device context, modify (e.g., with the modifying unit 1112) at least one experiential data structure based on at least one changed device context.

In some embodiments, the device context includes a location of the device.

In some embodiments, the device context includes motion of the device.

In some embodiments, the device context includes proximity to a second electronic device.

In some embodiments, the processing unit 1108 is further configured to modify (e.g., with the modifying unit 1112) at least one experiential data structure based on at least one user context.

In some embodiments, the processing unit 1108 is further configured to detect (e.g., with the detecting unit 1128) a change in user context and, in response to detection of a change in user context, modify (e.g., with the modifying unit 1112) at least one experiential data structure based on at least one changed user context.

In some embodiments, the user context includes personal information associated with the user.

In some embodiments, the user context includes locations associated with the user.

In some embodiments, the processing unit 1108 is further configured to receive (e.g., with the receiving unit 1116) an express user request to generate at least one experiential data structure and, in response to receipt of the express user request, generate (e.g., with the generating unit 1110) at least one experiential data structure, where the trigger is a user request.

In some embodiments, the processing unit 1108 is further configured to modify (e.g., with the modifying unit 1112) the at least one experiential data structure based on express user input.

In some embodiments, the processing unit 1108 is further configured to analyze (e.g., with the analyzing unit 1124) the content of the express user input; based on the analysis of the content of the express user input, determine (e.g., with the determining unit 1120) whether the user request is ambiguous; in accordance with a determination that the user request is other than ambiguous, perform the action to modify at least one experiential data structure; and in accordance with a determination that the user request is ambiguous: request (e.g., with the requesting unit 1122) additional information from the user to disambiguate; receive (e.g., with the receiving unit 1116) the additional information from the user; and based in part on the additional information from the user, perform the action to modify at least one experiential data structure.

In some embodiments, at least one experiential data structure includes social information comprising information associated with at least one person other than the user.

In some embodiments, the social information includes the content of email accessible to the virtual assistant.

In some embodiments, the social information includes the content of text messages accessible by the virtual assistant.

In some embodiments, the social information includes the characteristics of calendar events accessible by the virtual assistant.

In some embodiments, the social information includes contacts accessible by the virtual assistant.

In some embodiments, the social information includes notes about people accessible by the virtual assistant.

In some embodiments, at least one experiential data structure includes location information.

In some embodiments, the location information includes information associated with a period of time during which the electronic device is generally stationary at a location.

In some embodiments, the location information includes information associated with a period of time during which the electronic device is generally in motion.

In some embodiments, the location information includes information associated with the frequency with which the electronic device is at a particular location.

In some embodiments, the location information includes information associated with a user-identified location.

In some embodiments, the location information includes a location of an object associated with the electronic device.

In some embodiments, at least one experiential data structure includes media information.

In some embodiments, the media information includes information associated with a podcast played via the electronic device.

In some embodiments, the media information includes information associated with music played via the electronic device.

In some embodiments, the media information includes information associated with video played via the electronic device.

In some embodiments, at least one experiential data structure includes content information.

In some embodiments, the content information includes a browser history of the electronic device.

In some embodiments, the content information includes content received through a browser at the electronic device.

In some embodiments, the content information includes documents generated by the user with the electronic device.

In some embodiments, the content information includes a history of application usage at the electronic device.

In some embodiments, at least one experiential data structure includes photographic information.

In some embodiments, at least one experiential data structure includes daily activity information.

In some embodiments, the daily activity information includes reminders accessible to the virtual assistant.

In some embodiments, the daily activity information includes at least one of diet and exercise information accessible to the virtual assistant.

In some embodiments, the daily activity information includes user journal information accessible to the virtual assistant.

In some embodiments, the processing unit 1108 is further configured to generate (e.g., with the generating unit 1110) at least one new experiential data structure when at least one of the items of information of the experiential data structure, the device context, and the user context changes.

In some embodiments, the processing unit 1108 is further configured to receive (e.g., with the receiving unit 1116) a user request for service from the virtual assistant associated with at least one stored experiential data structure, analyze (e.g., with the analyzing unit 1124) at least one stored experiential data structure based on at least one element of the user request, and output (e.g., with the outputting unit 1118) information responsive to the user request based on the analysis of at least stored one experiential data structure.

In some embodiments, the processing unit 1108 is further configured to match (e.g., with the matching unit 1126) the user request directly to one or more stored experiential data structures.

In some embodiments, the processing unit 1108 is further configured to generate (e.g., with the generating unit 1110) at least one additional element based on at least one element of the user request and match (e.g., with the matching unit 1126 the generated element to at least one stored experiential data structure.

In some embodiments, the processing unit 1108 is further configured to generate (e.g., with the generating unit 1110) at least one further additional element, based on the at least one additional element and repeat the instruction to generate at least one further additional element, based on the at least one additional element, at least one additional time.

In some embodiments, analyzing at least one stored experiential data structure based on the user request includes analyzing (e.g., with the analyzing unit 1124) statistically a plurality of experiential data structures based on at least one element of the user request.

In some embodiments, the processing unit 1108 is further configured to analyze (e.g., with the analyzing unit 1124) the content of the user request; based on the analysis of the user request, determine (e.g., with the determining unit 1120) whether the user request is ambiguous; in accordance with a determination that the user request is other than ambiguous, proceed to output information responsive to the user request; and in accordance with a determination that the user request is ambiguous: request (e.g., with the requesting unit 1122) additional information from the user to disambiguate; receive (e.g., with the receiving unit 1116) the additional information from the user; and based in part on the additional information from the user, proceed to output information responsive to the user request.

In some embodiments, the processing unit 1108 is further configured to receive (e.g., with the receiving unit 1116) a user request for a recommendation from the virtual assistant, analyze (e.g., with the analyzing unit 1124) at least one stored experiential data structure based on the user request, and output (e.g., with the outputting unit 1118) information responsive to the user request based on the analysis of the at least one stored experiential data structure.

In some embodiments, analyzing at least one stored experiential data structure based on the user request, includes accessing (e.g., with the accessing unit 1130), using the virtual assistant, tags associated with anonymized stored experiential data structures of other users and analyzing (e.g., with the analyzing unit 1124), using the virtual assistant, the anonymized stored experiential data structures of other users based on the user request.

In some embodiments, the processing unit 1108 is further configured to anonymize (e.g., with the anonymizing unit 1132) at least one experiential data structure and transmit (e.g., with the transmitting unit 1134) at least one anonymized experiential data structure from the electronic device.

In some embodiments, the processing unit 1108 is further configured to store (e.g., with the storing unit 1114) at least one experiential data structure for a fixed period of time.

In some embodiments, the processing unit 1108 is further configured to set (e.g., with the setting unit 1136) the fixed period of time independent of the user.

In some embodiments, the processing unit 1108 is further configured to receive (e.g., with the receiving unit 1116) a period of time selected by the user and set (e.g., with the setting unit 1136) the fixed period of time in accordance with the selection received from the user.

The operations described above with reference to FIGS. 9A-9F are, optionally, implemented by components depicted in FIGS. 1A-7C or FIG. 10A. It would be clear to a person having ordinary skill in the art how processes can be implemented based on the components depicted in FIGS. 1A-7C or FIG. 10A.

It is understood by persons of skill in the art that the functional blocks described in FIG. 11 are, optionally, combined or separated into sub-blocks to implement the principles of the various described embodiments. Therefore, the description herein optionally supports any possible combination or separation or further definition of the functional blocks described herein. For example, processing unit 1108 can have an associated “controller” unit that is operatively coupled with processing unit 1108 to enable operation. This controller unit is not separately illustrated in FIG. 11 but is understood to be within the grasp of one of ordinary skill in the art who is designing a device having a processing unit 1108, such as device 1100. As another example, one or more units, such as the generating unit 1110, may be hardware units outside of processing unit 1108 in some embodiments. The description herein thus optionally supports combination, separation, and/or further definition of the functional blocks described herein.

FIG. 9G is a flow diagram 1000 illustrating a method for remembering user data and generating recommendations using a digital assistant and an electronic device (104, 200, 400, or 600) in accordance with some embodiments. Some operations in process 1000 optionally can be combined, the order of some operations optionally can be changed, and some operations optionally can be omitted. In particular, optional operations indicated with dashed-line shapes in FIG. 9G optionally can be performed in any suitable order, if at all, and need not be performed in the order set forth in FIG. 9G.

As described below, method 1000 provides an intuitive way for remembering user data and generating recommendations using a digital assistant. The method reduces the cognitive burden on a user for remembering user data and generating recommendations using a digital assistant, thereby creating a more efficient human-machine interface. For battery-operated computing devices, enabling a user to remember user data and generate recommendations based on a nonspecific, unstructured natural-language request using a digital assistant more accurately and more efficiently conserves power and increases the time between battery charges.

At the beginning of process 1000, in block 1002, the digital assistant generates at least one experiential data structure and/or the electronic device 104, 200, 400, 600 generates at least one experiential data structure accessible to the digital assistant. The experiential data structure is a data structure that includes an organized set of data associated with the user and/or the electronic device 200 at a particular point in time. The data is associated with items that a user wishes to remember, and data that has utility in generating recommendations to the user. The at least one experiential data structure in block 1002 is generated in a similar manner as in block 902, according to some embodiments. The optional generation of a plurality of experiential data structures separated by time intervals in block 1004 is performed in a similar manner as in block 904, according to some embodiments. The optional generation of at least one experiential data structure when at least one dimension of the experiential data structure, a device context, and a user context changes is performed in a similar manner as in block 906, according to some embodiments.

Next, in block 1014, at least one tagged experiential data structure is stored in a similar manner as in block 922, according to some embodiments.

Next, in block 1008, the virtual assistant tags at least one experiential data structure with one or more annotations associated with the experiential data structure in a similar manner as in block 912, according to some embodiments. Optionally, a change in device context is detected in block 1009. For example, the GPS coordinates of the electronic device 104, 200, 400, 600 change by a non-trivial amount, which is detected in block 1009. In block 1010, in response to detection of the change in device context in block 1009, at least one experiential data structure is modified based on that changed device context. Optionally, a change in user context is detected in block 1011. In block 1012, in response to detection of the change in user context in block 1009, at least one experiential data structure is modified based on that changed user context. The optional modifying of at least one experiential data structure based on at least one device context in block 1010 is performed in a similar manner as in block 914, according to some embodiments. The optional modifying of at least one experiential data structure based on at least one user context in block 1012 is performed in a similar manner as in block 918, according to some embodiments.

In block 1016, based on at least one of a user context and a device context, the virtual assistant generates a request for the recommendation without input from the user. For example, referring to FIG. 8X and the description of FIG. 8X above, the user is at the Delhi Palacio and has the electronic device 102, 200, 400, 600 in her possession, such that the device context includes the location of the Delhi Palacio. The electronic device 102, 200, 400, 600 recognizes that it is at the Delhi Palacio, and generates a request for a recommendation from the virtual assistant for a food item that the user would like. The virtual assistant searches stored experiential data structures for the location Delhi Palacio, and determines if any of those experiential data structures include stored user information relating to the user's preferences. The virtual assistant determines that one stored experiential data structure includes information that the user likes the chicken tikka masala, and that another stored experiential data structure includes information that the user likes the lentil soup. Without receiving a user request for a recommendation, the virtual assistant presents 1076 information on the display 212 as shown in FIG. 8X, reminding the user that she likes the chicken tikka masala and the lentil soup at the Delhi Palacio. In this way, even if the user has forgotten that she generated an experiential data structure to remind her that she likes those items, the virtual assistance can provide her with the benefit of her previous request to remember her likes. As another example, upon recognizing that the electronic device 102, 200, 400, 600 is located at the Delhi Palacio, the virtual assistant searches stored experiential data structures for the location Delhi Palacio, and determines if any of those experiential data structures include stored user information relating to the user's preferences. Some stored experiential data structures, in this example, include a content dimension that includes the content of one or more reviews of the Delhi Palacio written by the user, and others, in this example, include a content dimension that includes data associated with the contents of previous orders by the user, such as through an app for food delivery. Based on those experiential data structures, the virtual assistant determines that “lamb korma” appears in a review, and also appears in several previous orders by the user. Without receiving a user request for a recommendation, the virtual assistant presents 1076 information to the user that she may like the lamb korma here, and optionally informs the user that she has ordered it several times in the past.

Referring to FIG. 8Y, as another example, the user's calendar includes an entry for a birthday party. The virtual assistant periodically checks the calendar for upcoming events, and recognizes a user context that a birthday party to which the user has been invited is tonight. The virtual assistant also recognizes the location of that birthday party (“Anne's house”). The virtual assistant optionally includes one or more task templates, and the presence of the words “birthday party” in association with the event trigger performance of a task to remind the user to purchase a gift. The virtual assistant determines that none of the stored experiential data structures includes information that the user has purchased a birthday gift. Without receiving a user request for a recommendation, the virtual assistant presents 1078 information on the display 212 as shown in FIG. 8Y, reminding the user that he is scheduled to go to a birthday party tonight, and gently reminding the user to purchase a gift if he has not yet done so.

Next, the analysis of at least one stored experiential data structure based on the generated request of block 1018 is performed in a similar manner as in block 950, according to some embodiments. The satisfaction of the user request based on the analysis of the least one stored experiential data structure is performed in a similar manner as in block 948.

In accordance with some embodiments, FIG. 10B shows an exemplary functional block diagram of an electronic device 1200 configured in accordance with the principles of the various described embodiments. In accordance with some embodiments, the functional blocks of electronic device 1200 are configured to perform the techniques described above. The functional blocks of the device 1200 are, optionally, implemented by hardware, software, or a combination of hardware and software to carry out the principles of the various described examples. It is understood by persons skilled in the art that the functional blocks described in FIG. 10B are, optionally, combined or separated into sub-blocks to implement the principles of the various described examples. Therefore, the description herein optionally supports any possible combination or separation or further definition of the functional blocks described herein.

As shown in FIG. 10B, an electronic device 1200 optionally includes a display unit 1202 configured to display a graphic user interface; optionally, a touch-sensitive surface unit 1204 configured to receive contacts; optionally, a microphone unit 1206 configured to receive audio signals; and a processing unit 1208 coupled optionally to one or more of the display unit 1202, the touch-sensitive surface unit 1204 and microphone unit 1206. In some embodiments, the processing unit 1208 includes a generating unit 1210, a modifying unit 1212, a storing unit 1214, an analyzing unit 1216, and an outputting unit 1218.

The processing unit 1208 is configured to generate (e.g., with the generating unit 1210), in response to a trigger, at least one experiential data structure accessible to a virtual assistant, where the experiential data structure comprises an organized set of data associated with at least one of the user and the electronic device at a particular point in time; store (e.g., with the storing unit 1214) at least one experiential data structure; modify (e.g., with the modifying unit 1212) at least one experiential data structure with one or more annotations associated with the experiential data structure, utilizing the virtual assistant; based on at least one of a user context and a device context, generate (e.g., with the generating unit 1210) a request for a recommendation from the virtual assistant without a request from the user; analyze (e.g., with the analyzing unit 1216) at least one stored experiential data structure based on the generated request; and output (e.g., with the outputting unit 1118) information responsive to the generated request based on the analysis of the at least one stored experiential data structure.

In some embodiments, the processing unit 1208 is further configured to generate (e.g., with the generating unit 1210) a plurality of experiential data structures separated by time intervals.

In some embodiments, the processing unit 1208 is further configured to modify (e.g., with the modifying unit 1212) at least one experiential data structure based on at least one device context.

In some embodiments, the processing unit 1208 is further configured to modify (e.g., with the modifying unit 1212) at least one experiential data structure based on at least one user context.

In some embodiments, at least one experiential data structure includes social information.

In some embodiments, at least one experiential data structure includes location information

In some embodiments, at least one experiential data structure includes media information.

In some embodiments, at least one experiential data structure includes content information.

In some embodiments, at least one experiential data structure includes photographic information.

In some embodiments, at least one experiential data structure includes daily activity information.

In some embodiments, the processing unit 1208 is further configured to generate (e.g., with the generating unit 1210) at least one new experiential data structure when at least one of the items of information of the experiential data structure, the device context, and the user context changes.

The operations described above with reference to FIG. 9G are, optionally, implemented by components depicted in FIGS. 1A-7C or FIG. 10B. It would be clear to a person having ordinary skill in the art how processes can be implemented based on the components depicted in FIGS. 1A-7C or FIG. 10B.

It is understood by persons of skill in the art that the functional blocks described in FIG. 12 are, optionally, combined or separated into sub-blocks to implement the principles of the various described embodiments. Therefore, the description herein optionally supports any possible combination or separation or further definition of the functional blocks described herein. For example, processing unit 1208 can have an associated “controller” unit that is operatively coupled with processing unit 1208 to enable operation. This controller unit is not separately illustrated in FIG. 12 but is understood to be within the grasp of one of ordinary skill in the art who is designing a device having a processing unit 1208, such as device 1200. As another example, one or more units, such as the generating unit 1210, may be hardware units outside of processing unit 1208 in some embodiments. The description herein thus optionally supports combination, separation, and/or further definition of the functional blocks described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery to users of content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

What is claimed is:

1. A non-transitory computer-readable storage medium storing one or more programs, the one or more programs comprising instructions, which when executed by an electronic device of a user, cause the electronic device to:
generate, in response to a trigger, at least one experiential data structure accessible to a virtual assistant, wherein the experiential data structure comprises an organized set of data associated with at least one of the user and the electronic device at a particular point in time;
store at least one experiential data structure;
modify at least one experiential data structure with one or more annotations associated with the experiential data structure, utilizing the virtual assistant;
receive a natural-language user request for service from the virtual assistant, and
output information responsive to the user request using at least one experiential data structure.

2. The non-transitory computer-readable storage medium of claim 1, wherein the trigger is the passage of a time interval and wherein the one or more programs further comprise instructions, which when executed by the one or more processors of the electronic device, cause the device to:
generate an experiential data structure upon the passage of each time interval.

3. The non-transitory computer-readable storage medium of claim 1, wherein the one or more programs further comprise instructions, which when executed by the one or more processors of the electronic device, cause the device to:
modify at least one experiential data structure based on at least one device context.

4. The non-transitory computer-readable storage medium of claim 3, wherein the one or more programs further comprise instructions, which when executed by the one or more processors of the electronic device, cause the device to:
detect a change in device context; and
in response to detection of a change in device context, modify at least one experiential data structure based on at least one changed device context.

5. The non-transitory computer-readable storage medium of claim 3, wherein the device context includes a location of the device.

6. The non-transitory computer-readable storage medium of claim 3, wherein the device context includes motion of the device.

7. The non-transitory computer-readable storage medium of claim 3, wherein the device context includes proximity to a second electronic device.

8. The non-transitory computer-readable storage medium of claim 1, wherein the one or more programs further comprise instructions, which when executed by the one or more processors of the electronic device, cause the device to:
modify at least one experiential data structure based on at least one user context.

9. The non-transitory computer-readable storage medium of claim 8, wherein the one or more programs further comprise instructions, which when executed by the one or more processors of the electronic device, cause the device to:
detect a change in user context; and
in response to detection of a change in user context, modify at least one experiential data structure based on at least one changed user context.

10. The non-transitory computer-readable storage medium of claim 8, wherein the user context includes personal information associated with the user.

11. The non-transitory computer-readable storage medium of claim 8, wherein the user context includes locations associated with the user.

12. The non-transitory computer-readable storage medium of claim 1,wherein the one or more programs further comprise instructions, which when executed by the one or more processors of the electronic device, cause the device to:
wherein the trigger is a user request, receive an express user request to generate at least one experiential data structure; and
in response to receipt of the express user request, generate at least one experiential data structure.

13. The non-transitory computer-readable storage medium of claim 1, wherein the one or more programs further comprise instructions, which when executed by the one or more processors of the electronic device, cause the device to:
modify the at least one experiential data structure based on express user input.

14. The non-transitory computer-readable storage medium of claim 13, wherein the one or more programs further comprise instructions, which when executed by the one or more processors of the electronic device, cause the device to:
analyze the content of the express user input;
based on the analysis of the content of the express user input, determine whether the user request is ambiguous;
in accordance with a determination that the user request is other than ambiguous, perform the action to modify at least one experiential data structure; and
in accordance with a determination that the user request is ambiguous:
request additional information from the user to disambiguate;
receive the additional information from the user; and
based in part on the additional information from the user, perform the action to modify at least one experiential data structure.

15. The non-transitory computer-readable storage medium of claim 1, wherein at least one experiential data structure includes social information comprising information associated with at least one person other than the user.

16. The non-transitory computer-readable storage medium of claim 15, wherein the social information includes the content of email accessible to the virtual assistant.

17. The non-transitory computer-readable storage medium of claim 15, wherein the social information includes the content of text messages accessible by the virtual assistant.

18. The non-transitory computer-readable storage medium of claim 15, wherein the social information includes the characteristics of calendar events accessible by the virtual assistant.

19. The non-transitory computer-readable storage medium of claim 15, wherein the social information includes contacts accessible by the virtual assistant.

20. The non-transitory computer-readable storage medium of claim 15, wherein the social information includes notes about people accessible by the virtual assistant.

21. The non-transitory computer-readable storage medium of claim 1, wherein at least one experiential data structure includes location information.

22. The non-transitory computer-readable storage medium of claim 21, wherein the location information includes information associated with a period of time during which the electronic device is generally stationary at a location.

23. The non-transitory computer-readable storage medium of claim 21, wherein the location information includes information associated with a period of time during which the electronic device is generally in motion.

24. The non-transitory computer-readable storage medium of claim 21, wherein the location information includes information associated with the frequency with which the electronic device is at a particular location.

25. The non-transitory computer-readable storage medium of claim 21, wherein the location information includes information associated with a user-identified location.

26. The non-transitory computer-readable storage medium of claim 21, wherein the location information includes a location of an object associated with the electronic device.

27. The non-transitory computer-readable storage medium of claim 1, wherein at least one experiential data structure includes media information.

28. The non-transitory computer-readable storage medium of claim 27, wherein the media information includes information associated with a podcast played via the electronic device.

29. The non-transitory computer-readable storage medium of claim 27, wherein the media information includes information associated with music played via the electronic device.

30. The non-transitory computer-readable storage medium of claim 27, wherein the media information includes information associated with video played via the electronic device.

31. The non-transitory computer-readable storage medium of claim 1, wherein at least one experiential data structure includes content information.

32. The non-transitory computer-readable storage medium of claim 31, wherein the content information includes a browser history of the electronic device.

33. The non-transitory computer-readable storage medium of claim 31, wherein the content information includes content received through a browser at the electronic device.

34. The non-transitory computer-readable storage medium of claim 31, wherein the content information includes documents generated by the user with the electronic device.

35. The non-transitory computer-readable storage medium of claim 31, wherein the content information includes a history of application usage at the electronic device.

36. The non-transitory computer-readable storage medium of claim 1, wherein at least one experiential data structure includes photographic information.

37. The non-transitory computer-readable storage medium of claim 1, wherein at least one experiential data structure includes daily activity information.

38. The non-transitory computer-readable storage medium of claim 37, wherein the daily activity information includes reminders accessible to the virtual assistant.

39. The non-transitory computer-readable storage medium of claim 37, wherein the daily activity information includes at least one of diet and exercise information accessible to the virtual assistant.

40. The non-transitory computer-readable storage medium of claim 37, wherein the daily activity information includes user journal information accessible to the virtual assistant.

41. The non-transitory computer-readable storage medium, of claim 1, wherein the one or more programs further comprise instructions, which when executed by the one or more processors of the electronic device, cause the device to:
generate at least one new experiential data structure when at least one of the items of information of the experiential data structure, the device context, and the user context changes.

42. The non-transitory computer-readable storage medium of claim 1, wherein the one or more programs further comprise instructions, which when executed by the one or more processors of the electronic device, cause the device to:
receive a user request for service from the virtual assistant associated with at least one stored experiential data structure;
analyze at least one stored experiential data structure based on at least one element of the user request; and
output information responsive to the user request based on the analysis of at least stored one experiential data structure.

43. The non-transitory computer-readable storage medium of claim 42, wherein the one or more programs further comprise instructions, which when executed by the one or more processors of the electronic device, cause the device to:
match the user request directly to one or more stored experiential data structures.

44. The non-transitory computer-readable storage medium of claim 42, wherein the one or more programs further comprise instructions, which when executed by the one or more processors of the electronic device, cause the device to:
generate at least one additional element based on at least one element of the user request; and
match the generated element to at least one stored experiential data structure.

45. The non-transitory computer-readable storage medium of claim 44, wherein the one or more programs further comprise instructions, which when executed by the one or more processors of the electronic device, cause the device to:
generate at least one further additional element, based on the at least one additional element; and
repeat the instruction to generate at least one further additional element, based on the at least one additional element, at least one additional time.

46. The non-transitory computer-readable storage medium of claim 42, wherein the instructions, which when executed by the one or more processors of the electronic device, cause the device to analyze at least one stored experiential data structure based on the user request, further comprise instructions, which when executed by the one or more processors of the electronic device, cause the device to:
analyze statistically a plurality of experiential data structures based on at least one element of the user request.

47. The non-transitory computer-readable storage medium of claim 1, wherein the one or more programs further comprise instructions, which when executed by the one or more processors of the electronic device, cause the device to:
analyze the content of the user request;
based on the analysis of the user request, determine whether the user request is ambiguous;
in accordance with a determination that the user request is other than ambiguous, proceed to output information responsive to the user request; and
in accordance with a determination that the user request is ambiguous:
request additional information from the user to disambiguate;
receive the additional information from the user; and
based in part on the additional information from the user, proceed to output information responsive to the user request.

48. The non-transitory computer-readable storage medium of claim 1, wherein the one or more programs further comprise instructions, which when executed by the one or more processors of the electronic device, cause the device to:
receive a user request for a recommendation from the virtual assistant;
analyze at least one stored experiential data structure based on the user request; and
output information responsive to the user request based on the analysis of the at least one stored experiential data structure.

49. The non-transitory computer-readable storage medium of claim 48, wherein the instructions to analyze at least one stored experiential data structure based on the user request, further comprise instructions which when executed by the one or more processors of the electronic device, cause the device to:
access, using the virtual assistant, tags associated with anonymized stored experiential data structures of other users; and
analyze, using the virtual assistant, the anonymized stored experiential data structures of other users based on the user request.

50. The non-transitory computer-readable storage medium of claim 48, wherein the one or more programs further comprise instructions, which when executed by the one or more processors of the electronic device, cause the device to:
anonymize at least one experiential data structure; and
transmit at least one anonymized experiential data structure from the electronic device.

51. The non-transitory computer-readable storage medium of claim 1, wherein the one or more programs further comprise instructions, which when executed by the one or more processors of the electronic device, cause the device to:
store at least one experiential data structure for a fixed period of time.

52. The non-transitory computer-readable storage medium of claim 51, wherein the one or more programs further comprise instructions, which when executed by the one or more processors of the electronic device, cause the device to:
set the fixed period of time independent of the user.

53. The non-transitory computer-readable storage medium of claim 51, wherein the one or more programs further comprise instructions, which when executed by the one or more processors of the electronic device, cause the device to:
receive a period of time selected by the user; and
set the fixed period of time in accordance with the selection received from the user.

54. An electronic device, comprising:
a memory;
a processor coupled to the memory, the processor configured to:
generate, in response to a trigger, at least one experiential data structure accessible to a virtual assistant, wherein the experiential data structure comprises an organized set of data associated with at least one of the user and the electronic device at a particular point in time;
store at least one experiential data structure;
modify at least one experiential data structure with one or more annotations associated with the experiential data structure, utilizing the virtual assistant;
receive a natural-language user request for service from the virtual assistant; and
output information responsive to the user request using at least one experiential data structure.

55. A method of using a virtual assistant, comprising:
at an electronic device configured to transmit and receive data:
generating, in response to a trigger, at least one experiential data structure accessible to a virtual assistant, wherein the experiential data structure comprises an organized set of data associated with at least one of the user and the electronic device at a particular point in time;
storing at least one experiential data structure;
modifying at least one experiential data structure with one or more annotations associated with the experiential data structure, utilizing the virtual assistant;
receiving a natural-language user request for service from the virtual assistant; and
outputting information responsive to the user request using at least one experiential data structure.
